(19) United States
(12) Patent Application Publication
(10) Pub. No.: US 2025/0310495 A1
(43) Pub. Date: Oct. 2, 2025

(54) PROJECTOR AND PROJECTOR SYSTEM

(71) Applicant: SEIKO EPSON CORPORATION, Tokyo (JP)

(72) Inventor: Eiji MORIKUNI, Matsumoto-shi (JP)

(73) Assignee: SEIKO EPSON CORPORATION, Tokyo (JP)

(21) Appl. No.: 19/089,559

(22) Filed: Mar. 25, 2025

(30) Foreign Application Priority Data
Mar. 26, 2024 (JP) 2024-050218

(51) Int. Cl. H04N 9/31; G02B 13/00

(52) U.S. Cl. CPC H04N 9/3185; G02B 13/0095; H04N 9/3102; H04N 9/3152; H04N 9/317; H04N 9/3194

(57) ABSTRACT

A projector includes a first light source, a light modulator that modulates visible light output from the first light source to form a projection image, a first relay optical system that forms the projection image at a first position, an enlarging optical system, an invisible image generator that forms an invisible image made of invisible light, and a light combiner that is disposed in the optical path between the enlarging optical system and the light modulator and combines the visible light and the invisible light with each other into combined light. The invisible image is formed at a second position conjugate with the position where the projection image is formed. The enlarging optical system forms an image at the first position and projects the combined light to display the projection image and the invisible image on a single projection surface.

The present application is based on, and claims priority from JP Application Serial Number 2024-050218, filed Mar. 26, 2024, the disclosure of which is hereby incorporated by reference herein in its entirety.

### BACKGROUND

### 1. Technical Field

The present disclosure relates to a projector and a projector system.

### 2. Related Art

A projector that projects a visible image made of visible light and an infrared image made of infrared light on the same screen is described in JP-A-2008-176195. The projector described in JP-A-2008-176195 includes a light source that outputs light containing the visible light and the infrared light, a light separating unit that separates the light from the light source into multiple kinds of light having different wavelength ranges, a visible light modulator that modulates the visible light separated by the light separating unit, an infrared light modulator that modulates the infrared light separated by the light separating unit, a light combining unit that combines the modulated light from the visible light modulator and the modulated light from the infrared light modulator with each other into one kind of combined light, and a projecting unit that projects and displays the combined light on a projection receiving surface. The projecting unit is a projection lens including multiple lenses.

JP-A-2008-176195 is an example of the related art.

In the projector described in JP-A-2008-176195, the reduction-side image formation plane of the projection lens is located at the image formation surfaces of the visible light modulator and the infrared light modulator. The projection lens therefore has a long back focal length, so that there is a problem of a decrease in the contrast of the visible image and the infrared image displayed on the screen and an increase in the size of the projection lens.

### SUMMARY

To solve the problems described above, a projector according to an aspect of the present disclosure includes a first light source; a light modulator configured to modulate visible light output from the first light source to form a projection image; a first relay optical system configured to relay the projection image to a first position; an enlarging optical system; an invisible image generator configured to form an invisible image made of invisible light; and a light combiner disposed in an optical path between the enlarging optical system and the light modulator and configured to combine the visible light and the invisible light with each other into combined light, the invisible image is formed at a second position conjugate with a position where the projection image is formed, and the enlarging optical system is configured to form an image at the first position and project the combined light to display the projection image and the invisible image at a single projection surface.

A projector system according to another aspect of the present disclosure includes the projector described above; an imager configured to capture an image of the invisible image displayed at the projection surface; a recognizer configured to recognize a positional deviation of the invisible image from a reference position at the projection surface based on the image of the invisible image captured by the imager, and a display corrector configured to correct a position of the projection image displayed at the projection surface based on the positional deviation recognized by the recognizer.

### BRIEF DESCRIPTION OF THE DRAWINGS

FIG. 1 is a schematic view of key parts of a projector system according to a first embodiment.

FIG. 2 is a schematic view of key parts of a light source apparatus.

FIG. 3 is a schematic view of key parts of an invisible image generator.

FIG. 4 illustrates an example of an invisible image displayed on a screen.

FIG. 5 shows a schematic configuration of an optical system in the first embodiment.

FIG. 6 is a schematic configuration diagram of a first projection optical system that projects visible light out of the optical system in the first embodiment.

FIG. 7 is a schematic configuration diagram of a second projection optical system that projects invisible light out of the optical system in the first embodiment.

FIG. 8 illustrates the positional relationship between a light modulator and an intermediate image of a projection image in a first relay optical system.

FIG. 9 shows the reduction-side MTF of the first projection optical system in the first embodiment.

FIG. 10 shows the reduction-side MTF of the second projection optical system in the first embodiment.

FIG. 11 is a schematic view of key parts of a projector system according a second embodiment.

FIG. 12 shows a schematic configuration of an optical system in the second embodiment.

FIG. 13 is a schematic configuration diagram of a first projection optical system that projects visible light out of the optical system in the second embodiment.

FIG. 14 is a schematic configuration diagram of a second projection optical system that projects invisible light out of the optical system in the second embodiment.

FIG. 15 shows the reduction-side MTF of the first projection optical system in the second embodiment.

FIG. 16 shows the reduction-side MTF of the second projection optical system in the second embodiment.

FIG. 17 is a schematic view of key parts of a projector system according a third embodiment.

FIG. 18 shows a schematic configuration of an optical system in the third embodiment.

FIG. 19 is a schematic configuration diagram of a first projection optical system that projects visible light out of the optical system in the third embodiment.

FIG. 20 is a schematic configuration diagram of a second projection optical system that projects invisible light out of the optical system in the third embodiment.

FIG. 21 shows the reduction-side MTF of the first projection optical system in the third embodiment.

FIG. 22 shows the reduction-side MTF of the second projection optical system in the third embodiment.

FIG. 23 is a schematic view of key parts of a projector system according a fourth embodiment.

FIG. 24 shows a schematic configuration of an optical system in the fourth embodiment.

FIG. 25 is a schematic configuration diagram of a first projection optical system that projects visible light out of the optical system in the fourth embodiment.

FIG. 26 is a schematic configuration diagram of a second projection optical system that projects invisible light out of the optical system in the fourth embodiment.

FIG. 27 shows the reduction-side MTF of the first projection optical system in the fourth embodiment.

FIG. 28 shows the reduction-side MTF of the second projection optical system in the fourth embodiment.

FIG. 29 is a schematic view of key parts of a projector system according a fifth embodiment.

FIG. 30 shows a schematic configuration of an optical system in the fifth embodiment.

FIG. 31 is a schematic configuration diagram of a first projection optical system that projects visible light out of the optical system in the fifth embodiment.

FIG. 32 is a schematic configuration diagram of a second projection optical system that projects invisible light out of the optical system in the fifth embodiment.

FIG. 33 shows the reduction-side MTF of the first projection optical system in the fifth embodiment.

FIG. 34 shows the reduction-side MTF of the second projection optical system in the fifth embodiment.

FIG. 35 is a schematic view of key parts of a projector system according a sixth embodiment.

FIG. 36 shows a schematic configuration of an optical system in the sixth embodiment.

FIG. 37 is a schematic configuration diagram of a first projection optical system that projects visible light out of the optical system in the sixth embodiment.

FIG. 38 is a schematic configuration diagram of a second projection optical system that projects invisible light out of the optical system in the sixth embodiment.

FIG. 39 shows the reduction-side MTF of the first projection optical system in the sixth embodiment.

FIG. 40 shows the reduction-side MTF of the second projection optical system in the sixth embodiment.

FIG. 41 shows a schematic configuration of an optical system of a projector system according to a variation of the fourth embodiment.

FIG. 42 is a schematic view of an invisible image generator according to a first variation.

FIG. 43 is a schematic diagram of an invisible image generator according to a second modification.

FIG. 44 is a schematic diagram of an invisible image generator according to a third modification.

FIG. 45 is a perspective view of an example of an optical member of an invisible image generator according to the third variation.

### DESCRIPTION OF EMBODIMENTS

A projector and a projector system according to each embodiment of the present disclosure will be described below with reference to the drawings.

### First Embodiment

### Projector System

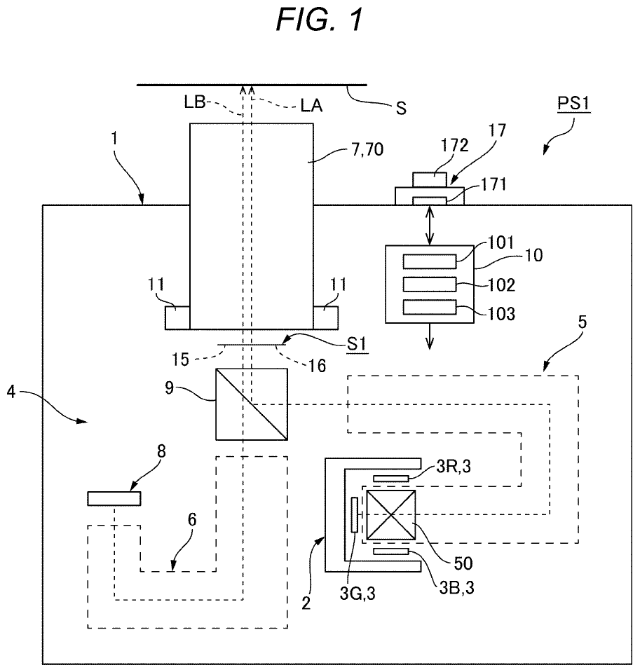

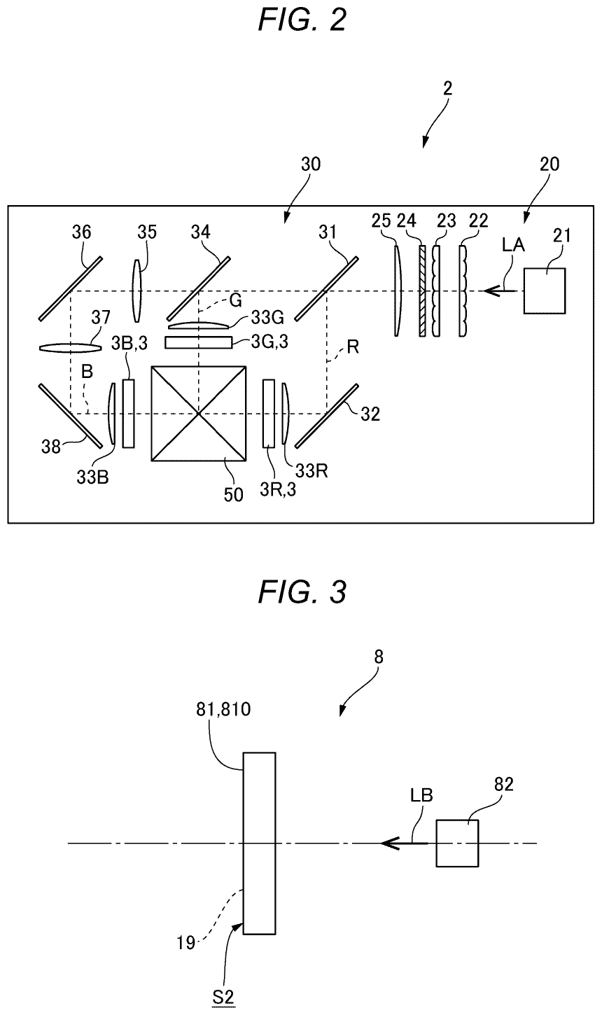

FIG. 1 is a schematic view of key parts of a projector system PS1. FIG. 2 is a schematic view of key parts of a light source apparatus 2. FIG. 3 is a schematic view of key parts of an invisible image generator 8. The projector system PS1 includes a projector 1, an imager 17, and a controller 10, as shown in FIG. 1. In the present embodiment, the imager 17 and the controller 10 are provided in the projector 1.

The projector 1 includes the light source apparatus 2, multiple light modulators 3, which modulate visible light output from the light source apparatus 2 to form projection images, the invisible image generator 8, which forms an invisible image made of invisible light, an optical system 4, which displays the projection images and the invisible image on the same screen that is a screen S, the imager 17, which captures an image of the invisible image displayed on the screen S, and the controller 10, as shown in FIG. 1.

The controller 10 controls the light modulators 3, the invisible image generator 8, and the imager 17. The controller 10 includes a first display driver 101, which drives the light modulators 3 based on an externally input image signal, a second display driver 102, which controls the invisible image generator 8, and a recognizer 103, which recognizes a positional deviation of the invisible image from a reference position on the screen S based on the image of the invisible image captured by the imager 17. The optical system 4 includes a first relay optical system 5, a second relay optical system 6, an enlarging optical system 7, and a light combiner 9. The first relay optical system 5 includes a dichroic prism 50.

The light source apparatus 2 includes an illumination optical system 20 and a separation optical system 30, as shown FIG. 2. The illumination optical system 20 includes a first light source 21, a first optical integration lens 22, a second optical integration lens 23, a polarization converter 24, and a superimposing lens 25. The first light source 21 outputs visible light LA and is configured, for example, with an ultrahigh-pressure mercury lamp or a solid-state light source. The first optical integration lens 22 divides the luminous flux from the first light source 21 into multiple luminous fluxes and brings the luminous fluxes into focus in the vicinity of the second optical integration lens 23. The polarization converter 24 converts the light from the second optical integration lens 23 into predetermined linearly polarized light. The superimposing lens 25 outputs the beams output from the polarization converter 24 toward the separation optical system 30.

The separation optical system 30 includes a first dichroic mirror 31, a reflection mirror 32, and a field lens 33R. The first dichroic mirror 31 reflects R light, which is part of the beams incident from the superimposing lens 25, and transmits G light and B light, which are part of the beams incident from the superimposing lens 25. The R light reflected off the first dichroic mirror 31 travels via the reflection mirror 32 and the field lens 33R and enters a light modulator 3R.

The separation optical system 30 includes a second dichroic mirror 34 and a field lens 33G. The second dichroic mirror 34 reflects the G light, which is part of the beams from the first dichroic mirror 31, and transmits the B light, which is part of the beams from the first dichroic mirror 31. The G light reflected off the second dichroic mirror 34 travels via the field lens 33G and enters a light modulator 3G.

The separation optical system 30 includes a relay lens 35, a reflection mirror 36, a relay lens 37, a reflection mirror 38, and a field lens 33B. The B light having passed through the second dichroic mirror 34 travels via the relay lens 35, the reflection mirror 36, the relay lens 37, the reflection mirror 38, and the field lens 33B and enters a light modulator 3B.

The light modulators 3 are configured with the three light modulators, as shown in FIG. 1. In the present embodiment, the light modulators 3 are each a liquid crystal panel. The light modulator 3R modulates the R light in accordance with an image signal to form a red projection image. The light modulator 3G modulates the G light in accordance with an image signal to form a green projection image. The light modulator 3B modulates the B light in accordance with an image signal to form a blue projection image. The polarized components of the visible light output from each of the light modulators 3 are aligned with one another by polarizers disposed upstream and downstream from the light modulator 3. In the present embodiment, the visible light output from each of the light modulators 3 is S-polarized beams.

The dichroic prism 50 generates a combined projection image as a result of combination of the beams modulated by the light modulators 3R, 3G, and 3B. The first relay optical system 5 relays the combined projection image to a first position S1, as shown in FIG. 1. That is, the first relay optical system 5 forms an intermediate image 15 of the projection images formed by the light modulators 3 at the first position S1.

The invisible image generator 8 includes a second light source 82, which outputs invisible light, and an IR light modulator 81, which forms an invisible image 19, as shown in FIG. 3. The second light source 82 is an LED device that outputs infrared light, which is the invisible light. The invisible light has a wavelength that cannot be recognized by human eyes, and is, for example, 850 nm or 940 nm. The IR light modulator 81 is controlled by the second display driver 102. The IR light modulator 81 is a transmissive liquid crystal panel 810. The liquid crystal panel 810 modulates the invisible light output from the second light source 82 to form an invisible image. The invisible image 19 is formed at a second position S2 conjugate with the position where the projection image is formed. That is, the surface of the liquid crystal panel 810 at which the invisible image 19 is formed is located at a position optically conjugate with the projection image formation surfaces of the light modulators 3. The polarized components of the invisible light output from the IR light modulator 81 are aligned with one another by polarizers disposed upstream and downstream from the IR light modulator 81. In the present embodiment, the invisible light output from the IR light modulator 81 is S-polarized beams.

The second relay optical system 6 relays the invisible image 19 formed by the IR light modulator 81 to the first position S1. That is, the second relay optical system 6 forms an intermediate image 16 of the invisible image 19 formed by the IR light modulator 81 at the first position S1, as shown in FIG. 1. The projection images formed by the light modulators 3 and the invisible image formed by the IR light modulator 81 are rectangular images having the same size.

The light combiner 9 is disposed between the enlarging optical system 7 and the light modulators 3, as shown in FIG. 1. The light combiner 9 combines the visible light LA and the invisible light LB with each other into combined light. The first position S1 is located between the light combiner 9 and the enlarging optical system 7.

The enlarging optical system 7 forms an image at the first position S1 and projects the combined light to display the combined projection image and the invisible image on the same screen S. The enlarging optical system 7 is a projection lens 70 configured with multiple lenses held in a lens barrel. The projector 1 includes an attachment/detachment mechanism 11, which detachably holds the projection lens 70. The attachment/detachment mechanism 11 can be any of various mechanisms capable of detachably holding the projection lens 70, such as a screw-based mechanism, a spigot-based mechanism, and a bayonet-based mechanism. The projection lens 70 of the projector 1 can thus be replaced in accordance with the projection specifications. That is, the attachment/detachment mechanism 11 makes the enlarging optical system 7 attachable to and detachable from the first relay optical system 5.

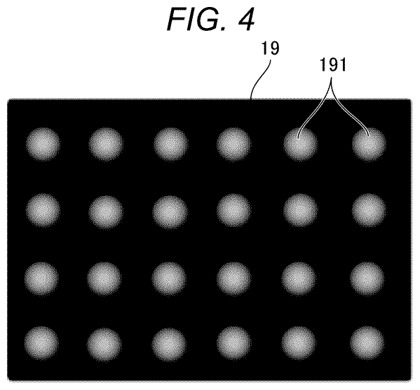

The imager 17 includes an imaging device 171, which captures an image of the invisible image displayed on the screen S, and an optical system 172. The optical system 172 of the imager 17 is an optical system used to capture an image of the invisible image displayed on the screen S. The imaging device 171 is configured, for example, with a CCD sensor or a CMOS sensor. The invisible image displayed on the screen S is the image shown in FIG. 4. In the invisible image 19, multiple circular sections 191 are displayed by the invisible light, as shown in FIG. 4. The circular sections 191 are arranged at equal intervals along the horizontal and vertical directions. In the present embodiment, the intensity of the light across each of the circular sections 191 decreases toward the outer circumferential so that the intensity distribution is the Gaussian distribution.

### Operation of Projector System

The operation of the projector system PS1 will be described. When the projector 1 is used, the projector 1 simultaneously displays the combined projection image and the invisible image on the same screen S. In this process, the imager 17 captures an image of the invisible image displayed on the screen S. The recognizer 103 recognizes a positional deviation of the invisible image from the reference position on the screen S based on the image of the invisible image captured by the imager 17. The reference position may be the position of the invisible image set when the position of the combined projection image displayed on the screen S is set, or may be a position stored in advance in a storage of the projector system PS1.

The first display driver 101 drives the light modulators 3 in such a way that the position of the combined projection image displayed on the screen S is corrected based on the positional deviation recognized by the recognizer 103. More specifically, the first display driver 101 corrects the positions of the projection images formed on the liquid crystal panels 300 of the light modulators 3 so as to correct the position of the combined projection image displayed on the screen S. The combined projection image displayed by the projector 1 may deviate from a predetermined position on the screen S due to heat of the light source and the like that affects the projection lens 70. In this case, the invisible image displayed by the projector 1 also similarly deviates from the predetermined position of the screen S due to the heat of the light source and the like that affects the projection lens 70. Therefore, since the projector system PS1 corrects the position of the combined projection image displayed on the screen S based on the positional deviation of the invisible image recognized by the recognizer 103, the position of the combined projection image displayed on the screen S is always kept constant. The first display driver 101 corresponds to the “display corrector” in the present disclosure.

### Details of Optical Systems

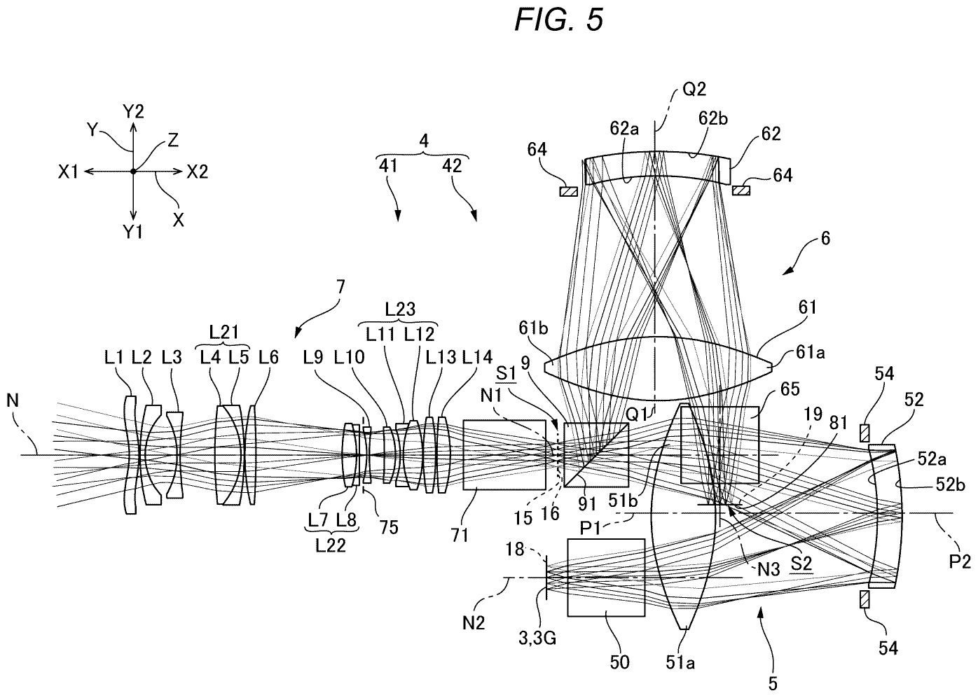

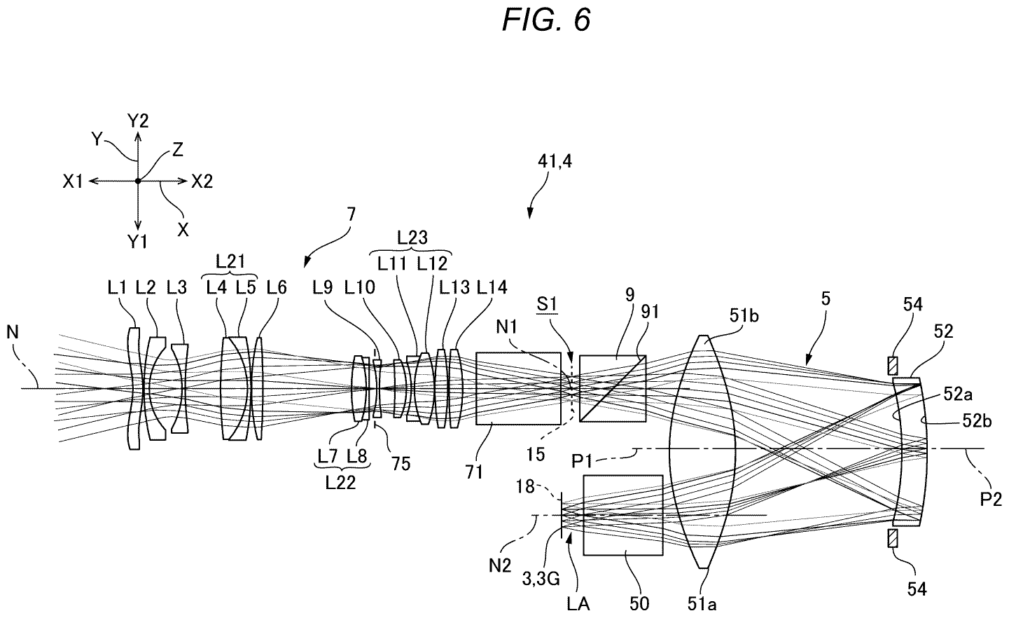

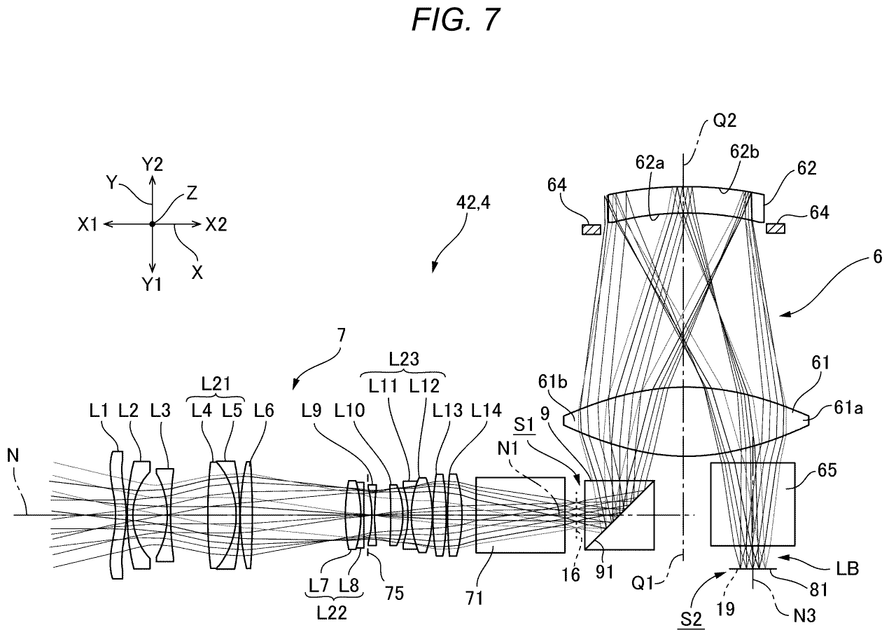

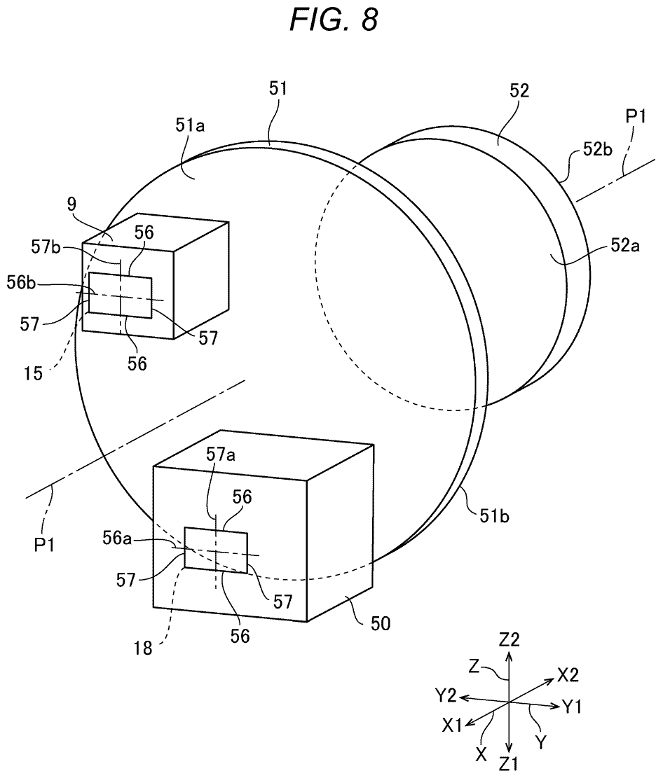

FIG. 5 shows a schematic configuration of the optical system 4 in the first embodiment. FIG. 6 is a schematic configuration diagram of a first projection optical system 41, which projects the visible light, out of the optical system 4 in the first embodiment. FIG. 7 is a schematic configuration diagram of a second projection optical system 42, which projects the invisible light, out of the optical system 4 in the first embodiment. FIG. 8 illustrates the positional relationship between one of the light modulators 3 and the intermediate image 15 of a projection image 18 in the first relay optical system 5.

The optical system 4 includes the first projection optical system 41 shown in FIG. 6, which projects the visible light LA, and the second projection optical system 42 shown in FIG. 7, which projects the invisible light LB, as shown in FIG. 5.

The enlarging optical system 7 includes 14 lenses L1 to L14 and a prism 71, as shown in FIG. 5 to 7. The lenses L1 to L14 are arranged in this order from the enlargement side toward the reduction side. The prism 71 is disposed on the reduction side of the lens L14. A diaphragm 75 is disposed between the lens L8 and the lens L9. The lenses L4 and L5 are cemented to each other into a cemented lens L21. The lenses L7 and L8 are cemented to each other into a cemented lens L22. The lenses L11 and L12 are cemented to each other into a cemented lens L23. The lens L1 has aspherical surfaces on opposite sides. The lens L10 has aspherical surfaces on opposite sides.

The first relay optical system 5 forms the intermediate image 15, which is as large as the projection images 18 formed at the light modulators 3, at the first position S1, as shown in FIGS. 5 and 6. The first relay optical system 5 includes the dichroic prism 50, a first lens element 51a, a first reflection member 52, and a second lens element 51b sequentially arranged in the direction in which the visible light travels from the light modulators 3 toward the first position S1. The dichroic prism 50 is located between the light modulators 3 and the first lens element 51a. The first lens element 51a and the second lens element 51b form an integral lens member 51 having positive power. In the following description, three axes orthogonal to each other are called an X-axis, a Y-axis, and a Z-axis for convenience. The direction in which the lenses L1 to L14 are arranged is called an X-axis direction. In the X-axis direction, the side on which the lens L1 is located is called an X1 side, and the side on which the lens L14 is located is called an X2 side. The upward-downward direction is called a Z-axis direction. In the Z-axis direction, the lower side is called a Z1 side, and the upper side is called a Z2 side.

The lens member 51 has convex surfaces on opposite side. The lens member 51 has aspherical surfaces on opposite sides. An optical axis P1 of the lens member 51 extends in the X-axis direction. The lens member 51 has a shape rotationally symmetrical around the optical axis P1. The first lens element 51a is located on a Y1 side of the optical axis P1 of the lens member 51, and the second lens element 51b is located on a Y2 side of the optical axis P1 of the lens member 51. The first lens element 51a and the second lens element 51b are therefore each a lens having positive power and having the same biconvex shape and the same refractive index. That is, the first lens element 51a and the second lens element 51b are provided symmetrically with respect to a symmetry plane containing the optical axis P1. In the present embodiment, the first lens element 51a constitutes a first lens group, and the second lens element 51b constitutes a second lens group.

The first reflection member 52 has a first transmissive surface 52a and a first reflective surface 52b. The first transmissive surface 52a is located on the X1 side, and the first reflective surface 52b is located on the X2 side. The first transmissive surface 52a has a concave shape recessed toward the X2 side. The first transmissive surface 52a has an aspherical shape.

The first reflective surface 52b has a concave shape recessed toward the X2 side. The first reflective surface 52b has an aspherical shape. The first reflective surface 52b is formed by providing a reflective coating layer on the X2-side outer surface of the first reflection member 52. An optical axis P2 of the first reflection member 52 extends in the X-axis direction. The first transmissive surface 52a and the first reflective surface 52b are rotationally symmetric with respect to the optical axis P2. That is, the first transmissive surface 52a and the first reflective surface 52b are plane-symmetrical with respect to a symmetry plane containing the optical axis P2. The optical axis P2 of the first reflection member 52 coincides with the optical axis P1 of the lens member 51.

The first relay optical system 5 includes a first light controlling member 54, which is adjacent to the first transmissive surface 52a on the light incident side of the first transmissive surface 52a and restricts the amount of the light incident on the first reflection member 52. The first light controlling member 54 can be a diaphragm that mechanically controls the amount of light such as a light shielding plate, or a diaphragm that electrically controls the amount of the light such as a liquid crystal device.

The projection image 18 and the intermediate image 15 are each a rectangular image plane having first sides 56 facing each other in the Z-axis direction and second sides 57 facing each other in the Y-axis direction, as shown in FIG. 8. Note that the projection image 18 shown in FIG. 8 is the projection image formed by the light modulator 3G. A center line 56a, which is parallel to the first sides 56 of the projection image 18, does not coincide with a center line 56b, which is parallel to the first sides 56 of the intermediate image 15. A center line 57a, which is parallel to the second sides 57 of the projection image 18, does not coincide with a center line 57b, which is parallel to the second sides 57 of the intermediate image 15. That is, the projection image 18 and the intermediate image 15 are located at positions shifted from each other in the Y-axis and Z-axis directions. The dichroic prism 50 and the light combiner 9 are therefore disposed at positions shifted from each other in the Y-axis and Z-axis directions.

The second relay optical system 6 forms the intermediate image 16, which is as large as the invisible image 19 formed at the IR light modulator 81, at the first position S1, as shown in FIGS. 5 and 7. The second relay optical system 6 has the same optical characteristics as the first relay optical system 5. The invisible image 19 is therefore formed at the second position S2 conjugate with the positions where the projection images 18 are formed. The projection images 18, the intermediate image 15, the intermediate image 16, and the invisible image 19 have the same size.

The second relay optical system 6 includes a prism 65, a first lens element 61a, a second reflection member 62, and a second lens element 61b sequentially arranged in the direction in which the invisible light travels from the IR light modulator 81 (second position S2) toward the first position S1. The first lens element 61a and the second lens element 61b form an integral lens member 61 having positive power. The prism 65 is disposed between the second lens element 61b and the IR light modulator 81. In the present embodiment, the lens member 61 has the same configuration as the lens member 51. The second reflection member 62 has the same configuration as the first reflection member 52. Neither the lens member 61 nor the second reflection member 62 will therefore be described in detail.

The prism 65 has the same optical characteristics as the dichroic prism 50. The prism 65 makes the optical distance between the IR light modulator 81 and the light incident surface of the first lens element 61a equal to the optical distance between the light exiting surface of the second lens element 61b and the first position S1. That is, the optical distance between the IR light modulator 81 and the light incident surface of the first lens element 61a is equal to the optical distance between the light modulators 3 and the light incident surface of the first lens element 51a. The optical distance between the light exiting surface of the second lens element 61b and the first position S1 is equal to the optical distance between the light exiting surface of the second lens element 51b and the first position S1.

Since the second relay optical system 6 has the same optical characteristics as the first relay optical system 5, the invisible image 19 and the intermediate image 16 are located at positions shifted from each other in the X-axis and Z-axis directions. The prism 65 and the light combiner 9 disposed between the IR light modulator 81 and the lens member 61 are thus disposed at positions shifted from each other in the X-axis and Z-axis directions.

The second relay optical system 6 includes a second light controlling member 64, which is adjacent to a second transmissive surface 62a on the light incident side of the second transmissive surface 62a and restricts the amount of the light incident on the second reflection member 62. The second light controlling member 64 can be a diaphragm that mechanically controls the amount of light such as a light shielding plate, or a diaphragm that electrically controls the amount of the light such as a liquid crystal device.

The light combiner 9 combines the visible light LA and the invisible light LB with each other into the combined light, as shown in FIG. 5 to 7. The enlarging optical system 7 is disposed at a position shifted in the X1 direction from the light combiner 9, the second lens element 61b is disposed at a position shifted in the Y2 direction from the light combiner 9, and the second lens element 51b is disposed at a position shifted in the X2 direction from the light combiner 9. The light combiner 9 includes a wavelength separating film 91. The wavelength separating film 91 transmits one of infrared light and visible light and reflects the other. In the present embodiment, the wavelength separating film 91 transmits infrared light, which is the visible light LA, and reflects the invisible light LB. The visible light LA output from the first relay optical system 5 therefore passes through the wavelength separating film 91 and enters the enlarging optical system 7, as shown in FIG. 6. The invisible light LB output from the second relay optical system 6 is reflected off the wavelength separating film 91 and enters the enlarging optical system 7, as shown in FIG. 7.

The visible light LA output from the light modulators 3 passes through the dichroic prism 50 and the first lens element 51a and reaches the first reflection member 52, as shown in FIG. 6. The visible light LA output from the first lens element 51a passes through the first transmissive surface 52a and is reflected off the first reflective surface 52b. The visible light LA reflected off the first reflective surface 52b passes through the first transmissive surface 52a and reaches the second lens element 51b. The visible light LA output from the first reflection member 52 passes through the second lens element 51b and reaches the light combiner 9. The visible light LA output from the second lens element 51b passes through the wavelength separating film 91 and is brought into focus as the intermediate image 15 at the first position S1. The visible light LA having passed through the first position S1 enters the enlarging optical system 7. The intermediate image 15 is thus displayed as the combined projection image on the screen S by the enlarging optical system 7.

The invisible light LB output from the IR light modulator 81 passes through the prism 65 and the first lens element 61a and reaches the second reflection member 62, as shown in FIG. 7. The invisible light LB output from the first lens element 61a passes through the second transmissive surface 62a and is reflected off a second reflective surface 62b. The invisible light LB reflected off the second reflective surface 62b passes through the second transmissive surface 62a and reaches the second lens element 61b. The invisible light LB output from the second reflection member 62 passes through the second lens element 61b and reaches the light combiner 9. The invisible light LB output from the second lens element 61b is reflected off the wavelength separating film 91 and brought into focus as the intermediate image 16 at the first position S1. The invisible light LB having passed through the first position S1 enters the enlarging optical system 7. The intermediate image 16 is thus displayed as the invisible image on the screen S by the enlarging optical system 7.

The enlarging optical system 7 forms an image at the first position S1, as shown in FIG. 5 to 7. That is, the reduction-side image formation plane of the enlarging optical system 7 is located at the first position S1. The reduction side of the enlarging optical system 7 is a telecentric system. The term “telecentric” means that the principal ray of each beam passing through the image formation plane is parallel to the optical axis of the image formation plane or substantially parallel to an optical axis N. Since the reduction side of the enlarging optical system 7 is a telecentric system, the principal ray of each beam passing through the reduction-side image formation plane is parallel or substantially parallel to the optical axis N of the reduction-side image formation plane. In the present specification, “telecentric” means that the angle between the principal ray of each luminous flux and the optical axis of the image formation plane is smaller than or equal to ±5°.

The opposite sides of the first relay optical system 5 are telecentric systems, as shown in FIG. 6. The principal ray of each beam passing through the image formation plane at the first position S1 is therefore parallel or substantially parallel to an optical axis N1 of the image formation plane at the first position S1. The principal ray of each beam passing through the image formation surfaces of the light modulators 3 is parallel or substantially parallel to an optical axis N2 of the image formation surfaces of the light modulators 3.

The opposite sides of the second relay optical system 6 are telecentric systems, as shown in FIG. 7. The principal ray of each beam passing through the image formation plane at the first position S1 is therefore parallel or substantially parallel to the optical axis N1 of the image formation plane at the first position S1. The principal ray of each beam passing through the image formation surface of the IR light modulator 81 (second position S2) is parallel or substantially parallel to an optical axis N3 of the formation surface of the IR light modulator 81.

### Lens Data

Data on the lenses of the first projection optical system 41 shown in FIG. 6 are shown below. Surface numbers are sequentially assigned from the enlargement side toward the reduction side. Reference characters are those of the screen, the lenses, the prism, the light deflector, the lens, the dichroic prism, and the light modulators. A surface having a surface number labeled with*is an aspherical surface. R represents the radius of curvature. D represents the axial inter-surface distance. Nd represents the refractive index at the d line. νd represents the Abbe number at the d line. Y represents the effective radius. R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.614 |
| | *2 | −35.90900 | 0.400000 | | | Refraction | 20.077 |
| L2 | 3 | 81.70000 | 2.000000 | 1.49700 | 81.54 | Refraction | 18.151 |
| | 4 | 22.98300 | 12.400000 | | | Refraction | 15.645 |
| L3 | 5 | −31.21800 | 1.200000 | 1.49700 | 81.54 | Refraction | 15.195 |
| | 6 | 118.38200 | 13.384000 | | | Refraction | 15.591 |
| L4 | 7 | 176.01300 | 10.150000 | 1.83400 | 37.16 | Refraction | 17.813 |
| L5 | 8 | −29.89400 | 1.300000 | 1.84666 | 23.78 | Refraction | 17.954 |
| | 9 | −103.47100 | 0.200000 | | | Refraction | 18.233 |
| L6 | 10 | 83.27600 | 1.320000 | 1.84666 | 23.78 | Refraction | 18.000 |
| | 11 | −298.53100 | 33.534000 | | | Refraction | 17.773 |
| L7 | 12 | 63.55500 | 5.580000 | 1.77250 | 49.60 | Refraction | 11.388 |
| L8 | 13 | −43.02500 | 1.100000 | 1.72825 | 28.46 | Refraction | 10.847 |
| | 14 | 1804.82100 | 2.873000 | | | Refraction | 10.388 |
| L9, 75 | 15 | −38.34400 | 1.000000 | 1.76182 | 26.52 | Refraction | 10.000 |
| | 16 | 75.19100 | 5.832000 | | | Refraction | 9.748 |
| L10 | *17 | −217.03500 | 4.360000 | 1.74320 | 49.29 | Refraction | 9.824 |
| | *18 | −29.41800 | 1.830000 | | | Refraction | 10.000 |
| L11 | 19 | −32.01900 | 1.200000 | 1.69895 | 30.13 | Refraction | 10.250 |
| L12 | 20 | 34.78000 | 7.550000 | 1.49700 | 81.54 | Refraction | 11.274 |
| | 21 | −41.76900 | 0.200000 | | | Refraction | 12.439 |
| L13 | 22 | 87.93800 | 4.850000 | 1.80809 | 22.76 | Refraction | 13.405 |
| | 23 | −86.87400 | 0.500000 | | | Refraction | 13.654 |
| L14 | 24 | 170.53700 | 5.170000 | 1.59522 | 67.74 | Refraction | 13.732 |
| | 25 | −55.33000 | 5.119637 | | | Refraction | 13.712 |
| 71 | 26 | 0.00000 | 32.000000 | 1.51680 | 64.17 | Refraction | 12.563 |
| | 27 | 0.00000 | 4.200000 | | | Refraction | 9.383 |
| | 28 | 0.00000 | 3.000000 | | | Refraction | 8.832 |
| 9 | 29 | 0.00000 | 12.500000 | 1.51680 | 64.17 | Refraction | 11.500 |
| 91 | 30 | 0.00000 | 12.500000 | 1.51680 | 64.17 | Refraction | 11.500 |
| | 31 | 0.00000 | 8.820000 | | | Refraction | 11.500 |
| 51b | *32 | 75.20938 | 25.000000 | 1.50940 | 56.47 | Refraction | 39.405 |
| | *33 | −86.40080 | 62.953784 | | | Refraction | 39.516 |
| 52a | *34 | −107.98920 | 9.557316 | 1.50940 | 56.47 | Refraction | 26.500 |
| 52b | *35 | −135.20655 | −9.557316 | 1.50940 | 56.47 | Reflection | 26.000 |
| 52a | *36 | −107.98920 | −62.953784 | | | Refraction | 26.500 |
| 51a | *37 | −86.40080 | −25.000000 | 1.50940 | 56.47 | Refraction | 36.145 |
| | *38 | 75.20938 | −2.441341 | | | Refraction | 42.200 |
| 50 | 39 | 0.00000 | −30.000000 | 1.71736 | 29.50 | Refraction | 19.799 |
| | 40 | 0.00000 | −8.305100 | | | Refraction | 19.799 |
| 3 | 41 | 0.00000 | 0.000000 | | | Refraction | 8.833 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3.314652E−08 | −5.17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | −4.717475E−17 | −3.480507E−15 | 1.826607E−14 |
| 14th-order coefficient | 1.074993E−20 | −2.316431E−20 | −8.166188E−17 | −1.164168E−16 |
| Surface number | 32 | 33 | 34 | 35 |
| Conic constant | 0 | 0 | 1.59961E+00 | 0 |
| 4th-order coefficient | −1.019789E−06 | 4.015744E−07 | 0 | −8.511161E−09 |
| 6th-order coefficient | 1.443295E−10 | −2.351044E−11 | 0 | −3.574313E−12 |
| 8th-order coefficient | −7.137023E−15 | 3.063089E−14 | 0 | 7.006635E−15 |
| 10th-order coefficient | −3.472316E−18 | −4.551714E−18 | 0 | −3.002244E−18 |

| Surface number | 36 | 37 | 38 |
|---|---|---|---|
| Conic constant | 1.59961E+00 | 0 | 0 |
| 4th-order coefficient | 0 | 4.015744E−07 | −1.019789E−06 |
| 6th-order coefficient | 0 | −2.351044E−11 | 1.443295E−10 |
| 8th-order coefficient | 0 | 3.063089E−14 | −7.137023E−15 |
| 10th-order coefficient | 0 | −4.551714E−18 | −3.472316E−18 |

Data on the lenses of the second projection optical system 42 shown in FIG. 7 are shown below. Surface numbers are sequentially assigned from the enlargement side toward the reduction side. Reference characters are those of the screen, the lenses, the prism, the light combiner, the lens, the prism, and the IR light modulator. A surface having a surface number labeled with*is an aspherical surface. R represents the radius of curvature. D represents the axial inter-surface distance. Nd represents the refractive index at the d line. νd represents the Abbe number at the d line. Y represents the effective radius. R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.614 |
| | *2 | −35.90900 | 0.400000 | | | Refraction | 20.077 |
| L2 | 3 | 81.70000 | 2.000000 | 1.49700 | 81.54 | Refraction | 18.151 |
| | 4 | 22.98300 | 12.400000 | | | Refraction | 15.645 |
| L3 | 5 | −31.21800 | 1.200000 | 1.49700 | 81.54 | Refraction | 15.195 |
| | 6 | 118.38200 | 13.384000 | | | Refraction | 15.591 |
| L4 | 7 | 176.01300 | 10.150000 | 1.83400 | 37.16 | Refraction | 17.813 |
| L5 | 8 | −29.89400 | 1.300000 | 1.84666 | 23.78 | Refraction | 17.954 |
| | 9 | −103.47100 | 0.200000 | | | Refraction | 18.233 |
| L6 | 10 | 83.27600 | 4.320000 | 1.84666 | 23.78 | Refraction | 18.000 |
| | 11 | −298.53100 | 33.534000 | | | Refraction | 17.773 |
| L7 | 12 | 63.55500 | 5.580000 | 1.77250 | 49.60 | Refraction | 11.388 |
| L8 | 13 | −43.02500 | 1.100000 | 1.72825 | 28.46 | Refraction | 10.847 |
| | 14 | 1804.82100 | 2.873000 | | | Refraction | 10.388 |
| L9, 75 | 15 | −38.34400 | 1.000000 | 1.76182 | 26.52 | Refraction | 10.000 |
| | 16 | 75.19100 | 5.832000 | | | Refraction | 9.748 |
| L10 | *17 | −217.03500 | 4.360000 | 1.74320 | 49.29 | Refraction | 9.824 |
| | *18 | −29.41800 | 1.830000 | | | Refraction | 10.000 |
| L11 | 19 | −32.01900 | 1.200000 | 1.69895 | 30.13 | Refraction | 10.250 |
| L12 | 20 | 34.78000 | 7.550000 | 1.49700 | 81.54 | Refraction | 11.274 |
| | 21 | −41.76900 | 0.200000 | | | Refraction | 12.439 |
| L13 | 22 | 87.93800 | 4.850000 | 1.80809 | 22.76 | Refraction | 13.405 |
| | 23 | −86.87400 | 0.500000 | | | Refraction | 13.654 |
| L14 | 24 | 170.53700 | 5.170000 | 1.59522 | 67.74 | Refraction | 13.732 |
| | 25 | −55.33000 | 5.119637 | | | Refraction | 13.712 |
| 71 | 26 | 0.00000 | 32.000000 | 1.51680 | 64.17 | Refraction | 12.563 |
| | 27 | 0.00000 | 4.200000 | | | Refraction | 9.383 |
| | 28 | 0.00000 | 3.000000 | | | Refraction | 8.832 |
| 9 | 29 | 0.00000 | 12.500000 | 1.51680 | 64.17 | Refraction | 11.500 |
| 91 | 30 | 0.00000 | −12.500000 | 1.51680 | 64.17 | Reflection | 16.500 |
| | 31 | 0.00000 | −8.820000 | | | Refraction | 11.500 |
| 61a | *32 | −75.20938 | −25.000000 | 1.50940 | 56.47 | Refraction | 39.832 |
| | *33 | 86.40080 | −62.953784 | | | Refraction | 39.965 |
| 62a | *34 | 107.98920 | −9.557316 | 1.50940 | 56.47 | Refraction | 26.500 |
| 62b | *35 | 135.20655 | 9.557316 | 1.50940 | 56.47 | Reflection | 26.000 |
| 62a | *36 | 107.98920 | 62.953784 | | | Refraction | 26.500 |
| 61b | *37 | 86.40080 | 25.000000 | 1.50940 | 56.47 | Refraction | 36.145 |
| | *38 | −75.20938 | 2.441341 | | | Refraction | 42.200 |
| 65 | 39 | 0.00000 | 30.000000 | 1.71736 | 29.50 | Refraction | 19.799 |
| | 40 | 0.00000 | 8.305100 | | | Refraction | 19.799 |
| 81 | 41 | 0.00000 | 0.000000 | | | Refraction | 8.833 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3.314652E−08 | −5.17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | −4.717475E−17 | −3.480507E−15 | 1.826607E−14 |
| 14th-order coefficient | 1.074993E−20 | −2.316431E−20 | −8.166188E−17 | −1.164168E−16 |

| Surface number | 32 | 33 | 34 | 35 |
|---|---|---|---|---|
| Conic constant | 0 | 0 | 1.59961E+00 | 0 |
| 4th-order coefficient | −1.019789E−06 | 4.015744E−07 0 | 0 | −8.511161E−09 |
| 6th-order coefficient | 1.443295E−10 | −2. 351044E−11 0 | 0 | −3.574313E−12 |
| 8th-order coefficient | −7.137023E−15 | 3.063089E−14 0 | 0 | 7.006635E−15 |
| 10th-order coefficient | −3.472316E−18 | −4.551714E−18 0 | 0 | −3.002244E−18 |

| Surface number | 36 | 37 | 38 |
|---|---|---|---|
| Conic constant | 1.59961E+00 | 0 | 0 |
| 4th-order coefficient | 0 | 4.015744E−07 | −1.019789E−06 |
| 6th-order coefficient | 0 | −2.351044E−11 | 1.443295E−10 |
| 8th-order coefficient | 0 | 3.063089E−14 | −7.137023E−15 |
| 10th-order coefficient | 0 | −4.551714E−18 | −3.472316E−18 |

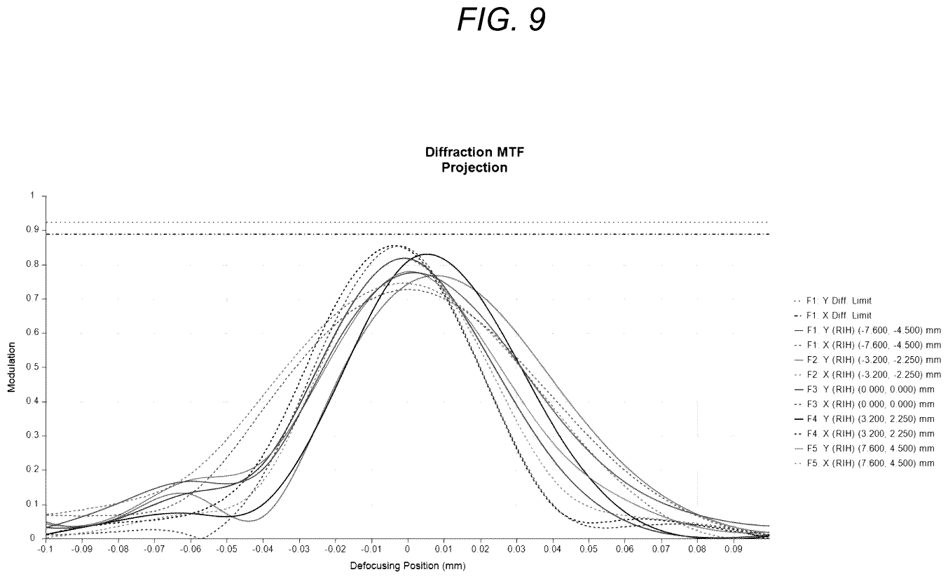

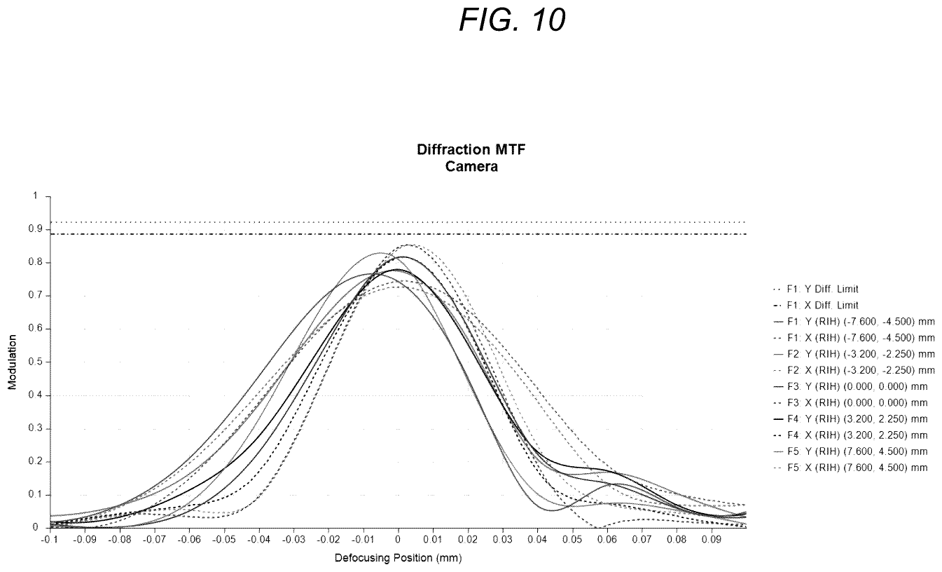

FIG. 9 shows the reduction-side MTF or the first projection optical system 41. FIG. 10 shows the reduction-side MTF of the second projection optical system 42. In FIGS. 9 and 10, the horizontal axis represents the spatial frequency, and the vertical axis represents the contrast reproduction ratio. The first projection optical system 41 provides high resolution, as shown in FIG. 9. The second projection optical system 42 provides high resolution, as shown in FIG. 10.

### Effects and Advantages

The projector 1 according to the present embodiment includes the first light source 21, the light modulators 3, which modulate the visible light LA output from the first light source 21 to form the projection images 18, the first relay optical system 5, which forms a projection image at the first position S1, the enlarging optical system 7, the invisible image generator 8, which forms the invisible image 19 made of the invisible light LB, and the light combiner 9, which is disposed in the optical path between the enlarging optical system 7 and the light modulators 3 and combines the visible light LA and the invisible light LB with each other into combined light. The invisible image 19 is formed at the second position S2 conjugate with the positions where the projection images 18 are formed. The enlarging optical system 7 forms an image at the first position S1 and projects the combined light to display the projection images 18 and the invisible image 19 on the same screen S.

According to the present embodiment, since the projection images 18 and the invisible image 19 displayed on the screen S are displayed on the same screen S by the common enlarging optical system 7, the positional relationship between the projection images 18 and the invisible image 19 displayed on the screen S is unlikely to change even when the enlarging optical system 7 is affected by the temperature.

Furthermore, in the projector 1 according to the present embodiment, since the projection images 18 and the invisible image 19 are displayed on the same screen S by the single enlarging optical system 7, the size of the projector 1 and the manufacturing cost of the projector 1 are reduced as compared with a case where the projection images 18 and the invisible image 19 are displayed on the same screen S by different optical systems.

Since the enlarging optical system 7 forms an image at the first position S1, the back focal length of the enlarging optical system 7 is shortened as compared with a case where the enlarging optical system 7 forms an image at the position of each of the light modulators 3. The contrast of the projection images 18 displayed on the screen S is thus improved. Furthermore, since the invisible image 19 is formed at the second position S2 conjugate with the positions where the projection images 18 are formed, the contrast of the invisible image 19 displayed on the screen S is also improved. Moreover, since the back focal length of the enlarging optical system 7 is shortened, the size of the enlarging optical system 7 can be reduced.

The projector system PS1 according to the present embodiment includes the projector 1, the imager 17, which captures an image of the invisible image 19 displayed on the screen S, the recognizer 103, which recognizes a positional deviation of the invisible image 19 from the reference position on the screen S based on the image of the invisible image 19 captured by the imager 17, and the first display driver 101, which corrects the position of the projection images 18 displayed on the screen S based on the positional deviation recognized by the recognizer 103.

The projector system PS1 thus corrects the positions of the projection images 18 displayed on the screen S based on the positional deviation of the invisible image 19 recognized by the recognizer 103, so that the positions of the projection images 18 displayed on the screen S are always kept constant. Therefore, the projector system PS1 according to the present embodiment, when used for projection mapping in which a projection image is projected on a specific object or multi-projection in which multiple projection images projected from multiple projectors are arranged to form a single display image, can prevent the projection image from deviating from the specific object or the multiple projection images from deviating from each other or overlapping with each other.

The first relay optical system 5 has the first reflective surface 52b having a concave shape. The thus configured first relay optical system 5 has a folded optical path, so that the entire first relay optical system 5 can be made compact. Furthermore, the first reflective surface 52b, which allows the optical path of the first relay optical system 5 to be folded, can reduce chromatic aberrations produced by the folded optical path.

The second relay optical system 6 has the second reflective surface 62b having a concave shape. The thus configured second relay optical system 6 has a folded optical path, so that the entire second relay optical system 6 can be made compact. Furthermore, the second reflective surface 62b, which allows the optical path of the second relay optical system 6 to be folded, can improve the contrast of the invisible image displayed on the screen S. As a result, the imager 17 can capture an image of the invisible image with higher accuracy.

The invisible image generator 8 includes the IR light modulator 81, which forms the invisible image 19. The invisible image 19 can therefore be formed in any manner, so that the imager 17 can capture an image of the invisible image 19 displayed on the screen S with higher accuracy.

The invisible image generator 8 includes the second light source 82, which outputs the invisible light LB, and the transmissive liquid crystal panel 810 as the IR light modulator 81. The liquid crystal panel 810 modulates the invisible light LB output from the second light source 82 to form an invisible image. When the IR light modulator 81 is a reflective liquid crystal panel, the IR light modulator 81 needs to have a structure that prevents beam interference. The size of the IR light modulator 81 is therefore reduced as compared with the case where the IR light modulator 81 is a reflective liquid crystal panel.

The invisible light is infrared light having a peak wavelength longer than or equal to 840 nm but shorter than or equal to 860 nm, or infrared light having a peak wavelength longer than or equal to 930 nm but shorter than or equal to 950 nm. More preferably, the wavelength of the invisible light is 850 nm or 940 nm. When the wavelength of the invisible light is 850 nm, the light emission efficiency of the infrared light from the second light source 82 can be increased, so that the imaging device 171 of the imager 17 can favorably capture the invisible image even when the imaging device 171 has low sensitivity. Since the light emission efficiency of the infrared light from the second light source 82 can be increased, the power consumed by the second light source 82 is reduced. When the wavelength of the invisible light is 940 nm, the invisible light is unlikely to be affected by external light, so that the invisible image displayed on the screen S becomes clear.

The enlarging optical system 7 paired with the first relay optical system 5 can be replaced with another. The enlarging optical system 7 of the projector 1 can thus be replaced with another in accordance with the projection specifications. Furthermore, the reduction side of the enlarging optical system 7 is a telecentric system. Therefore, when the enlarging optical system 7 is attached to the first relay optical system 5, and even when the reduction-side image formation plane of the enlarging optical system 7 deviates from the first position S1 in the optical axis direction, the enlarging optical system 7 can favorably project the intermediate image 15 of the projection images 18 on the enlargement side.

The opposite sides of the first relay optical system 5 are telecentric systems. The opposite sides of the second relay optical system 6 are telecentric systems. Therefore, even when the light modulators 3 are shifted in the optical axis direction, the intermediate image 15 of the projection images 18 with no change in magnification can be formed at the first position S1. Furthermore, even when the IR light modulator 81 is shifted in the optical axis direction, the intermediate image 16 of the invisible image 19 having no change in magnification can be formed at the first position S1.

### Second Embodiment

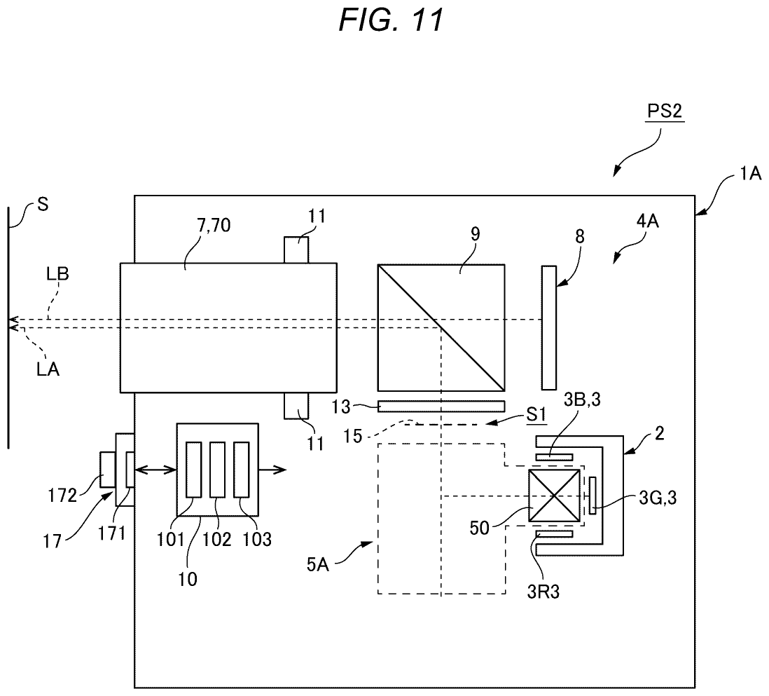

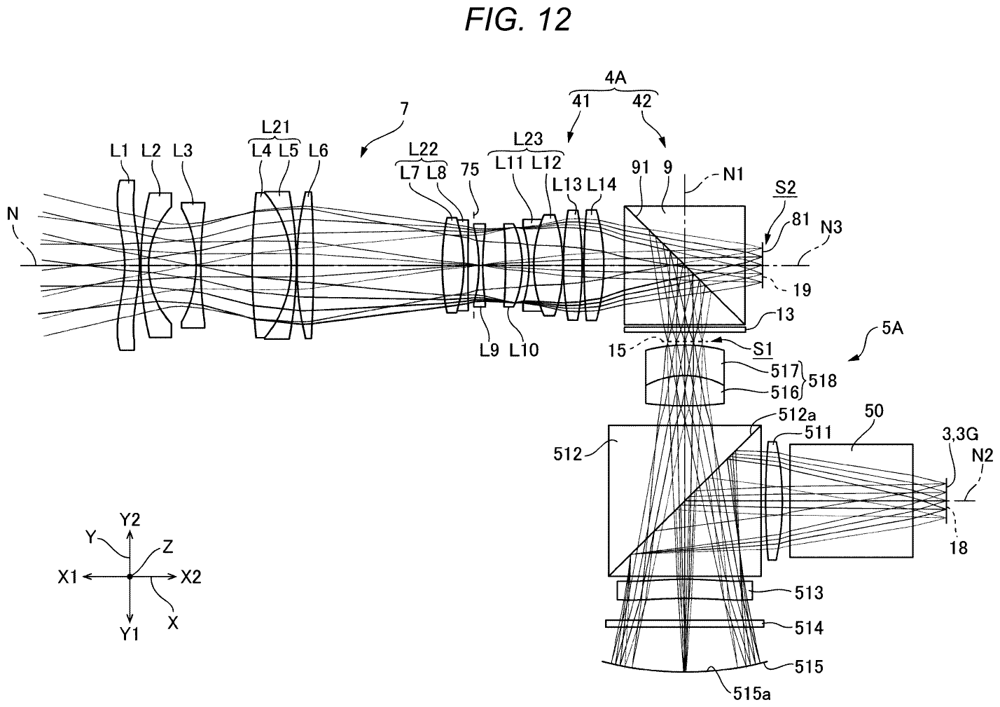

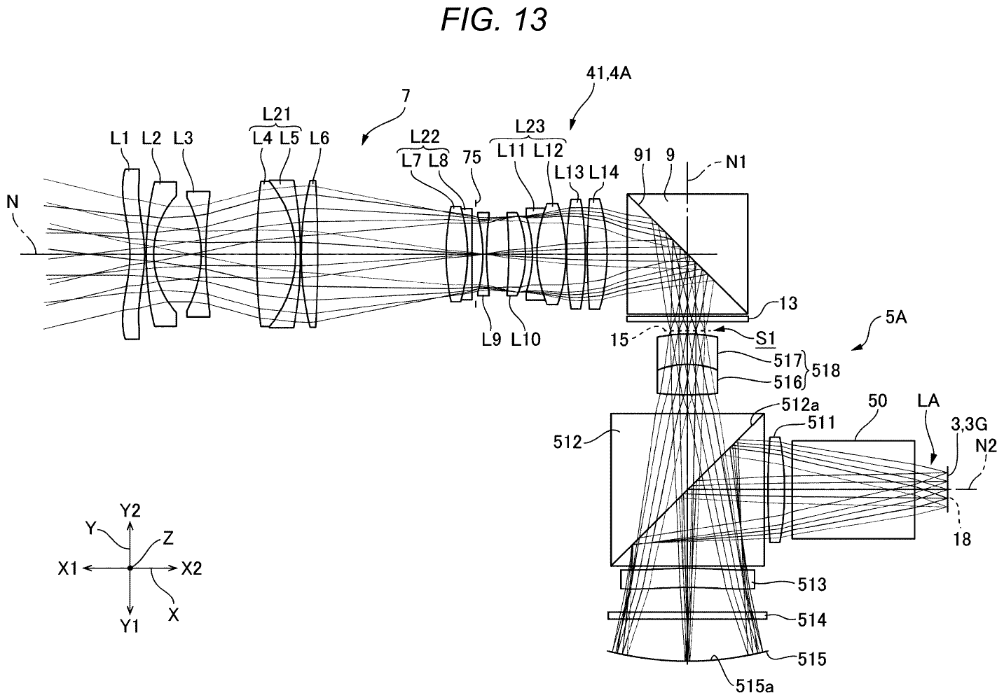

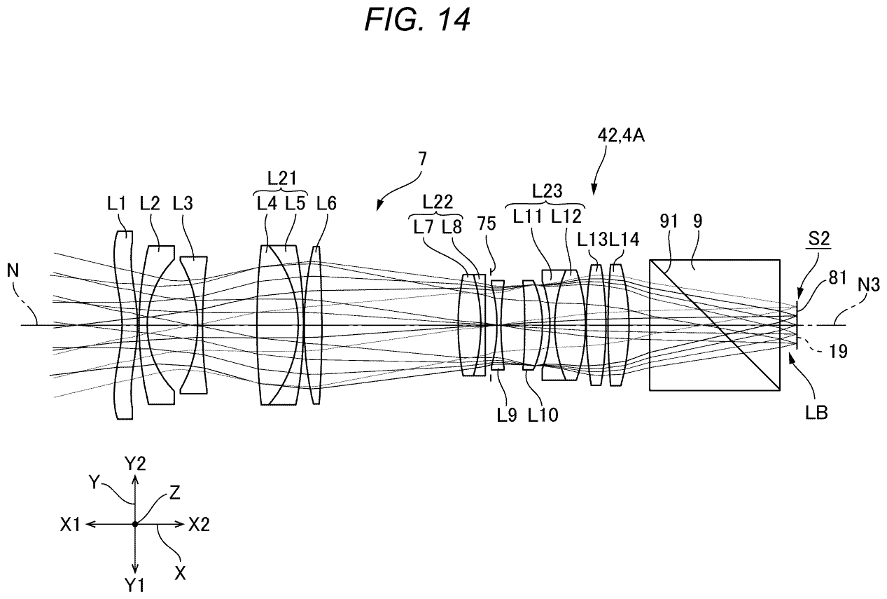

FIG. 11 is a schematic view of key parts of a projector system PS2 according a second embodiment. FIG. 12 shows a schematic configuration of an optical system 4A in the second embodiment. FIG. 13 is a schematic configuration diagram of the first projection optical system 41, which projects visible light, out of the optical system 4A in the second embodiment. FIG. 14 is a schematic configuration diagram of the second projection optical system 42, which projects invisible light, out of the optical system 4A in the second embodiment. The optical system 4A of the projector system PS2 according to the second embodiment shown in FIG. 11 differs from the optical system 4 of the projector system PS1 according to the first embodiment. Therefore, in the second embodiment, the same configurations as those in the first embodiment have the same reference characters, and will not be described in some cases.

The optical system 4A includes a first relay optical system 5A, the enlarging optical system 7, the light combiner 9, and a retardation film 13, as shown in FIG. 11. The first relay optical system 5A includes the dichroic prism 50.

The optical system 4A includes the first projection optical system 41 shown in FIG. 13, which projects the visible light LA, and the second projection optical system 42 shown in FIG. 14, which projects the invisible light LB, as shown in FIG. 12.

The enlarging optical system 7 includes 14 lenses L1 to L14, as shown in FIG. 12 to 14. The lenses L1 to L14 are arranged in this order from the enlargement side toward the reduction side. The diaphragm 75 is disposed between the lens L8 and the lens L9. The lenses L4 and L5 are cemented to each other into the cemented lens L21. The lenses L7 and L8 are cemented to each other into the cemented lens L22. The lenses L11 and L12 are cemented to each other into the cemented lens L23. The lens L1 has aspherical surfaces on opposite sides. The lens L10 has aspherical surfaces on opposite sides.

The first relay optical system 5A forms the projection images 18 at the first position S1, as shown in FIGS. 12 and 13. In the present embodiment, the first relay optical system 5A forms the intermediate image 15, which is as large as the projection image 18 formed at the light modulators 3, at the first position S1. The first position S1 is located between the retardation film 13 and the first relay optical system 5A. The first relay optical system 5A includes the dichroic prism 50, a first lens 511, a polarization combining/separating prism 512, a second lens 513, a retardation film 514, a first reflection member 515, a third lens 516, and a fourth lens 517 sequentially arranged in the direction in which the visible light travels from the light modulators 3 toward the first position S1. The dichroic prism 50 is located between the light modulators 3 and the first lens 511 and shifted in the X1 direction from the light modulators 3. The first lens 511 and the second lens 513 constitute a first lens group, and the second lens 513, the third lens 516, and the fourth lens 517 constitute a second lens group.

The first lens 511 has positive power. The polarization combining/separating prism 512 is disposed at a position shifted in the X1 direction from the first lens 511. The polarization combining/separating prism 512 includes a polarization separating film 512a. The polarization separating film 512a transmits one of the P-polarized and S-polarized components out of the polarized components contained in the beams, and reflects the other polarized component. In the present embodiment, the polarization separating film 512a transmits the P-polarized component and reflects the S-polarized component out of the polarized components contained in the beams.

The second lens 513 is disposed at a position shifted in the Y1 direction from the polarization combining/separating prism 512. The second lens 513 has negative power. The second lens 513 has aspherical surfaces on opposite sides. The retardation film 514 is disposed at a position shifted in the Y1 direction from the second lens 513. The retardation film 514 is a λ/4 plate. The first reflection member 515 is disposed at a position shifted in the Y1 direction from the retardation film 514. The first reflection member 515 has a first reflective surface 515a. The first reflective surface 515a has a concave shape recessed toward the Y1 side. The first reflective surface 515a has an aspherical shape. The third lens 516 and the fourth lens 517 are disposed at positions shifted in the Y2 direction from the polarization combining/separating prism 512. The third lens 516 and the fourth lens 517 are cemented to each other into a cemented lens 518. The cemented lens 518 has positive power.

The retardation film 13 is disposed on the enlargement side of the first relay optical system 5A, as shown in FIGS. 12 and 13. The retardation film 13 is a λ/2 plate. The light combiner 9 combines the visible light LA and the invisible light LB with each other into the combined light, as shown in FIG. 12 to 14. The enlarging optical system 7 is disposed at a position shifted in the X1 direction from the light combiner 9, the IR light modulator 81 is disposed at a position shifted in the X2 direction from the light combiner 9, and the fourth lens 517 of the first relay optical system 5A is disposed at a position shifted in the Y1 direction from the light combiner 9. The light combiner 9 includes a wavelength separating film 91. The wavelength separating film 91 transmits one of infrared light and visible light and reflects the other. In the present embodiment, the wavelength separating film 91 transmits infrared light, which is the visible light LA, and reflects the invisible light LB. The visible light LA output from the first relay optical system 5A is therefore reflected off the wavelength separating film 91 and enters the enlarging optical system 7, as shown in FIG. 13. The invisible light LB output from the IR light modulator 81 passes through the wavelength separating film 91 and enters the enlarging optical system 7, as shown in FIG. 14.

The S-polarized visible light LA output from the light modulators 3 passes through the dichroic prism 50 and the first lens 511 and reaches the polarization combining/separating prism 512, as shown in FIG. 13. The visible light LA output from the first lens 511 is reflected off the polarization separating film 512a and reaches the second lens 513. The visible light LA output from the second lens 513 passes through the retardation film 514, which circularly polarizes the visible light LA. The visible light LA having passed through the retardation film 514 is reflected off the first reflective surface 515a. The visible light LA reflected off the first reflective surface 515a passes through the retardation film 514 again, which converts the visible light LA into P-polarized visible light LA, which reaches the polarization combining/separating prism 512. The visible light LA output from the retardation film 514 passes through the polarization separating film 512a and the cemented lens 518, and is brought into focus as the intermediate image 15 at the first position S1. The visible light LA having passed through the first position S1 passes through the retardation film 13, which converts the visible light LA into S-polarized visible light LA, which reaches the light combiner 9. The visible light LA having passed through the retardation film 13 is reflected off the wavelength separating film 91 and enters the enlarging optical system 7. The intermediate image 15 is thus displayed as the combined projection image on the screen S by the enlarging optical system 7.

The first relay optical system 5A may include a light controlling member that is located on the side facing the first reflective surface 515a of the first reflection member 515 and restricts the amount of the light incident on the first reflection member. The light controlling member can be a diaphragm that mechanically controls the amount of the light such as a light shielding plate, or a diaphragm that electrically controls the amount of the light such as a liquid crystal device. The contrast of the intermediate image 15 formed at the first position S1 can thus be improved. As a result, the contrast of the combined projection image displayed on the screen S can be improved.

The invisible image 19 is formed at the second position S2 conjugate with the positions where the projection images 18 are formed, as shown in FIG. 14. The invisible light LB output from the IR light modulator 81 passes through the light combiner 9 and enters the enlarging optical system 7. The invisible image 19 is thus displayed on the screen S by the enlarging optical system 7.

The enlarging optical system 7 forms an image at the first position S1, as shown in FIG. 12 to 14. That is, the reduction-side image formation plane of the enlarging optical system 7 is located at the first position S1. The reduction side of the enlarging optical system 7 is a telecentric system. Since the reduction side of the enlarging optical system 7 is a telecentric system, the principal ray of each beam passing through the reduction-side image formation plane is parallel or substantially parallel to the optical axis N of the reduction-side image formation plane. The enlarging optical system 7 forms an image also at the second position S2. That is, the reduction-side image formation plane of the enlarging optical system 7 is also located at the position where the IR light modulator 81 is disposed.

The opposite sides of the first relay optical system 5A are telecentric systems, as shown in FIG. 13. The principal ray of each beam passing through the image formation plane at the first position S1 is therefore parallel or substantially parallel to the optical axis N1 of the image formation plane at the first position S1. The principal ray of each beam passing through the image formation surfaces of the light modulators 3 is parallel or substantially parallel to the optical axis N2 of the image formation surfaces of the light modulators 3.

Since the reduction side of the enlarging optical system 7 is a telecentric system, the principal ray of each beam passing through the image formation surface of the IR light modulator 81 is parallel or substantially parallel to the optical axis N3 of the image formation surface of the IR light modulator 81, as shown in FIG. 14.

### Lens Data

Data on the lenses of the first projection optical system 41 shown in FIG. 13 are shown below. Surface numbers are sequentially assigned from the enlargement side toward the reduction side. Reference characters are those of the screen, the lenses, the light combiner, the lenses, the polarization combining/separating prism, the dichroic prism, and the light modulators. A surface having a surface number labeled with*is an aspherical surface. R represents the radius of curvature. D represents the axial inter-surface distance. Nd represents the refractive index at the d line. νd represents the Abbe number at the d line. Y represents the effective radius. R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.000 |
| | *2 | −35.90900 | 0.400000 | | | Refraction | 19.556 |
| L2 | 3 | 81.70000 | 2.000000 | 1.49700 | 81.54 | Refraction | 17.735 |
| | 4 | 22.98300 | 12.400000 | | | Refraction | 15.392 |
| L3 | 5 | −31.21800 | 1.200000 | 1.49700 | 81.54 | Refraction | 14.911 |
| | 6 | 118.38200 | 13.384000 | | | Refraction | 15.325 |
| L4 | 7 | 176.01300 | 10.150000 | 1.83400 | 37.16 | Refraction | 17.641 |
| L5 | 8 | −29.89400 | 1.300000 | 1.84666 | 23.78 | Refraction | 17.802 |
| | 9 | −103.47100 | 0.200000 | | | Refraction | 18.099 |
| L6 | 10 | 83.27600 | 4.320000 | 1.84666 | 23.78 | Refraction | 18.000 |
| | 11 | −298.53100 | 33.534000 | | | Refraction | 17.796 |
| L7 | 12 | 63.55500 | 5.580000 | 1.77250 | 49.60 | Refraction | 11.502 |
| L8 | 13 | −43.02500 | 1.100000 | 1.72825 | 28.46 | Refraction | 10.945 |
| | 14 | 1804.82100 | 2.873000 | | | Refraction | 10.461 |
| L9, 75 | 15 | −38.34400 | 1.000000 | 1.76182 | 26.52 | Refraction | 10.000 |
| | 16 | 75.19100 | 5.832000 | | | Refraction | 9.776 |
| L10 | *17 | −217.03500 | 4.360000 | 1.74320 | 49.29 | Refraction | 9.777 |
| | *18 | −29.41800 | 1.830000 | | | Refraction | 10.000 |
| L11 | 19 | −32.01900 | 1.200000 | 1.69895 | 30.13 | Refraction | 10.108 |
| L12 | 20 | 34.78000 | 7.550000 | 1.49700 | 81.54 | Refraction | 11.067 |
| | 21 | −41.76900 | 0.200000 | | | Refraction | 12.227 |
| L13 | 22 | 87.93800 | 4.850000 | 1.80809 | 22.76 | Refraction | 13.114 |
| | 23 | −86.87400 | 0.500000 | | | Refraction | 13.356 |
| L14 | 24 | 170.53700 | 5.170000 | 1.59522 | 67.74 | Refraction | 13.417 |
| | 25 | −55.33000 | 5.119637 | | | Refraction | 13.385 |
| 9 | 26 | 0.00000 | 16.000000 | 1.51680 | 64.17 | Refraction | 12.318 |
| 91 | 27 | 0.00000 | −16.000000 | 1.51680 | 64.17 | Reflection | 14.448 |
| | 28 | 0.00000 | −5.000000 | | | Refraction | 9.331 |
| 517 | 29 | −37.80107 | −8.000000 | 1.80420 | 46.50 | Refraction | 9.179 |
| 516 | 30 | −20.90626 | −8.000000 | 1.67011 | 23.90 | Refraction | 9.087 |
| | 31 | 84.38721 | −5.000000 | | | Refraction | 9.289 |
| 512 | 32 | 0.00000 | −20.000000 | 1.51680 | 64.17 | Refraction | 9.326 |
| 512a | 33 | 0.00000 | −20.000000 | 1.51680 | 64.17 | Refraction | 11.161 |
| | 34 | 0.00000 | −0.644094 | | | Refraction | 14.565 |
| 513 | *35 | −98.23961 | −5.000000 | 1.50940 | 56.47 | Refraction | 14.871 |
| | *36 | −110.57456 | −19.438469 | | | Refraction | 15.756 |
| 515a | *37 | 82.97883 | 19.438469 | | | Reflection | 20.083 |
| 513 | *38 | −110.57456 | 5.000000 | 1.50940 | 56.47 | Refraction | 16.356 |
| | *39 | −98.23961 | 0.644094 | | | Refraction | 15.562 |
| 512 | 40 | 0.00000 | 20.000000 | 1.51680 | 64.17 | Refraction | 15.306 |
| 512a | 41 | 0.00000 | −20.000000 | 1.51680 | 64.17 | Reflection | 20.000 |
| | 42 | 0.00000 | −1.000000 | | | Refraction | 14.381 |
| 511 | 43 | −181.66230 | −4.338165 | 1.77223 | 47.70 | Refraction | 14.419 |
| | 44 | 80.74054 | −2.000000 | | | Refraction | 14.368 |
| 50 | 45 | 0.00000 | −32.000000 | 1.51680 | 64.20 | Refraction | 13.768 |
| | 46 | 0.00000 | −8.705166 | | | Refraction | 10.171 |
| 3 | 47 | 0.00000 | 0.000000 | | | Refraction | 8.838 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3.314652E−08 | −5.17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | −4.717475E−17 | −3.480507E−15 | 1.826607E−14 |
| 14th-order coefficient | 1.074993E−20 | −2.316431E−20 | −8.166188E−17 | −1.164168E−16 |

| Surface number | 35 | 36 | 37 |
|---|---|---|---|
| Conic constant | 0 | 0 | −1.00E+00 |
| 4th-order coefficient | 1.201655E−05 | 1.051619E−05 | 8.382102E−08 |
| 6th-order coefficient | 2.746810E−09 | 2.638418E−09 | −6.123083E−11 |
| 8th-order coefficient | 1.094746E−11 | 4.371560E−12 | −5.053909E−13 |
| 10th-order coefficient | −3.531471E−14 | −2.640316E−14 | 1.061247E−15 |

| Surface number | 38 | 39 |
|---|---|---|
| Conic constant | 0 | 0 |
| 4th-order coefficient | 1.051619E−05 | 1.201655E−05 |
| 6th-order coefficient | 2.638418E−09 | 2.746810E−09 |
| 8th-order coefficient | 4.371560E−12 | 1.094746E−11 |
| 10th-order coefficient | −2.640316E−14 | −3.531471E−14 |

Data on the lenses of the second projection optical system 42 shown in FIG. 14 are shown below. Surface numbers are sequentially assigned from the enlargement side toward the reduction side. Reference characters are those of the screen, the lenses, the light combiner, and the imaging device. A surface having a surface number labeled with*is an aspherical surface. R represents the radius of curvature. D represents the axial inter-surface distance. Nd represents the refractive index at the d line. νd represents the Abbe number at the d line. Y represents the effective radius. R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.000 |
| | *2 | −35.90900 | 0.400000 | | | Refraction | 19.556 |
| L2 | 3 | 81.70000 | 2.000000 | 1.49700 | 81.54 | Refraction | 17.735 |
| | 4 | 22.98300 | 12.400000 | | | Refraction | 15.392 |
| L3 | 5 | −31.21800 | 1.200000 | 1.49700 | 81.54 | Refraction | 14.911 |
| | 6 | 118.38200 | 13.384000 | | | Refraction | 15.325 |
| L4 | 7 | 176.01300 | 10.150000 | 1.83400 | 37.16 | Refraction | 17.641 |
| L5 | 8 | −29.89400 | 1.300000 | 1.84666 | 23.78 | Refraction | 17.802 |
| | 9 | −103.47100 | 0.200000 | | | Refraction | 18.099 |
| L6 | 10 | 83.27600 | 4.320000 | 1.84666 | 23.78 | Refraction | 18.000 |
| | 11 | −298.53100 | 33.534000 | | | Refraction | 17.796 |
| L7 | 12 | 63.55500 | 5.580000 | 1.77250 | 49.60 | Refraction | 11.502 |
| L8 | 13 | −43.02500 | 1.100000 | 1.72825 | 28.46 | Refraction | 10.945 |
| | 14 | 1804.82100 | 2.873000 | | | Refraction | 10.461 |
| L9, 75 | 15 | −38.34400 | 1.000000 | 1.76182 | 26.52 | Refraction | 10.000 |
| | 16 | 75.19100 | 5.832000 | | | Refraction | 9.776 |
| L10 | *17 | −217.03500 | 4.360000 | 1.74320 | 49.29 | Refraction | 9.777 |
| | *18 | −29.41800 | 1.830000 | | | Refraction | 10.000 |
| L11 | 19 | −32.01900 | 1.200000 | 1.69895 | 30.13 | Refraction | 10.108 |
| L12 | 20 | 34.78000 | 7.550000 | 1.49700 | 81.54 | Refraction | 11.067 |
| | 21 | −41.76900 | 0.200000 | | | Refraction | 12.227 |
| L13 | 22 | 87.93800 | 4.850000 | 1.80809 | 22.76 | Refraction | 13.114 |
| | 23 | −86.87400 | 0.500000 | | | Refraction | 13.356 |
| L14 | 24 | 170.53700 | 5.170000 | 1.59522 | 67.74 | Refraction | 13.417 |
| | 25 | −55.33000 | 5.119637 | | | Refraction | 13.385 |
| 9 | 26 | 0.00000 | 16.000000 | 1.51680 | 64.17 | Refraction | 10.417 |
| 91 | 27 | 0.00000 | 16.000000 | 1.51680 | 64.17 | Refraction | 10.417 |
| | 28 | 0.00000 | 4.200000 | | | Refraction | 5.495 |
| 81 | 29 | 0.00000 | 0.000000 | | | Refraction | 4.503 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3.314652E−08 | −5.17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | −4.717475E−17 | −3.480507E−15 | 1.826607E−14 |
| 14th-order coefficient | 1.074993E−20 | −2.316431E−20 | −8.166188E−17 | −1.164168E−16 |

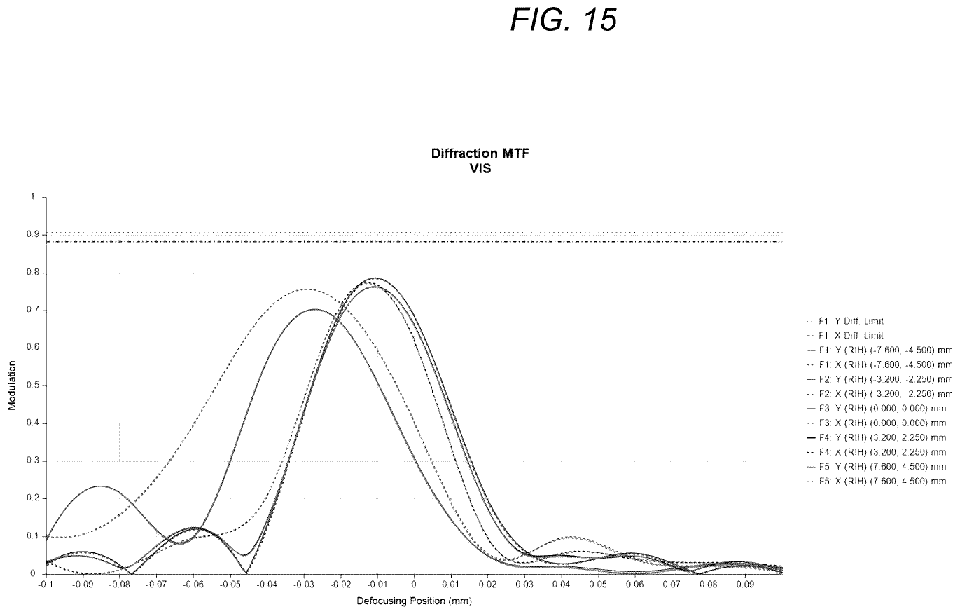

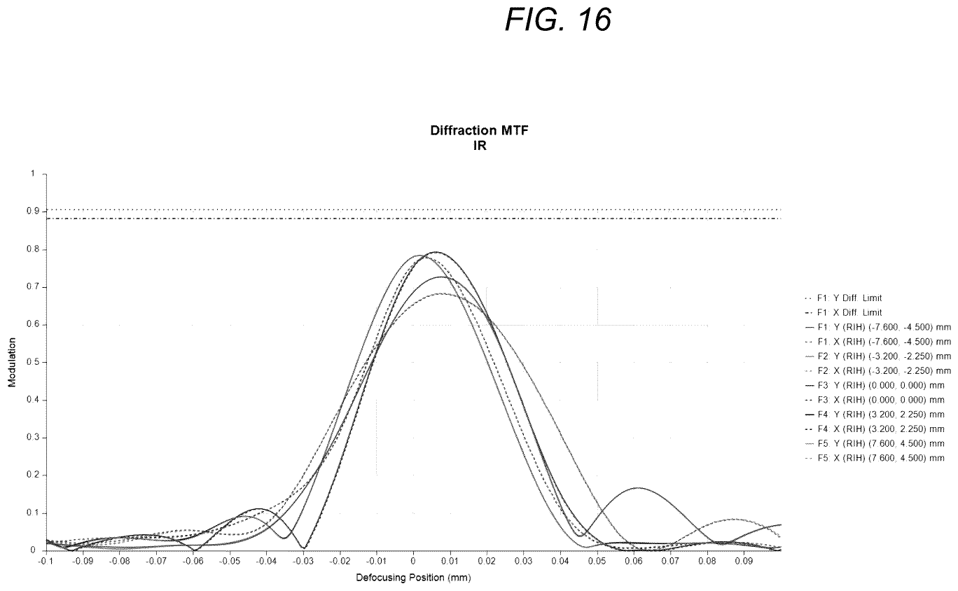

FIG. 15 shows the reduction-side MTF of the first projection optical system 41. FIG. 16 shows the reduction-side MTF of the second projection optical system 42. The first projection optical system 41 provides high resolution, as shown in FIG. 15. The second projection optical system 42 provides high resolution, as shown in FIG. 16.

### Effects and Advantages

The enlarging optical system 7 forms an image at the second position S2. Therefore, since the invisible light LB from the IR light modulator 81 reaches the enlarging optical system 7 only after passing through the light combiner 9, the invisible image displayed on the screen S has high image quality. Furthermore, the amount of the invisible light LB reaching the enlarging optical system 7 can be secured. Since the invisible image displayed on the screen S has high image quality, the imager 17 can capture an image of the invisible image with higher accuracy.

The projector system PS2 according to the second embodiment has the same configuration as the projector system PS1 according to the first embodiment. The projector system PS2 according to the second embodiment therefore provides the same effects and advantages as the projector system PS1 according to the first embodiment.

### Third Embodiment

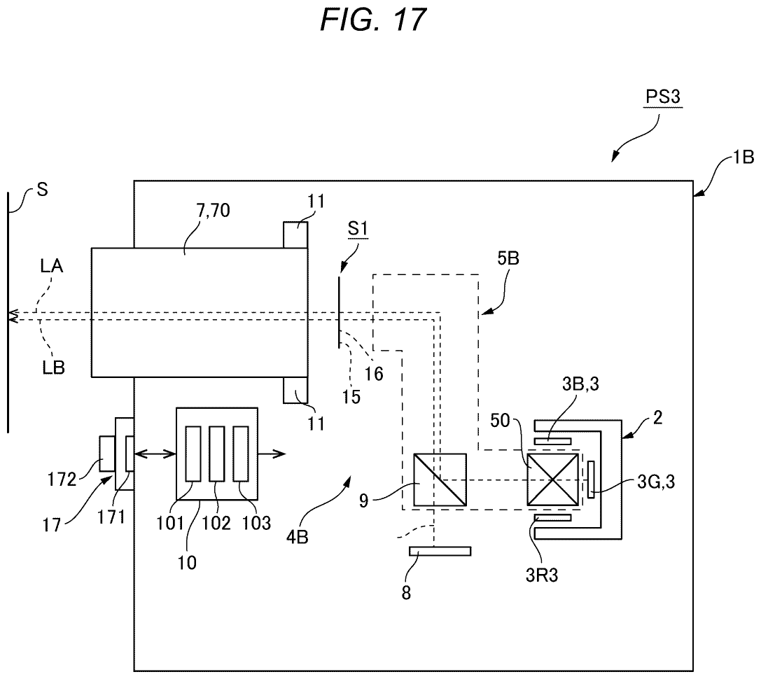

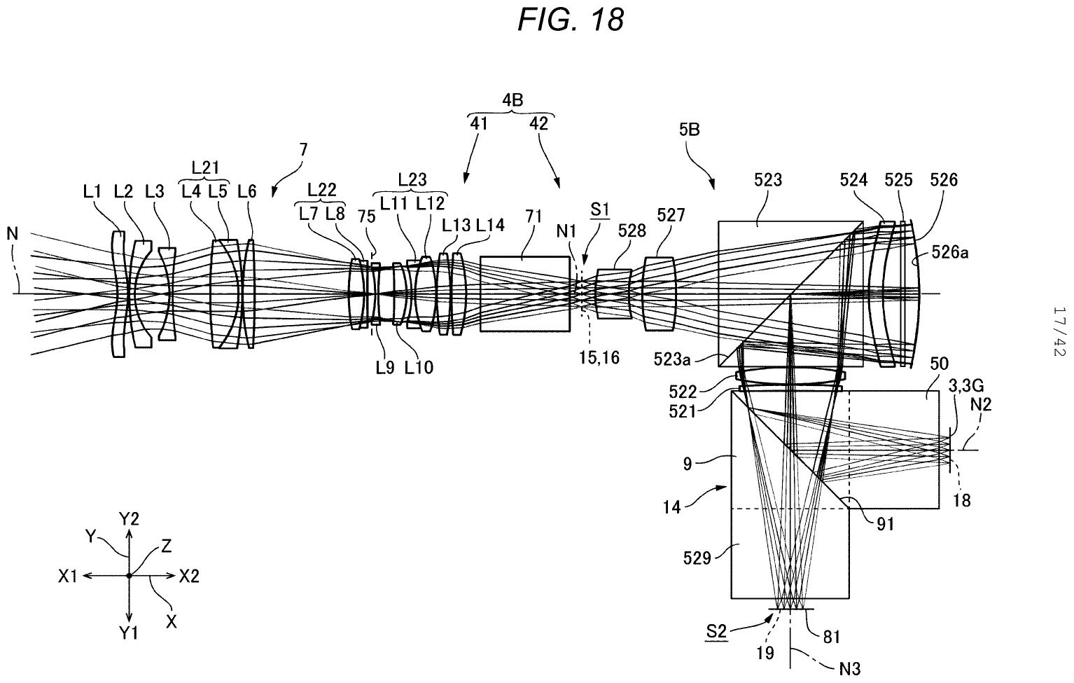

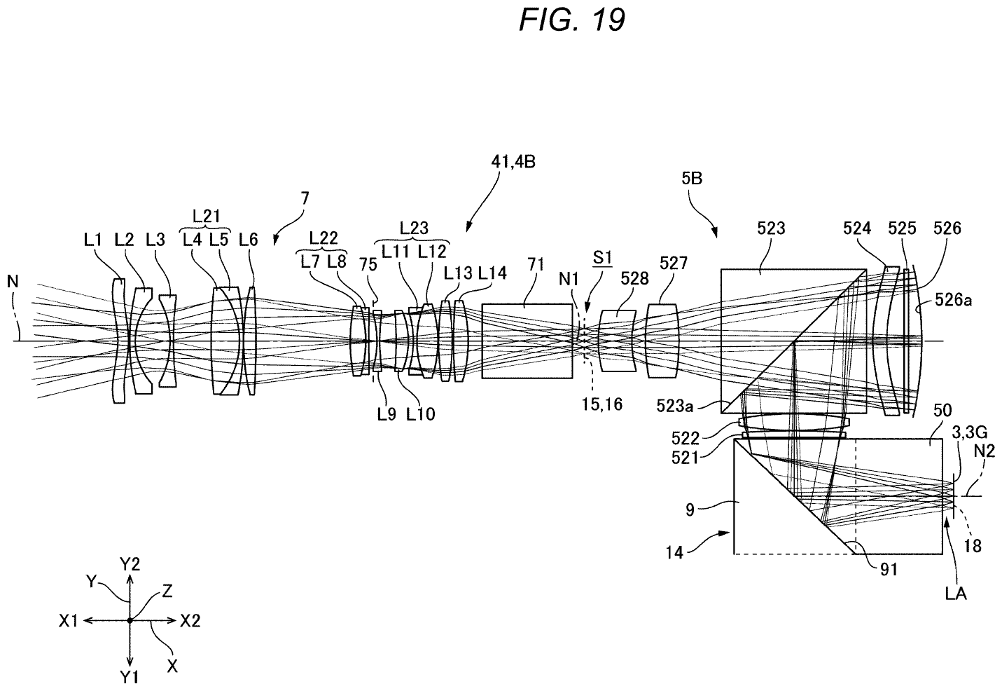

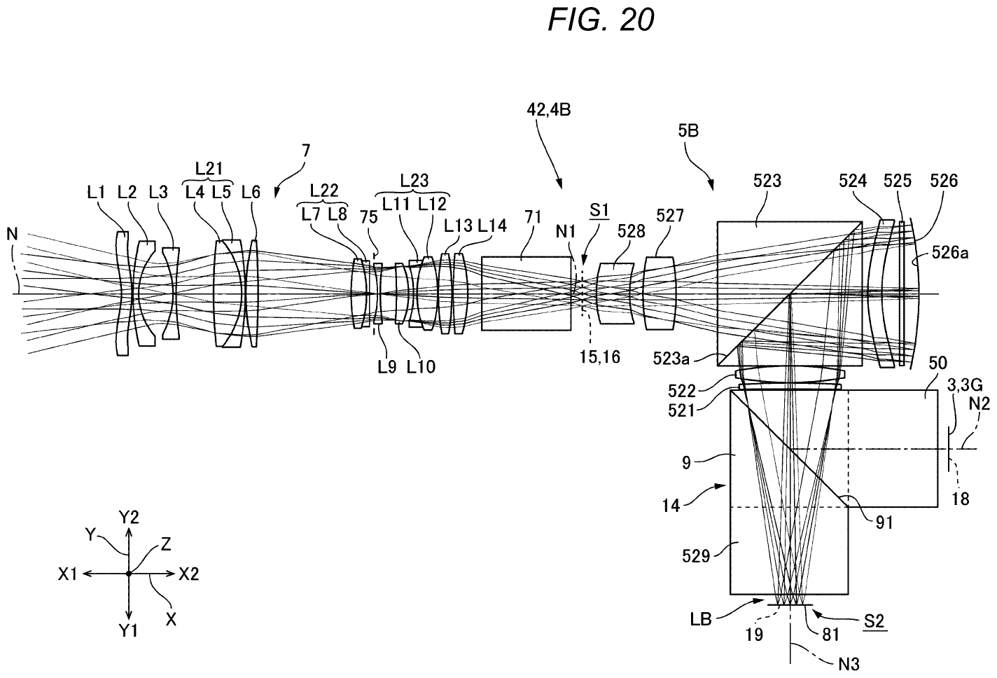

FIG. 17 is a schematic view of key parts of a projector system PS3 according a third embodiment. FIG. 18 shows a schematic configuration of an optical system 4B in the third embodiment. FIG. 19 is a schematic configuration diagram of the first projection optical system 41, which projects visible light, out of the optical system 4B in the third embodiment. FIG. 20 is a schematic configuration diagram of the second projection optical system 42, which projects invisible light, out of the optical system 4B in the third embodiment. The optical system 4B of the projector system PS3 according to the third embodiment shown in FIG. 17 differs from the optical system 4 of the projector system PS1 according to the first embodiment. Therefore, in the third embodiment, the same configurations as those in the first embodiment have the same reference characters, and will not be described in some cases.

The optical system 4B includes a first relay optical system 5B, the enlarging optical system 7, and the light combiner 9, as shown in FIG. 17. The first relay optical system 5B includes the dichroic prism 50. The light combiner 9 is disposed inside the first relay optical system 5B.

The optical system 4 includes the first projection optical system 41 shown in FIG. 19, which projects the visible light LA, and the second projection optical system 42 shown in FIG. 20, which projects the invisible light LB, as shown in FIG. 18.

The enlarging optical system 7 includes 14 lenses L1 to L14 and the prism 71, as shown in FIG. 18 to 20. The lenses L1 to L14 are arranged in this order from the enlargement side toward the reduction side. The prism 71 is disposed on the reduction side of the lens L14. A diaphragm 75 is disposed between the lens L8 and the lens L9. The lenses L4 and L5 are cemented to each other into the cemented lens L21. The lenses L7 and L8 are cemented to each other into the cemented lens L22. The lenses L11 and L12 are cemented to each other into the cemented lens L23. The lens L1 has aspherical surfaces on opposite sides. The lens L10 has aspherical surfaces on opposite sides.

The first relay optical system 5B forms the projection images 18 at the first position S1, as shown in FIGS. 18 and 19. In the present embodiment, the first relay optical system 5B forms the intermediate image 15, which is as large as the projection images 18 formed at the light modulators 3, at the first position S1. The first position S1 is located between the first relay optical system 5B and the enlarging optical system 7. The first relay optical system 5B includes the dichroic prism 50, a first lens 521, a second lens 522, a polarization combining/separating prism 523, a third lens 524, a retardation film 525, a first reflection member 526, a fourth lens 527, and a fifth lens 528 sequentially arranged in the direction in which the visible light travels from the light modulators 3 toward the first position S1. The light combiner 9 is disposed between the dichroic prism 50 and the first lens 521 in the optical path along which the visible light LA travels. The first relay optical system 5B includes a prism 529 disposed at a position shifted in the Y1 direction from the light combiner 9. The first lens 521, the second lens 522, and the third lens 524 constitute a first lens group, and the third lens 524, the fourth lens 527, and the fifth lens 528 constitute a second lens group.

The dichroic prism 50 is located between the light modulators 3 and the light combiner 9 and shifted in the X1 direction from the light modulators 3. The first lens 521 is disposed at a position shifted in the Y2 direction from the light combiner 9. The first lens 521 has positive power. The second lens 522 is disposed at a position shifted in the Y2 direction from the first lens 521. The second lens 522 has positive power. The polarization combining/separating prism 523 is disposed at a position shifted in the Y2 direction from the second lens 522. The polarization combining/separating prism 523 includes a polarization separating film 523a. The polarization separating film 523a transmits one of the P-polarized and S-polarized components out of the polarized components contained in the beams, and reflects the other polarized component. In the present embodiment, the polarization separating film 523a transmits the S-polarized component and reflects the P-polarized component out of the polarized components contained in the beams.

The third lens 524 is disposed at a position shifted in the X2 direction from the polarization combining/separating prism 523. The third lens 524 has negative power. The third lens 524 has aspherical surfaces on opposite sides. The retardation film 525 is disposed at a position shifted in the X2 direction from the third lens 524. The retardation film 525 is a λ/4 plate. The first reflection member 526 is disposed at a position shifted in the X2 direction from the retardation film 525. The first reflection member 526 has a first reflective surface 526a. The first reflective surface 526a has a concave shape recessed toward the X2 side. The first reflective surface 526a has an aspherical shape.

The fourth lens 527 is disposed at a position shifted in the X1 direction from the polarization combining/separating prism 523. The fourth lens 527 has positive power. The fifth lens 528 is disposed at a position shifted in the X1 direction from the fourth lens 527. The fifth lens 528 has negative power.

The light combiner 9 combines the visible light LA and the invisible light LB with each other into the combined light, as shown in FIG. 18 to 20. The first lens 521 is disposed at a position shifted in the Y2 direction from the light combiner 9, the light modulators 3 are disposed at a position shifted in the X2 direction from the light combiner 9, and the IR light modulator 81 is disposed at a position shifted from the light combiner 9 in the Y1 direction. The light combiner 9 includes the wavelength separating film 91. The wavelength separating film 91 transmits one of infrared light and visible light and reflects the other. In the present embodiment, the wavelength separating film 91 reflects infrared light, which is visible light LA, and transmits the invisible light LB. The visible light LA output from the dichroic prism 50 is therefore reflected off the wavelength separating film 91 and enters the enlarging optical system 7, as shown in FIG. 19. The invisible light LB output from the IR light modulator 81 passes through the wavelength separating film 91 and enters the enlarging optical system 7, as shown in FIG. 20.

The prism 529 has the same optical characteristics as the dichroic prism 50. The prism 529 makes the optical distance between the IR light modulator 81 and the light combiner 9 equal to the optical distance between the light modulators 3 and the light combiner 9. The first relay optical system 5B forms the invisible image 19 at the first position S1, as shown in FIG. 20. That is, the first relay optical system 5B forms the intermediate image 16, which is as large as the invisible image 19 formed by the IR light modulator 81, at the first position S1. The invisible image 19 is therefore formed at the second position S2 conjugate with the positions where the projection images 18 are formed. The projection images 18, the intermediate image 15, the intermediate image 16, and the invisible image 19 have the same size.

In the present embodiment, the dichroic prism 50, the light combiner 9, and the prism 529 constitute an integral prism block 14. The dichroic prism 50, the light combiner 9, and the prism 529 can thus be configured with the single prism block 14, so that the parts can be assembled with improved accuracy. Note that the dichroic prism 50, the light combiner 9, and the prism 529 may be separate members.

The S-polarized visible light LA output from the light modulators 3 passes through the dichroic prism 50 and reaches the light combiner 9, as shown in FIG. 19. The visible light LA output from the dichroic prism 50 is reflected off the wavelength separating film 91, passes through the first lens 521 and the second lens 522, and reaches the polarization combining/separation prism 523. The visible light LA output from the second lens 522 is reflected off the polarization separating film 523a and reaches the third lens 524.

The visible light LA output from the third lens 524 passes through the retardation film 525, which circularly polarizes the visible light LA. The visible light LA having passed through the retardation film 525 is reflected off the first reflective surface 526a. The visible light LA reflected off the first reflective surface 526a passes through the retardation film 525 again, which converts the visible light LA into P-polarized visible light LA, which reaches the polarization combining/separating prism 523. The visible light LA output from the retardation film 525 passes through the polarization separating film 523a, the fourth lens 527, and the fifth lens 528, and is brought into focus as the intermediate image 15 at the first position S1. The visible light LA having passed through the first position S1 enters the enlarging optical system 7. The intermediate image 15 is thus displayed as the combined projection image on the screen S by the enlarging optical system 7.

The S-polarized invisible light LB output from the IR light modulator 81 passes through the prism 529 and reaches the light combiner 9, as shown in FIG. 20. The invisible light LB output from the prism 529 passes through the wavelength separating film 91, the first lens 521, and the second lens 522, and reaches the polarization combining/separation prism 523. The invisible light LB output from the second lens 522 is reflected off the polarization separating film 523a and reaches the third lens 524.

The invisible light LB output from the third lens 524 passes through the retardation film 525, which circularly polarizes the visible light LB. The invisible light LB having passed through the retardation film 525 is reflected off the first reflective surface 526a. The invisible light LB reflected off the first reflective surface 526a passes through the retardation film 525 again, which converts the visible light LB into P-polarized visible light LB, which reaches the polarization combining/separating prism 523. The invisible light LB output from the retardation film 525 passes through the polarization separating film 523a, the fourth lens 527, and the fifth lens 528, and is brought into focus as the intermediate image 16 at the first position S1. The invisible light LB having passed through the first position S1 enters the enlarging optical system 7. The intermediate image 16 is thus displayed as the invisible image on the screen S by the enlarging optical system 7.

The first relay optical system 5B may include a light controlling member that is located on the side facing the first reflective surface 526a of the first reflection member 526 and restricts the amount of the light incident on the first reflection member. The light controlling member can be a diaphragm that mechanically controls the amount of the light such as a light shielding plate, or a diaphragm that electrically controls the amount of the light such as a liquid crystal device. The contrast of the intermediate image 15 formed at the first position S1 can thus be improved. As a result, the contrast of the combined projection image displayed on the screen S can be improved. The contrast of the intermediate image 16 formed at the first position S1 can thus be improved. As a result, the contrast of the invisible image displayed on the screen S can be improved.

The reduction-side image formation plane of the enlarging optical system 7 is located at the first position S1, as shown in FIGS. 18 to 20. The reduction side of the enlarging optical system 7 is a telecentric system. Since the reduction side of the enlarging optical system 7 is a telecentric system, the principal ray of each beam passing through the reduction-side image formation plane is parallel or substantially parallel to the optical axis N of the reduction-side image formation plane.

The opposite sides of the first relay optical system 5B are telecentric systems, as shown in FIGS. 19 and 20. The principal ray of each beam passing through the image formation plane at the first position S1 is therefore parallel or substantially parallel to the optical axis N1 of the image formation plane at the first position S1. The principal ray of each beam passing through the image formation surfaces of the light modulators 3 is parallel or substantially parallel to the optical axis N2 of the image formation surfaces of the light modulators 3. The principal ray of each beam passing through the image formation surface of the IR light modulator 81 is parallel or substantially parallel to the optical axis N3 of the image formation surface of the IR light modulator 81.

### Lens Data

Data on the lenses of the first projection optical system 41 shown in FIG. 19 are shown below. Surface numbers are sequentially assigned from the enlargement side toward the reduction side. Reference characters are those of the screen, the lenses, the prism, the lenses, the prism, the lenses, the light combiner, the dichroic prism, and the light modulators. A surface having a surface number labeled with*is an aspherical surface. R represents the radius of curvature. D represents the axial inter-surface distance. Nd represents the refractive index at the d line. νd represents the Abbe number at the d line. Y represents the effective radius. R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.000 |
| | *2 | −35.90900 | 0.400000 | | | Refraction | 19.556 |
| L2 | 3 | 81.70000 | 2.000000 | 1.49700 | 81.54 | Refraction | 17.735 |
| | 4 | 22.98300 | 12.400000 | | | Refraction | 15.392 |
| L3 | 5 | −31.21800 | 1.200000 | 1.49700 | 81.54 | Refraction | 14.911 |
| | 6 | 118.38200 | 13.384000 | | | Refraction | 15.325 |
| L4 | 7 | 176.01300 | 10.150000 | 1.83400 | 37.16 | Refraction | 17.641 |
| L5 | 8 | −29.89400 | 1.300000 | 1.84666 | 23.78 | Refraction | 17.802 |
| | 9 | −103.47100 | 0.200000 | | | Refraction | 18.099 |
| L6 | 10 | 83.27600 | 4.320000 | 1.84666 | 23.78 | Refraction | 18.000 |
| | 11 | −298.53100 | 33.534000 | | | Refraction | 17.796 |
| L7 | 12 | 63.55500 | 5.580000 | 1.77250 | 49.60 | Refraction | 11.502 |
| L8 | 13 | −43.02500 | 1.100000 | 1.72825 | 28.46 | Refraction | 10.945 |
| | 14 | 1804.82100 | 2.873000 | | | Refraction | 10.461 |
| L9, 75 | 15 | −38.34400 | 1.000000 | 1.76182 | 26.52 | Refraction | 10.000 |
| | 16 | 75.19100 | 5.832000 | | | Refraction | 9.776 |
| L10 | *17 | −217.03500 | 4.360000 | 1.74320 | 49.29 | Refraction | 9.777 |
| | *18 | −29.41800 | 1.830000 | | | Refraction | 10.000 |
| L11 | 19 | −32.01900 | 1.200000 | 1.69895 | 30.13 | Refraction | 10.108 |
| L12 | 20 | 34.78000 | 7.550000 | 1.49700 | 81.54 | Refraction | 11.067 |
| | 21 | −41.76900 | 0.200000 | | | Refraction | 12.227 |
| L13 | 22 | 87.93800 | 4.850000 | 1.80809 | 22.76 | Refraction | 13.114 |
| | 23 | −86.87400 | 0.500000 | | | Refraction | 13.356 |
| L14 | 24 | 170.53700 | 5.170000 | 1.59522 | 67.74 | Refraction | 13.417 |
| | 25 | −55.33000 | 5.119637 | | | Refraction | 13.385 |
| 71 | 26 | 0.00000 | 32.000000 | 1.51680 | 64.17 | Refraction | 12.239 |
| | 27 | 0.00000 | 9.189561 | | | Refraction | 9.289 |
| 528 | 28 | 39.41593 | 12.000000 | 1.77250 | 49.62 | Refraction | 10.002 |
| | 29 | 37.12254 | 4.803539 | | | Refraction | 9.988 |
| 527 | 30 | 69.46159 | 12.000000 | 1.58144 | 40.89 | Refraction | 11.093 |
| | 31 | −73.57415 | 15.000000 | | | Refraction | 12.107 |
| 523 | 32 | 0.00000 | 26.000000 | 1.51680 | 64.17 | Refraction | 15.175 |
| 523a | 33 | 0.00000 | 26.000000 | 1.51680 | 64.17 | Refraction | 19.172 |
| | 34 | 0.00000 | 2.000000 | | | Refraction | 23.196 |
| 524 | *35 | 63.18083 | 5.000000 | 1.50940 | 56.47 | Refraction | 24.616 |
| | *36 | 59.71497 | 10.000000 | | | Refraction | 24.982 |
| 526a | *37 | −117.95288 | −10.000000 | | | Reflection | 25.728 |
| 524 | *38 | 59.71497 | −5.000000 | 1.50940 | 56.47 | Refraction | 25.216 |
| | *39 | 63.18083 | −2.000000 | | | Refraction | 25.093 |
| 523 | 40 | 0.00000 | −26.000000 | 1.51680 | 64.17 | Refraction | 24.106 |
| 523a | 41 | 0.00000 | 26.000000 | 1.51680 | 64.17 | Reflection | 32.663 |
| | 42 | 0.00000 | 0.100000 | | | Refraction | 18.596 |
| 522 | 43 | 106.34979 | 6.100930 | 1.49700 | 81.61 | Refraction | 18.324 |
| | 44 | −105.71672 | 0.100000 | | | Refraction | 17.829 |
| 521 | 45 | 320.35200 | 2.262085 | 1.58144 | 40.89 | Refraction | 17.089 |
| | 46 | 1868.83177 | 0.100000 | | | Refraction | 16.640 |
| 9 | 47 | 0.00000 | 21.000000 | 1.51680 | 64.20 | Refraction | 16.630 |
| 91 | 48 | 0.00000 | −21.000000 | 1.51680 | 64.20 | Reflection | 21.620 |
| 50 | 49 | 0.00000 | −32.000000 | 1.51680 | 64.20 | Refraction | 11.607 |
| | 50 | 0.00000 | −3.812973 | | | Refraction | 9.193 |
| 3 | 51 | 0.00000 | 0.000000 | | | Refraction | 8.833 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3.314652E−08 | −5.17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | 4.717475E−17 | −3.480507E−15 | 1.826607E−14 |
| 14th-order coefficient | 1.074993E−20 | −2.316431E−20 | −8.166188E−17 | −1.164168E−16 |

| Surface number | 35 | 36 | 37 |
|---|---|---|---|
| Conic constant | −1.00E+00 | −1.00E+00 | −1.00E+00 |
| 4th-order coefficient | −2.230389E−06 | −2.316343E−06 | 2.049472E−08 |
| 6th-order coefficient | −2.206091E−10 | −3.306150E−10 | 5.756230E−11 |
| 8th-order coefficient | 3.728125E−13 | 5.687054E−13 | 7.644694E−14 |
| 10th-order coefficient | −5.403157E−16 | −3.680130E−16 | −1.804365E−16 |

| Surface number | 38 | 39 |
|---|---|---|
| Conic constant | −1.00E+00 | −1.00E+00 |
| 4th-order coefficient | −2.316343E−06 | −2.230389E−06 |
| 6th-order coefficient | −3.306150E−10 | −2.206091E−10 |
| 8th-order coefficient | 5.687054E−13 | 3.728125E−13 |
| 10th-order coefficient | −3.680130E−16 | −5.403157E−16 |

Data on the lenses of the second projection optical system 42 shown in FIG. 20 are shown below. Surface numbers are sequentially assigned from the enlargement side toward the reduction side. Reference characters are those of the screen, the lenses, the prism, the lenses, the prism, the lenses, the light combiner, the prism, and the imaging devices. A surface having a surface number labeled with*is an aspherical surface. R represents the radius of curvature. D represents the axial inter-surface distance. Nd represents the refractive index at the d line. νd represents the Abbe number at the d line. Y represents the effective radius. R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.000 |
| | *2 | −35.90900 | 0.400000 | | | Refraction | 19.556 |
| L2 | 3 | 81.70000 | 2.000000 | 1.49700 | 81.54 | Refraction | 17.735 |
| | 4 | 22.98300 | 12.400000 | | | Refraction | 15.392 |
| L3 | 5 | −31.21800 | 1.200000 | 1.49700 | 81.54 | Refraction | 14.911 |
| | 6 | 118.38200 | 13.384000 | | | Refraction | 15.325 |
| L4 | 7 | 176.01300 | 10.150000 | 1.83400 | 37.16 | Refraction | 17.641 |
| L5 | 8 | −29.89400 | 1.300000 | 1.84666 | 23.78 | Refraction | 17.802 |
| | 9 | −103.47100 | 0.200000 | | | Refraction | 18.099 |
| L6 | 10 | 83.27600 | 4.320000 | 1.84666 | 23.78 | Refraction | 18.000 |
| | 11 | −298.53100 | 33.534000 | | | Refraction | 17.796 |
| L7 | 12 | 63.55500 | 5.580000 | 1.77250 | 49.60 | Refraction | 11.502 |
| L8 | 13 | −43.02500 | 1.100000 | 1.72825 | 28.46 | Refraction | 10.945 |
| | 14 | 1804.82100 | 2.873000 | | | Refraction | 10.461 |
| L9, 75 | 15 | −38.34400 | 1.000000 | 1.76182 | 26.52 | Refraction | 10.000 |
| | 16 | 75.19100 | 5.832000 | | | Refraction | 9.776 |
| L10 | *17 | −217.03500 | 4.360000 | 1.74320 | 49.29 | Refraction | 9.777 |
| | *18 | −29.41800 | 1.830000 | | | Refraction | 10.000 |
| L11 | 19 | −32.01900 | 1.200000 | 1.69895 | 30.13 | Refraction | 10.108 |
| L12 | 20 | 34.78000 | 7.550000 | 1.49700 | 81.54 | Refraction | 11.067 |
| | 21 | −41.76900 | 0.200000 | | | Refraction | 12.227 |
| L13 | 22 | 87.93800 | 4.850000 | 1.80809 | 22.76 | Refraction | 13.114 |
| | 23 | −86.87400 | 0.500000 | | | Refraction | 13.356 |
| L14 | 24 | 170.53700 | 5.170000 | 1.59522 | 67.74 | Refraction | 13.417 |
| | 25 | −55.33000 | 5.119637 | | | Refraction | 13.385 |
| 71 | 26 | 0.00000 | 32.000000 | 1.51680 | 64.17 | Refraction | 12.239 |
| | 27 | 0.00000 | 9.189561 | | | Refraction | 9.289 |
| 528 | 28 | 39.41593 | 12.000000 | 1.77250 | 49.62 | Refraction | 10.002 |
| | 29 | 37.12254 | 4.803539 | | | Refraction | 9.988 |
| 527 | 30 | 69.46159 | 12.000000 | 1.58144 | 40.89 | Refraction | 11.093 |
| | 31 | −73.57415 | 15.000000 | | | Refraction | 12.107 |
| 523 | 32 | 0.00000 | 26.000000 | 1.51680 | 64.17 | Refraction | 15.175 |
| 523a | 33 | 0.00000 | 26.000000 | 1.51680 | 64.17 | Refraction | 19.172 |
| | 34 | 0.00000 | 2.000000 | | | Refraction | 23.196 |
| 524 | *35 | 63.18083 | 5.000000 | 1.50940 | 56.47 | Refraction | 24.616 |
| | *36 | 59.71497 | 10.000000 | | | Refraction | 24.982 |
| 526a | *37 | −117.95288 | −10.000000 | | | Reflection | 25.728 |
| 524 | *38 | 59.71497 | −5.000000 | 1.50940 | 56.47 | Refraction | 25.216 |
| | *39 | 63.18083 | −2.000000 | | | Refraction | 25.093 |
| 523 | 40 | 0.00000 | −26.000000 | 1.51680 | 64.17 | Refraction | 24.106 |
| 523a | 41 | 0.00000 | 26.000000 | 1.51680 | 64.17 | Reflection | 32.663 |
| | 42 | 0.00000 | 0.100000 | | | Refraction | 18.596 |
| 522 | 43 | 106.34979 | 6.100930 | 1.49700 | 81.61 | Refraction | 18.324 |
| | 44 | −105.71672 | 0.100000 | | | Refraction | 17.829 |
| 521 | 45 | 320.35200 | 2.262085 | 1.58144 | 40.89 | Refraction | 17.089 |
| | 46 | 1868.83177 | 0.100000 | | | Refraction | 16.640 |
| 9 | 47 | 0.00000 | 21.000000 | 1.51680 | 64.20 | Refraction | 16.630 |
| 91 | 48 | 0.00000 | 21.000000 | 1.51680 | 64.20 | Reflection | 21.620 |
| 530 | 49 | 0.00000 | 32.000000 | 1.51680 | 64.20 | Refraction | 11.607 |
| | 50 | 0.00000 | 3.812973 | | | Refraction | 9.193 |
| 81 | 51 | 0.00000 | 0.000000 | | | Refraction | 8.833 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3.314652E−08 | −5.17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | −4.717475E−17 | −3.480507E−15 | 1.826607E−14 |
| 14th-order coefficient | 1.074993E−20 | −2.316431E−20 | −8.166188E−17 | −1.164168E−16 |

| Surface number | 35 | 36 | 37 |
|---|---|---|---|
| Conic constant | −1.00E+00 | −1.00E+00 | −1.00E+00 |
| 4th-order coefficient | −2.230389E−06 | −2.316343E−06 | 2.049472E−08 |
| 6th-order coefficient | −2.206091E−10 | −3.306150E−10 | 5.756230E−11 |
| 8th-order coefficient | 3.728125E−13 | 5.687054E−13 | 7.644694E−14 |
| 10th-order coefficient | −5.403157E−16 | −3.680130E−16 | −1.804365E−16 |

| Surface number | 38 | 39 |
|---|---|---|
| Conic constant | −1.00E+00 | −1.00E+00 |
| 4th-order coefficient | −2.316343E−06 | −2.230389E−06 |
| 6th-order coefficient | −3.306150E−10 | −2.206091E−10 |
| 8th-order coefficient | 5.687054E−13 | 3.728125E−13 |
| 10th-order coefficient | −3.680130E−16 | −5.403157E−16 |

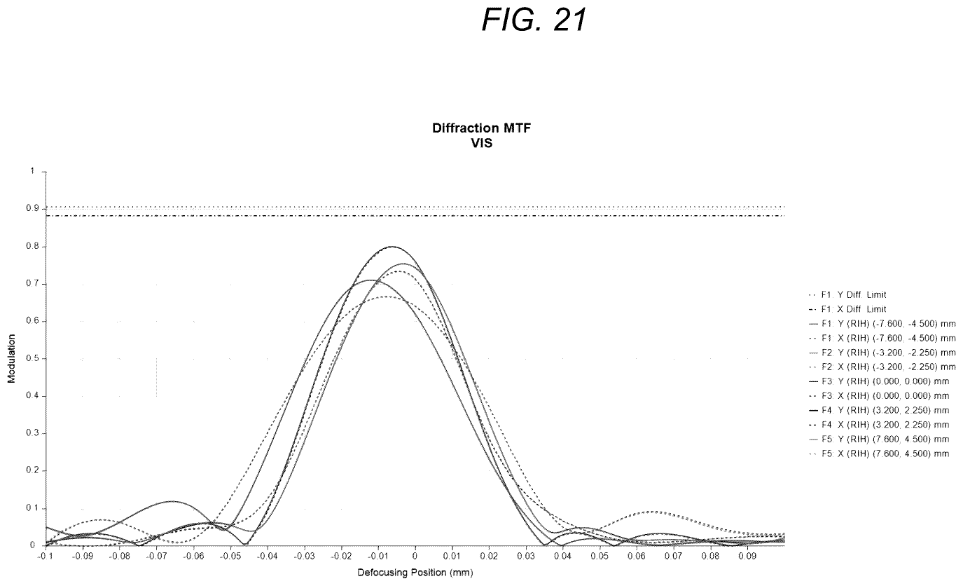

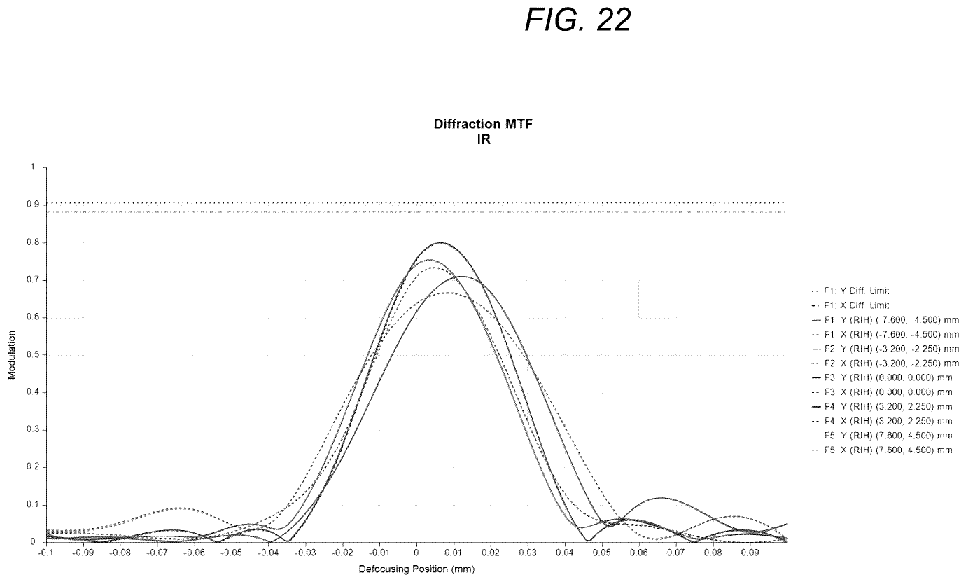

FIG. 21 shows the reduction-side MTF of the first projection optical system 41. FIG. 22 shows the reduction-side MTF of the second projection optical system 42. The first projection optical system 41 provides high resolution, as shown in FIG. 21. The second projection optical system 42 provides high resolution, as shown in FIG. 22.

### Effects and Advantages

In the projector 1B, the optical distance between the second position S2 and the light combiner 9 is equal to the optical distance between the positions where the projection images 18 are formed and the light combiner 9. More specifically, the optical distance between the second position S2 and the light incident surface of the light combiner 9 on which the invisible light is incident is equal to the optical distance between the positions where the projection images 18 are formed and the light incident surface of the light combiner 9 on which the visible light is incident. The light modulators 3 and the IR light modulator 81 are thus disposed at the same distance from the light combiner 9, so that the optical characteristics relating to the light modulators 3 and the IR light modulator 81 are unlikely to change even when the shape of the light combiner 9 changes due to a change in the temperature.

Since the dichroic prism 50, the light combiner 9, and the prism 529 constitute the integral prism block 14, the number of parts can be reduced. Furthermore, since the integral prism block 14 is provided, the optical characteristics relating to the light modulators 3 and the IR light modulator 81 are unlikely to change even when the shape of the prism block 14 changes due to a change in the temperature.

The first relay optical system 5B forms the invisible image 19 at the first position. That is, the first relay optical system 5B forms the intermediate image 16 of the invisible image 19 at the first position S1. The intermediate image 16 of the invisible image 19 and the intermediate image 15 of the projection images 18 can thus be formed by the single first relay optical system 5B, so that the entire optical system can be made compact.

The projector system PS3 according to the third embodiment has the same configuration as the projector system PS1 according to the first embodiment. The projector system PS3 according to the third embodiment therefore provides the same effects and advantages as the projector system PS1 according to the first embodiment.

### Fourth Embodiment

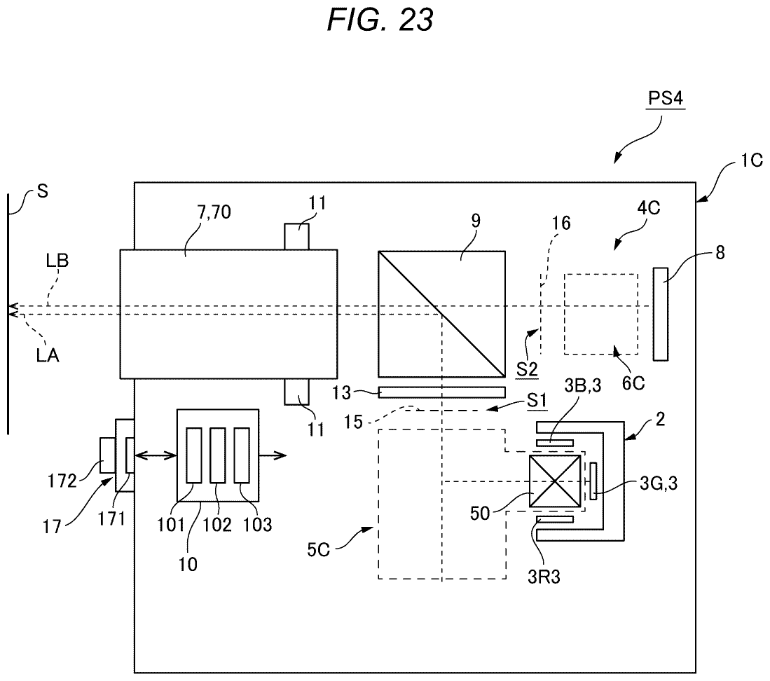

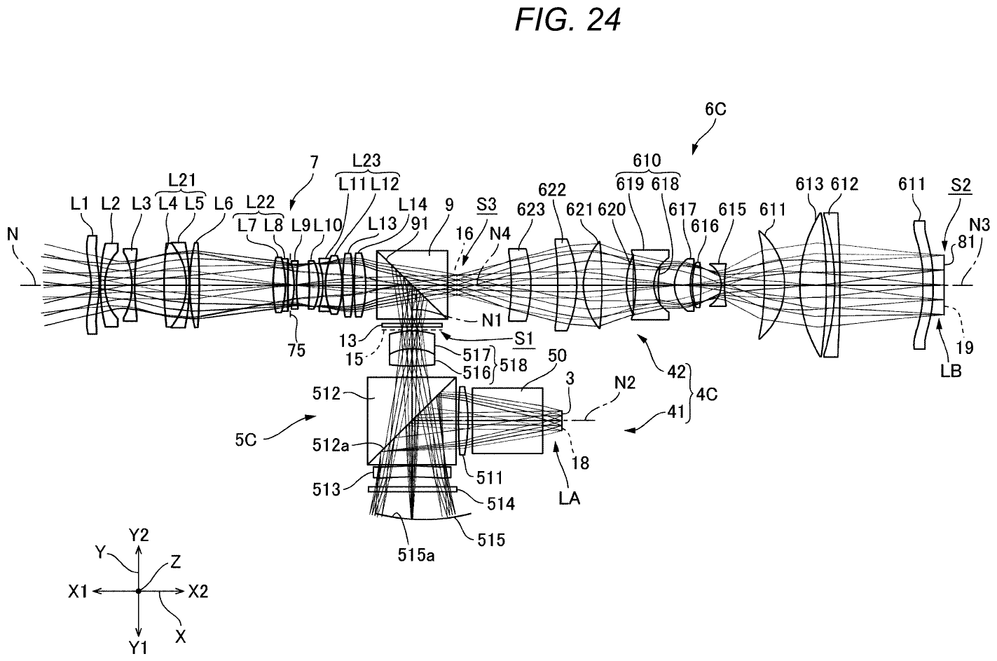

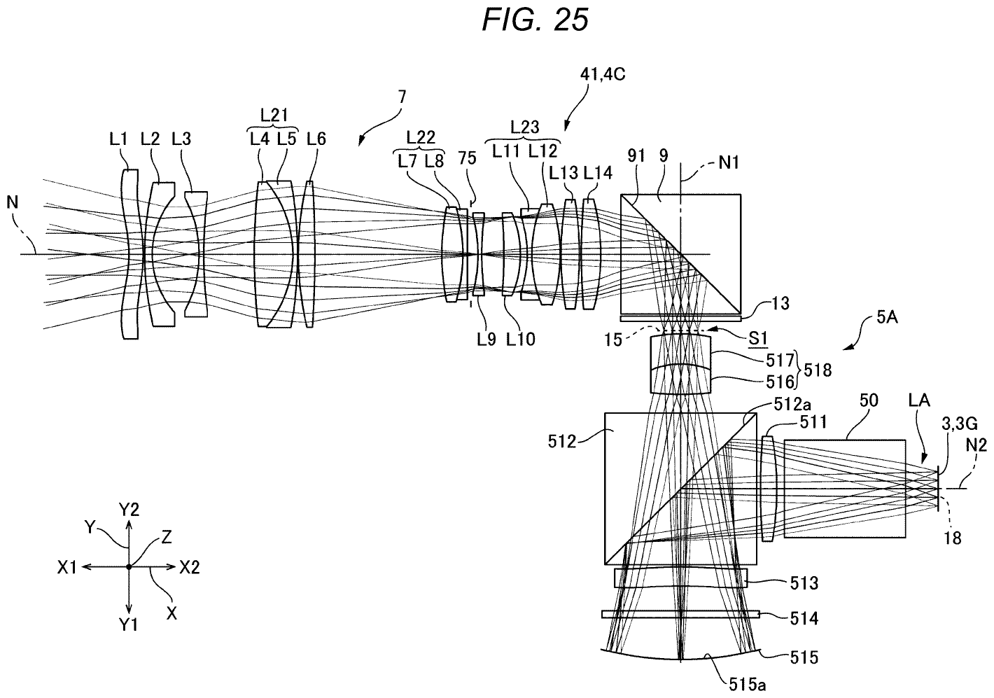

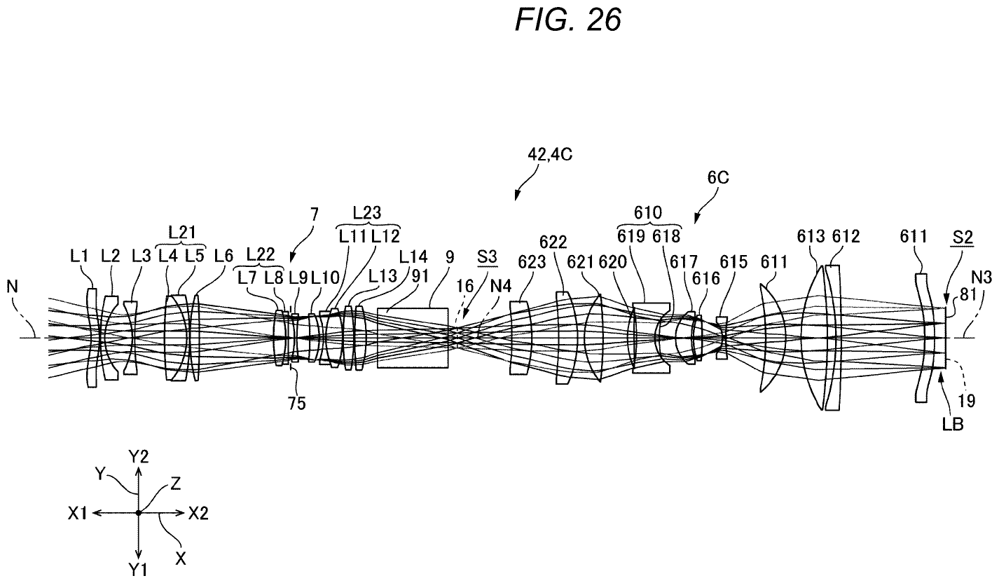

FIG. 23 is a schematic view of key parts of a projector system PS4 according a fourth embodiment. FIG. 24 shows a schematic configuration of an optical system 4C in the fourth embodiment. FIG. 25 is a schematic configuration diagram of the first projection optical system 41, which projects visible light, out of the optical system 4C in the fourth embodiment. FIG. 26 is a schematic configuration diagram of the second projection optical system 42, which projects invisible light, out of the optical system 4C in the fourth embodiment. The optical system 4C of the projector system PS4 according to the fourth embodiment shown in FIG. 23 differs from the optical system 4A of the projector system PS2 according to the second embodiment. Therefore, in the fourth embodiment, the same configurations as those in the second embodiment have the same reference characters, and will not be described in some cases.

The optical system 4C includes a first relay optical system 5C, the enlarging optical system 7, the light combiner 9, the retardation film 13, and a second relay optical system 6C, as shown in FIG. 23. The first relay optical system 5C includes the dichroic prism 50.

The optical system 4C includes the first projection optical system 41 shown in FIG. 25, which projects the visible light LA, and the second projection optical system 42 shown in FIG. 26, which projects the invisible light LB, as shown in FIG. 24.

The enlarging optical system 7 includes 14 lenses L1 to L14, as shown in FIG. 24 to 26. The lenses L1 to L14 are arranged in this order from the enlargement side toward the reduction side. The diaphragm 75 is disposed between the lens L8 and the lens L9. The lenses L4 and L5 are cemented to each other into the cemented lens L21. The lenses L7 and L8 are cemented to each other into the cemented lens L22. The lenses L11 and L12 are cemented to each other into the cemented lens L23. The lens L1 has aspherical surfaces on opposite sides. The lens L10 has aspherical surfaces on opposite sides.

The first relay optical system 5C forms the projection images 18 at the first position S1, as shown in FIGS. 24 and 25. In the present embodiment, the first relay optical system 5C forms the intermediate image 15, which is as large as the projection images 18 formed at the light modulators 3, at the first position S1. The first position S1 is located between the retardation film 13 and the first relay optical system 5C. The first relay optical system 5C has the same configuration as the first relay optical system 5A in the second embodiment, therefore has the same reference characters, and will not be described.

The retardation film 13 is disposed on the enlargement side of the first relay optical system 5C, as shown in FIGS. 24 and 25. The retardation film 13 is a λ/2 plate.

The second relay optical system 6C forms the invisible image 19 at a third position S3, as shown in FIGS. 24 and 26. In the present embodiment, the second relay optical system 6C forms the intermediate image 16, which differs in magnification from the invisible image 19 formed at the IR light modulator 81, at the third position S3. The invisible image 19 formed at the IR light modulator 81 is larger than the intermediate image 16 formed at the third position S3. The third position S3 is located between the light combiner 9 and the second relay optical system 6C. Furthermore, in the present embodiment, the invisible image 19 formed by the IR light modulator 81 is larger than the projection images 18 formed by the light modulators 3.

The second relay optical system 6C includes a first lens 611, a second lens 612, a third lens 613, a fourth lens 614, a fifth lens 615, a sixth lens 616, a seventh lens 617, an eighth lens 618, a ninth lens 619, a tenth lens 620, an eleventh lens 621, a twelfth lens 622, and a thirteenth lens 623 sequentially arranged in the direction in which the invisible light travels from the IR light modulator 81 toward the third position S3. The first lens 611 to the thirteenth lens 623 are arranged along the X-axis. The first lens 611 has aspherical surfaces on opposite sides. The eighth lens 618 and the ninth lens 619 are cemented to each other into a cemented lens 610.

The light combiner 9 combines the visible light LA and the invisible light LB with each other into the combined light, as shown in FIG. 24 to 26. The enlarging optical system 7 is disposed at a position shifted in the X1 direction from the light combiner 9, the thirteenth lens 623 of the second relay optical system 6C is disposed at a position shifted in the X2 direction from the light combiner 9, and the fourth lens 517 of the first relay optical system 5C is disposed at a position shifted in the Y1 direction from the light combiner 9. The light combiner 9 includes a wavelength separating film 91. The wavelength separating film 91 transmits one of infrared light and visible light and reflects the other. In the present embodiment, the wavelength separating film 91 transmits infrared light, which is the visible light LA, and reflects the invisible light LB. The visible light LA output from the first relay optical system 5C is therefore reflected off the wavelength separating film 91 and enters the enlarging optical system 7, as shown in FIG. 25. The intermediate image 15 is displayed as the combined projection image on the screen S by the enlarging optical system 7. The invisible light LB output from the second relay optical system 6C passes through the wavelength separating film 91 and enters the enlarging optical system 7, as shown in FIG. 26. The invisible image 19 is displayed on the screen S by the enlarging optical system 7. The invisible image 19 is formed at the second position S2 conjugate with the positions where the projection images 18 are formed.

The enlarging optical system 7 forms an image at the first position S1, as shown in FIG. 24 to 26. That is, the reduction-side image formation plane of the enlarging optical system 7 is located at the first position S1. The reduction side of the enlarging optical system 7 is a telecentric system. Since the reduction side of the enlarging optical system 7 is a telecentric system, the principal ray of each beam passing through the reduction-side image formation plane is parallel or substantially parallel to the optical axis N of the reduction-side image formation plane. The enlarging optical system 7 forms an image also at the third position S3. That is, the reduction-side image formation plane of the enlarging optical system 7 is located also at the third position S3.

The opposite sides of the first relay optical system 5C are telecentric systems, as shown in FIG. 25. The principal ray of each beam passing through the image formation plane at the first position S1 is therefore parallel or substantially parallel to the optical axis N1 of the image formation plane at the first position S1. The principal ray of each beam passing through the image formation surfaces of the light modulators 3 is parallel or substantially parallel to the optical axis N2 of the image formation surfaces of the light modulators 3.

The opposite sides of the second relay optical system 6C are telecentric systems, as shown in FIG. 26. The principal ray of each beam passing through the image formation plane at the third position S3 is therefore parallel or substantially parallel to an optical axis N4 of the image formation plane at the third position S3. The principal ray of each beam passing through the image formation surface of the IR light modulator 81 is parallel or substantially parallel to the optical axis N3 of the image formation surface of the IR light modulator 81.

### Lens Data

Data on the lenses of the first projection optical system 41 shown in FIG. 25 are shown below. Surface numbers are sequentially assigned from the enlargement side toward the reduction side. Reference characters are those of the screen, the lenses, the light combiner, the lenses, the polarization combining/separating prism, the dichroic prism, and the light modulators. A surface having a surface number labeled with*is an aspherical surface. R represents the radius of curvature. D represents the axial inter-surface distance. Nd represents the refractive index at the d line. νd represents the Abbe number at the d line. Y represents the effective radius. R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.000 |
| | *2 | −35.90900 | 0.400000 | | | Refraction | 19.556 |
| L2 | 3 | 81.70000 | 2.000000 | 1.49700 | 81.54 | Refraction | 17.735 |
| | 4 | 22.98300 | 12.400000 | | | Refraction | 15.392 |
| L3 | 5 | −31.21800 | 1.200000 | 1.49700 | 81.54 | Refraction | 14.911 |
| | 6 | 118.38200 | 13.384000 | | | Refraction | 15.325 |
| L4 | 7 | 176.01300 | 10.150000 | 1.83400 | 37.16 | Refraction | 17.641 |
| L5 | 8 | −29.89400 | 1.300000 | 1.84666 | 23.78 | Refraction | 17.802 |
| | 9 | −103.47100 | 0.200000 | | | Refraction | 18.099 |
| L6 | 10 | 83.27600 | 4.320000 | 1.84666 | 23.78 | Refraction | 18.000 |
| | 11 | −298.53100 | 33.534000 | | | Refraction | 17.796 |
| L7 | 12 | 63.55500 | 5.580000 | 1.77250 | 49.60 | Refraction | 11.502 |
| L8 | 13 | −43.02500 | 1.100000 | 1.72825 | 28.46 | Refraction | 10.945 |
| | 14 | 1804.82100 | 2.873000 | | | Refraction | 10.461 |
| L9, 75 | 15 | −38.34400 | 1.000000 | 1.76182 | 26.52 | Refraction | 10.000 |
| | 16 | 75.19100 | 5.832000 | | | Refraction | 9.776 |
| L10 | *17 | −217.03500 | 4.360000 | 1.74320 | 49.29 | Refraction | 9.777 |
| | *18 | −29.41800 | 1.830000 | | | Refraction | 10.000 |
| L11 | 19 | −32.01900 | 1.200000 | 1.69895 | 30.13 | Refraction | 10.108 |
| L12 | 20 | 34.78000 | 7.550000 | 1.49700 | 81.54 | Refraction | 11.067 |
| | 21 | −41.76900 | 0.200000 | | | Refraction | 12.227 |
| L13 | 22 | 87.93800 | 4.850000 | 1.80809 | 22.76 | Refraction | 13.114 |
| | 23 | −86.87400 | 0.500000 | | | Refraction | 13.356 |
| L14 | 24 | 170.53700 | 5.170000 | 1.59522 | 67.74 | Refraction | 13.417 |
| | 25 | −55.33000 | 5.119637 | | | Refraction | 13.385 |
| 9 | 26 | 0.00000 | 16.000000 | 1.51680 | 64.17 | Refraction | 12.318 |
| 91 | 27 | 0.00000 | −16.000000 | 1.51680 | 64.17 | Reflection | 14.448 |
| | 28 | 0.00000 | −5.000000 | | | Refraction | 9.331 |
| 517 | 29 | −37.80107 | −8.000000 | 1.80420 | 46.50 | Refraction | 9.179 |
| 516 | 30 | −20.90626 | −8.000000 | 1.67011 | 23.90 | Refraction | 9.087 |
| | 31 | 84.38721 | −5.000000 | | | Refraction | 9.289 |
| 512 | 32 | 0.00000 | −20.000000 | 1.51680 | 64.17 | Refraction | 9.326 |
| 512a | 33 | 0.00000 | −20.000000 | 1.51680 | 64.17 | Refraction | 11.161 |
| | 34 | 0.00000 | −0.644094 | | | Refraction | 14.565 |
| 513 | *35 | −98.23961 | −5.000000 | 1.50940 | 56.47 | Refraction | 14.871 |
| | *36 | −110.57456 | −19.438469 | | | Refraction | 15.756 |
| 515a | *37 | 82.97883 | 19.438469 | | | Reflection | 20.083 |
| 513 | *38 | −110.57456 | 5.000000 | 1.50940 | 56.47 | Refraction | 16.356 |
| | *39 | −98.23961 | 0.644094 | | | Refraction | 15.562 |
| 512 | 40 | 0.00000 | 20.000000 | 1.51680 | 64.17 | Refraction | 15.306 |
| 512a | 41 | 0.00000 | −20.000000 | 1.51680 | 64.17 | Reflection | 20.000 |
| | 42 | 0.00000 | −1.000000 | | | Refraction | 14.381 |
| 511 | 43 | −181.66230 | −4.338165 | 1.77223 | 47.70 | Refraction | 14.419 |
| | 44 | 80.74054 | −2.000000 | | | Refraction | 14.368 |
| 50 | 45 | 0.00000 | −32.000000 | 1.51680 | 64.20 | Refraction | 13.768 |
| | 46 | 0.00000 | −8.705166 | | | Refraction | 10.171 |
| 3 | 47 | 0.00000 | 0.000000 | | | Refraction | 8.838 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3.314652E−08 | −5.17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | −4.717475E−17 | −3.480507E−15 | 1.826607E−14 |
| 14th-order coefficient | 1.074993E−20 | −2.316431E−20 | −8.166188E−17 | −1.164168E−16 |

| Surface number | 35 | 36 | 37 |
|---|---|---|---|
| Conic constant | 0 | 0 | −1.00E+00 |
| 4th-order coefficient | 1.201655E−05 | 1.051619E−05 | 8.382102E−08 |
| 6th-order coefficient | 2.746810E−09 | 2.638418E−09 | −6.123083E−11 |
| 8th-order coefficient | 1.094746E−11 | 4.371560E−12 | −5.053909E−13 |
| 10th-order coefficient | −3.531471E−14 | −2.640316E−14 | 1.061247E−15 |

| Surface number | 38 | 39 |
|---|---|---|
| Conic constant | 0 | 0 |
| 4th-order coefficient | 1.051619E−05 | 1.201655E−05 |
| 6th-order coefficient | 2.638418E−09 | 2.746810E−09 |
| 8th-order coefficient | 4.371560E−12 | 1.094746E−11 |
| 10th-order coefficient | −2.640316E−14 | −3.531471E−14 |

Data on the lenses of the second projection optical system 42 shown in FIG. 26 are shown below. Surface numbers are sequentially assigned from the enlargement side toward the reduction side. Reference characters are those of the screen, the lenses, the light combiner, and the imaging device. A surface having a surface number labeled with*is an aspherical surface. R represents the radius of curvature. D represents the axial inter-surface distance. Nd represents the refractive index at the d line. νd represents the Abbe number at the d line. Y represents the effective radius. R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.000 |
| | *2 | −35.90900 | 0.400000 | | | Refraction | 19.556 |
| L2 | 3 | 81.70000 | 2.000000 | 1.49700 | 81.54 | Refraction | 17.735 |
| | 4 | 22.98300 | 12.400000 | | | Refraction | 15.392 |
| L3 | 5 | −31.21800 | 1.200000 | 1.49700 | 81.54 | Refraction | 14.911 |
| | 6 | 118.38200 | 13.384000 | | | Refraction | 15.325 |
| L4 | 7 | 176.01300 | 10.150000 | 1.83400 | 37.16 | Refraction | 17.641 |
| L5 | 8 | −29.89400 | 1.300000 | 1.84666 | 23.78 | Refraction | 17.802 |
| | 9 | −103.47100 | 0.200000 | | | Refraction | 18.099 |
| L6 | 10 | 83.27600 | 4.320000 | 1.84666 | 23.78 | Refraction | 18.000 |
| | 11 | −298.53100 | 33.534000 | | | Refraction | 17.796 |
| L7 | 12 | 63.55500 | 5.580000 | 1.77250 | 49.60 | Refraction | 11.502 |
| L8 | 13 | −43.02500 | 1.100000 | 1.72825 | 28.46 | Refraction | 10.945 |
| | 14 | 1804.82100 | 2.873000 | | | Refraction | 10.461 |
| L9, 75 | 15 | −38.34400 | 1.000000 | 1.76182 | 26.52 | Refraction | 10.000 |
| | 16 | 75.19100 | 5.832000 | | | Refraction | 9.776 |
| L10 | *17 | −217.03500 | 4.360000 | 1.74320 | 49.29 | Refraction | 9.777 |
| | *18 | −29.41800 | 1.830000 | | | Refraction | 10.000 |
| L11 | 19 | −32.01900 | 1.200000 | 1.69895 | 30.13 | Refraction | 10.108 |
| L12 | 20 | 34.78000 | 7.550000 | 1.49700 | 81.54 | Refraction | 11.067 |
| | 21 | −41.76900 | 0.200000 | | | Refraction | 12.227 |
| L13 | 22 | 87.93800 | 4.850000 | 1.80809 | 22.76 | Refraction | 13.114 |
| | 23 | −86.87400 | 0.500000 | | | Refraction | 13.356 |
| L14 | 24 | 170.53700 | 5.170000 | 1.59522 | 67.74 | Refraction | 13.417 |
| | 25 | −55.33000 | 5.119637 | | | Refraction | 13.385 |
| 9 | 26 | 0.00000 | 32.000000 | 1.51680 | 64.17 | Refraction | 12.334 |
| | 27 | 0.00000 | 4.200000 | | | Refraction | 9.394 |
| S3 | 28 | 0.00000 | 24.728531 | | | Refraction | 8.889 |
| 623 | 29 | −103.96942 | 8.940786 | 1.71172 | 32.86 | Refraction | 13.807 |
| | 30 | −62.28214 | 12.164688 | | | Refraction | 15.319 |
| 622 | 31 | −162.94499 | 8.608101 | 1.74013 | 28.22 | Refraction | 18.397 |
| | 32 | −51.18173 | 3.073614 | | | Refraction | 19.604 |
| 621 | 33 | 31.25536 | 8.383879 | 1.48749 | 70.41 | Refraction | 20.556 |
| | 34 | −194.94284 | 11.152372 | | | Refraction | 20.653 |
| 620 | 35 | 32.51312 | 3.035723 | 1.61315 | 60.70 | Refraction | 14.147 |
| | 36 | 1333.79102 | 1.138066 | | | Refraction | 14.203 |
| 619 | 37 | −63.99707 | 8.209475 | 1.75422 | 27.62 | Refraction | 14.768 |
| 618 | 38 | 14.72268 | 2.033535 | 1.48749 | 70.41 | Refraction | 11.080 |
| | 39 | 44.08088 | 7.398826 | | | Refraction | 11.244 |
| 617 | 40 | 15.19600 | 7.223832 | 1.48986 | 70.14 | Refraction | 10.934 |
| | 41 | 29.65639 | 0.865238 | | | Refraction | 9.578 |
| 616 | 42 | 31.43230 | 3.967441 | 1.50097 | 68.96 | Refraction | 9.357 |
| | 43 | −118.16549 | 9.205400 | | | Refraction | 8.658 |
| 615 | 44 | −10.96755 | 1.500000 | 1.72987 | 39.50 | Refraction | 7.117 |
| | 45 | 67.47827 | 18.089502 | | | Refraction | 8.696 |
| 614 | 46 | −113.80157 | 9.142618 | 1.68015 | 31.42 | Refraction | 22.999 |
| | 47 | −32.32117 | 6.916629 | | | Refraction | 23.673 |
| 613 | 48 | 62.75875 | 11.944663 | 1.73781 | 43.38 | Refraction | 31.660 |
| | 49 | −236.17994 | 3.883612 | | | Refraction | 31.545 |
| 612 | 50 | −105.32879 | 2.421010 | 1.60480 | 38.07 | Refraction | 31.198 |
| | 51 | −539.16276 | 37.679707 | | | Refraction | 30.950 |
| 611 | *52 | −92.60728 | 4.500000 | 1.56547 | 60.08 | Refraction | 27.566 |
| | *53 | −127.93422 | 5.109489 | | | Refraction | 27.209 |
| 81, S2 | 54 | 0.00000 | 0.000000 | | | Refraction | 26.500 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3.314652E−08 | −5.17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | −4.717475E−17 | −3.480507E−15 | 1.826607E−14 |
| 14th-order coefficient | 1.074993E−20 | −2.316431E−20 | −8.166188E−17 | −1.164168E−16 |

| Surface number | 52 | 53 |
|---|---|---|
| 4th-order coefficient | −4.214313E−06 | −8.874419E−06 |
| 6th-order coefficient | −6.318791E−09 | 2.270662E−09 |
| 8th-order coefficient | 2.669951E−11 | 1.972489E−11 |
| 10th-order coefficient | −1.401679E−14 | −1.175329E−14 |

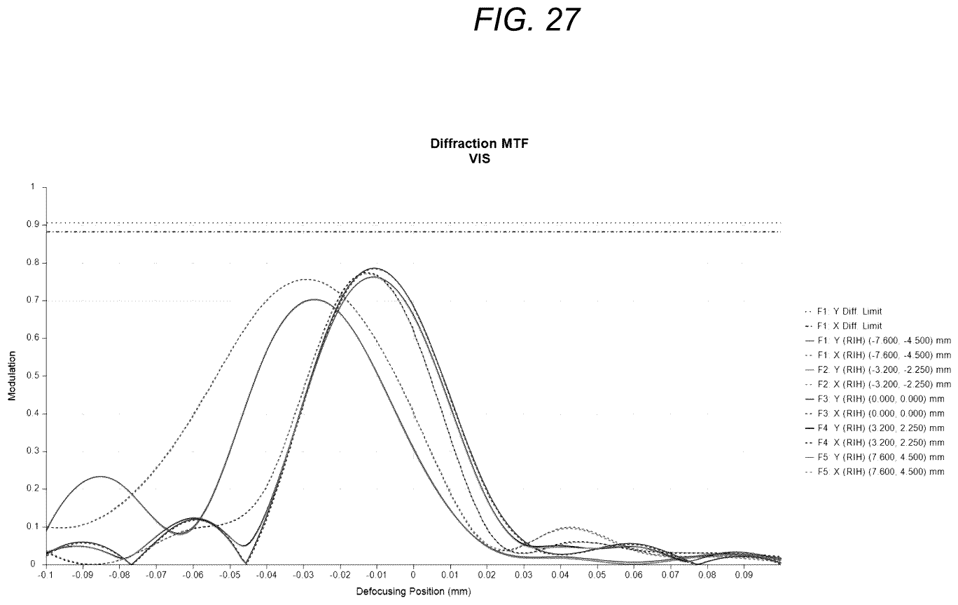

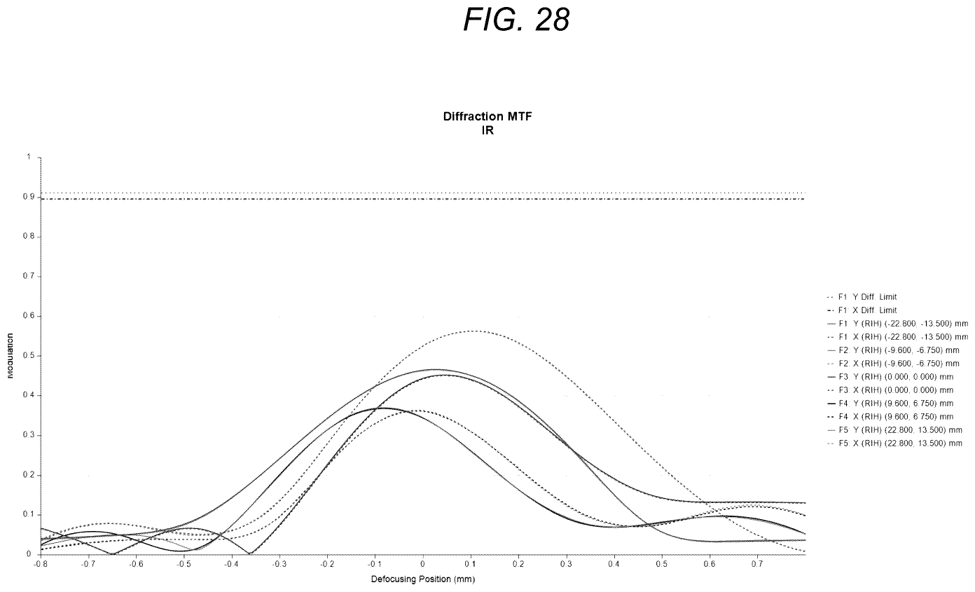

FIG. 27 shows the reduction-side MTF of the first projection optical system 41. FIG. 28 shows the reduction-side MTF of the second projection optical system 42. The first projection optical system 41 provides high resolution, as shown in FIG. 27. The second projection optical system 42 provides high resolution, as shown in FIG. 28.

### Effects and Advantages

The second relay optical system 6C forms the intermediate image 16, which differs in magnification from the invisible image 19 formed at the IR light modulator 81, at the third position S3. The invisible image 19 formed at the IR light modulator 81 is larger than the intermediate image 16 formed at the third position S3. The resolution of the invisible image 19 formed at the IR light modulator 81 can thus be increased, so that a high-definition invisible image is displayed on the screen S. As a result, the imager 17 can accurately capture an image of the invisible image displayed on the screen S.

The projector system PS4 according to the fourth embodiment has the same configuration as the projector system PS2 according to the second embodiment. The projector system PS4 according to the fourth embodiment therefore provides the same effects and advantages as the projector system PS2 according to the second embodiment.

### Fifth Embodiment

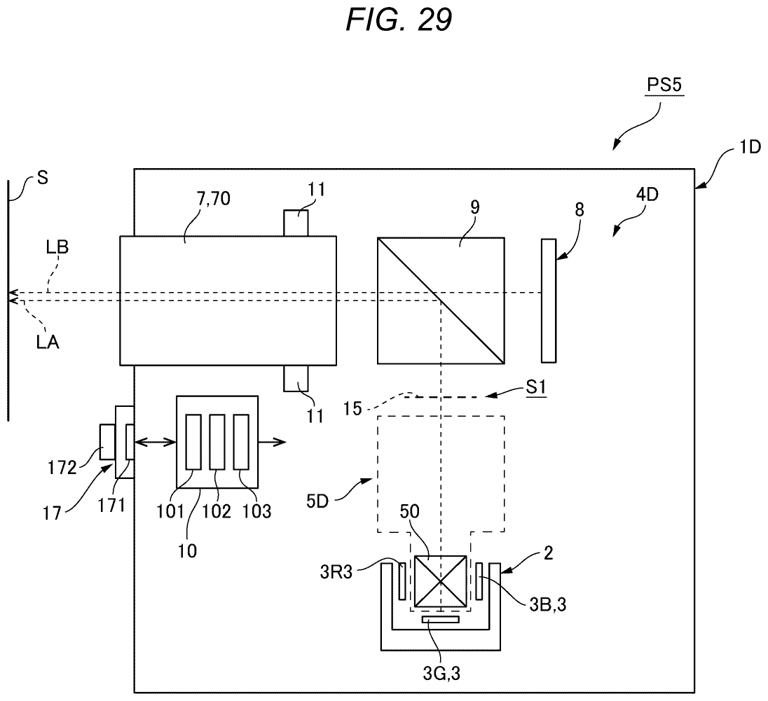

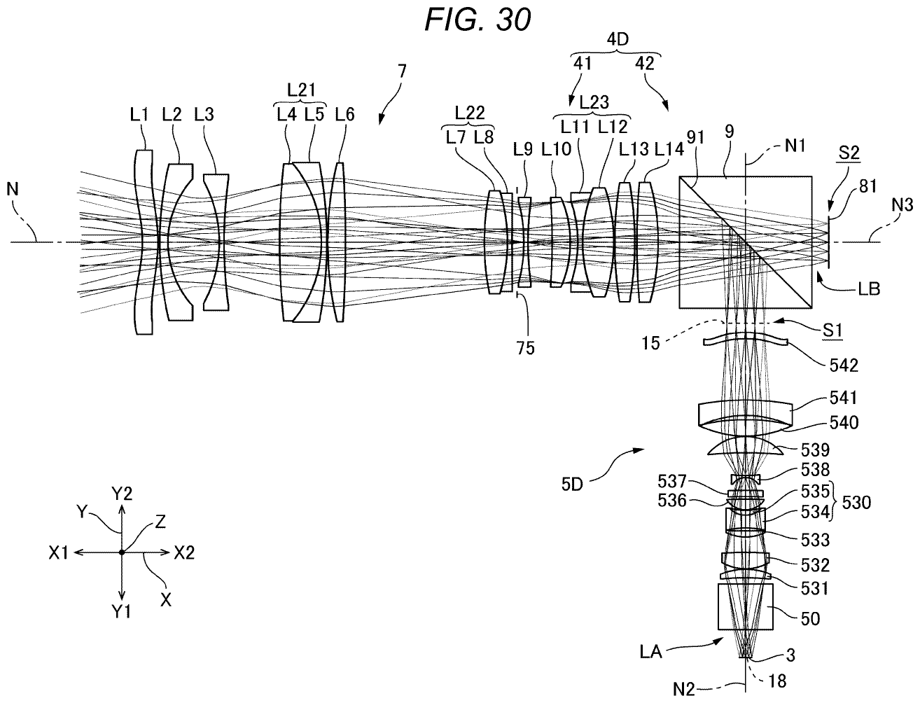

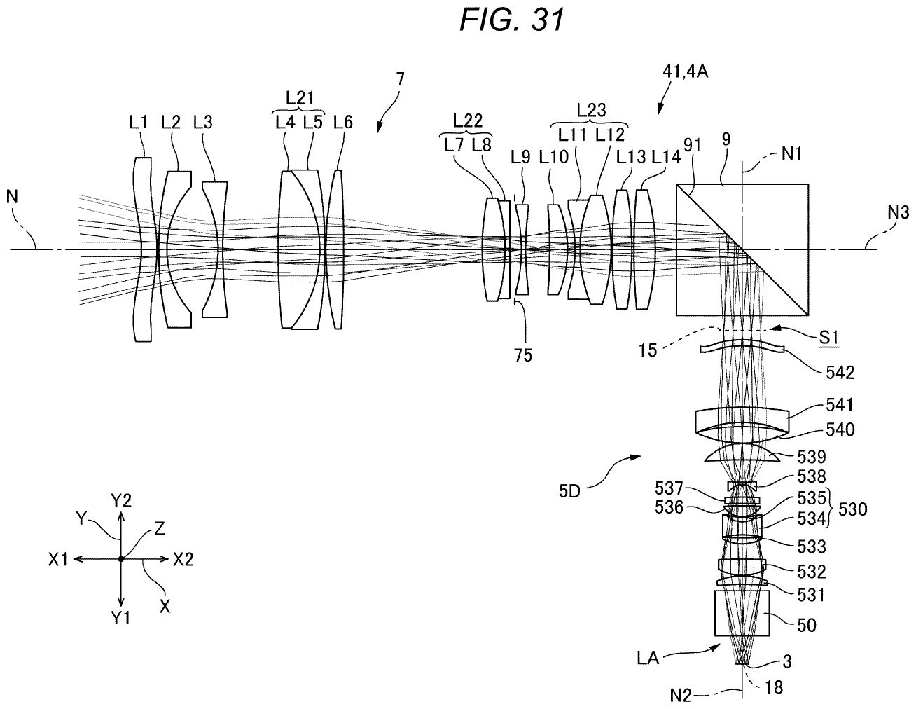

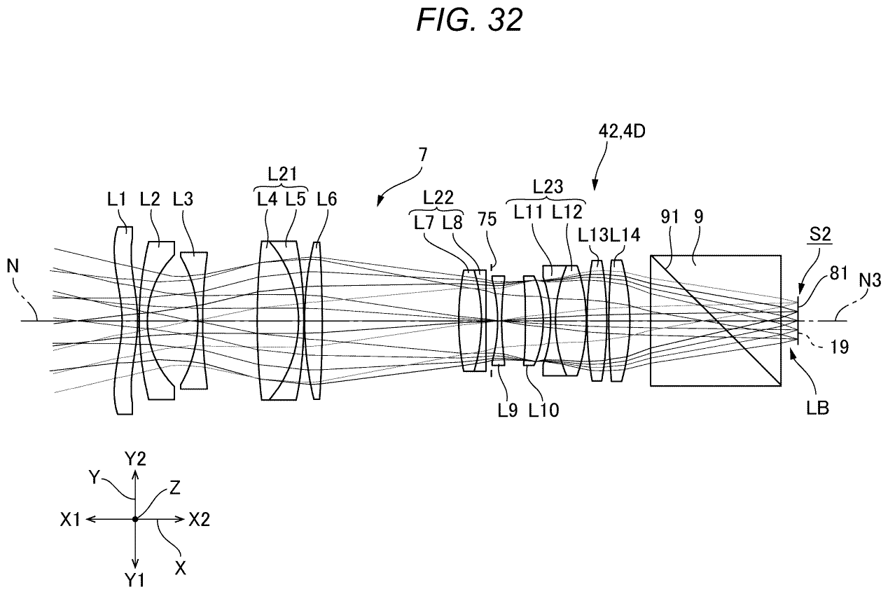

FIG. 29 is a schematic view of key parts of a projector system PS5 according a fifth embodiment. FIG. 30 shows a schematic configuration of an optical system 4D in the fifth embodiment. FIG. 31 is a schematic configuration diagram of the first projection optical system 41, which projects visible light, out of the optical system 4D in the fifth embodiment. FIG. 32 is a schematic configuration diagram of the second projection optical system 42, which projects invisible light, out of the optical system 4D in the fifth embodiment. In the fifth embodiment, the optical system 4D of the projector system PS5 according to the fifth embodiment shown in FIG. 29 differs from the optical system 4 of the projector system PS1 according to the first embodiment. Therefore, in the fifth embodiment, the same configurations as those in the first embodiment have the same reference characters, and will not be described in some cases.

The optical system 4D includes a first relay optical system 5D, the enlarging optical system 7, and the light combiner 9, as shown in FIG. 29. The first relay optical system 5D includes the dichroic prism 50.

The optical system 4D includes the first projection optical system 41 shown in FIG. 31, which projects the visible light LA, and the second projection optical system 42 shown in FIG. 32, which projects the invisible light LB, as shown in FIG. 30.

The enlarging optical system 7 includes 14 lenses L1 to L14, as shown in FIG. 30 to 32. The lenses L1 to L14 are arranged in this order from the enlargement side toward the reduction side. The diaphragm 75 is disposed between the lens L8 and the lens L9. The lenses L4 and L5 are cemented to each other into the cemented lens L21. The lenses L7 and L8 are cemented to each other into the cemented lens L22. The lenses L11 and L12 are cemented to each other into the cemented lens L23. The lens L1 has aspherical surfaces on opposite sides. The lens L10 has aspherical surfaces on opposite sides.

The first relay optical system 5D forms the projection images 18 at the first position S1, as shown in FIGS. 30 and 31. In the present embodiment, the first relay optical system 5D forms the intermediate image 15, which differs in magnification from the projection images 18 formed at the light modulators 3, at the first position S1. The projection images 18 formed at the light modulators 3 are smaller than the intermediate image 15 formed at the first position S1. The first position S1 is located between the light combiner 9 and the first relay optical system 5D. Furthermore, in the present embodiment, the invisible image 19 formed by the IR light modulator 81 is larger than the projection images 18 formed by the light modulators 3.

The first relay optical system 5D includes the dichroic prism 50, a first lens 531, a second lens 532, a third lens 533, a fourth lens 534, a fifth lens 535, a sixth lens 536, a seventh lens 537, an eighth lens 538, a ninth lens 539, a tenth lens 540, an eleventh lens 541, and a twelfth lens 542 sequentially arranged in the direction in which the visible light travels from the light modulators 3 toward the first position S1. The first lens 531 to the twelfth lens 542 are arranged along the Y-axis. The fourth lens 534 and the fifth lens 535 are cemented to each other into the cemented lens 530. The twelfth lens 542 has aspherical surfaces on opposite sides.

The light combiner 9 combines the visible light LA and the invisible light LB with each other into the combined light, as shown in FIG. 30 to 32. The enlarging optical system 7 is disposed at a position shifted in the X1 direction from the light combiner 9, the IR light modulator 81 is disposed at a position shifted in the X2 direction from the light combiner 9, and the twelfth lens 542 of the first relay optical system 5D is disposed at a position shifted in the Y1 direction from the light combiner 9. The light combiner 9 includes a wavelength separating film 91. The wavelength separating film 91 transmits one of infrared light and visible light and reflects the other. In the present embodiment, the wavelength separating film 91 transmits infrared light, which is the visible light LA, and reflects the invisible light LB. The visible light LA output from the first relay optical system 5D is therefore reflected off the wavelength separating film 91 and enters the enlarging optical system 7, as shown in FIG. 31. The intermediate image 15 is displayed as the combined projection image on the screen S by the enlarging optical system 7. The invisible light LB output from the second relay optical system 6C passes through the wavelength separating film 91 and enters the enlarging optical system 7, as shown in FIG. 32. The invisible image 19 is displayed on the screen S by the enlarging optical system 7. The invisible image 19 is formed at the second position S2 conjugate with the positions where the projection images 18 are formed.

The enlarging optical system 7 forms an image at the first position S1, as shown in FIG. 30 to 32. That is, the reduction-side image formation plane of the enlarging optical system 7 is located at the first position S1. The reduction side of the enlarging optical system 7 is a telecentric system. Since the reduction side of the enlarging optical system 7 is a telecentric system, the principal ray of each beam passing through the reduction-side image formation plane is parallel or substantially parallel to the optical axis N of the reduction-side image formation plane. The enlarging optical system 7 forms an image also at the second position S2. That is, the reduction-side image formation plane of the enlarging optical system 7 is also located at the position where the IR light modulator 81 is disposed.

The opposite sides of the first relay optical system 5D are telecentric systems, as shown in FIG. 31. The principal ray of each beam passing through the image formation plane at the first position S1 is therefore parallel or substantially parallel to the optical axis N1 of the image formation plane at the first position S1. The principal ray of each beam passing through the image formation surfaces of the light modulators 3 is parallel or substantially parallel to the optical axis N2 of the image formation surfaces of the light modulators 3.

Since the reduction side of the enlarging optical system 7 is a telecentric system, the principal ray of each beam passing through the image formation surface of the IR light modulator 81 is parallel or substantially parallel to the optical axis N3 of the image formation surface of the IR light modulator 81, as shown in FIG. 32.

### Lens Data

Data on the lenses of the first projection optical system 41 shown in FIG. 31 are shown below. Surface numbers are sequentially assigned from the enlargement side toward the reduction side. Reference characters are those of the screen, the lenses, the light combiner, the lenses, the polarization combining/separating prism, the dichroic prism, and the light modulators. A surface having a surface number labeled with*is an aspherical surface. R represents the radius of curvature. D represents the axial inter-surface distance. Nd represents the refractive index at the d line. νd represents the Abbe number at the d line. Y represents the effective radius, R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.000 |
| | *2 | −35.90900 | 0.400000 | | | Refraction | 19.556 |
| L2 | 3 | 81.70000 | 2.000000 | 1.49700 | 81.54 | Refraction | 17.735 |
| | 4 | 22.98300 | 12.400000 | | | Refraction | 15.392 |
| L3 | 5 | −31.21800 | 1.200000 | 1.49700 | 81.54 | Refraction | 14.911 |
| | 6 | 118.38200 | 13.384000 | | | Refraction | 15.325 |
| L4 | 7 | 176.01300 | 10.150000 | 1.83400 | 37.16 | Refraction | 17.641 |
| L5 | 8 | −29.89400 | 1.300000 | 1.84666 | 23.78 | Refraction | 17.802 |
| | 9 | −103.47100 | 0.200000 | | | Refraction | 18.099 |
| L6 | 10 | 83.27600 | 4.320000 | 1.84666 | 23.78 | Refraction | 18.000 |
| | 11 | −298.53100 | 33.534000 | | | Refraction | 17.796 |
| L7 | 12 | 63.55500 | 5.580000 | 1.77250 | 49.60 | Refraction | 11.502 |
| L8 | 13 | −43.02500 | 1.100000 | 1.72825 | 28.46 | Refraction | 10.945 |
| | 14 | 1804.82100 | 2.873000 | | | Refraction | 10.461 |
| L9, 75 | 15 | −38.34400 | 1.000000 | 1.76182 | 26.52 | Refraction | 10.000 |
| | 16 | 75.19100 | 5.832000 | | | Refraction | 9.776 |
| L10 | *17 | −217.03500 | 4.360000 | 1.74320 | 49.29 | Refraction | 9.777 |
| | *18 | −29.41800 | 1.830000 | | | Refraction | 10.000 |
| L11 | 19 | −32.01900 | 1.200000 | 1.69895 | 30.13 | Refraction | 10.108 |
| L12 | 20 | 34.78000 | 7.550000 | 1.49700 | 81.54 | Refraction | 11.067 |
| | 21 | −41.76900 | 0.200000 | | | Refraction | 12.227 |
| L13 | 22 | 87.93800 | 4.850000 | 1.80809 | 22.76 | Refraction | 13.114 |
| | 23 | −86.87400 | 0.500000 | | | Refraction | 13.356 |
| L14 | 24 | 170.53700 | 5.170000 | 1.59522 | 67.74 | Refraction | 13.417 |
| | 25 | −55.33000 | 5.119637 | | | Refraction | 13.385 |
| 9 | 26 | 0.00000 | 16.000000 | 1.51680 | 64.17 | Refraction | 12.000 |
| 91 | 27 | 0.00000 | −16.000000 | 1.51680 | 64.17 | Reflection | 12.000 |
| | 28 | 0.00000 | −4.200000 | | | Refraction | 9.228 |
| S1 | 29 | 0.00000 | −1.703163 | | | Refraction | 8.831 |
| 542 | *30 | −28.61054 | −1.500000 | 1.49087 | 70.03 | Refraction | 9.147 |
| | *31 | −26.99464 | −14.903614 | | | Refraction | 9.211 |
| 541 | 32 | −62.12449 | −3.700863 | 1.71934 | 29.19 | Refraction | 10.347 |
| | 33 | −24.93559 | −1.039205 | | | Refraction | 10.224 |
| 540 | 34 | −46.52677 | −3.978658 | 1.74821 | 36.21 | Refraction | 10.218 |
| | 35 | 26.18684 | −0.100000 | | | Refraction | 10.272 |
| 539 | 36 | −11.77625 | −3.968201 | 1.68800 | 50.10 | Refraction | 8.964 |
| | 37 | −98.02736 | −5.509012 | | | Refraction | 8.842 |
| 538 | 38 | 27.34872 | −0.500000 | 1.72479 | 46.43 | Refraction | 3.100 |
| | 39 | −3.82446 | −3.110708 | | | Refraction | 3.100 |
| 537 | 40 | −102.39141 | −1.505321 | 1.48927 | 70.21 | Refraction | 3.800 |
| | 41 | −123.36605 | −0.612197 | | | Refraction | 3.800 |
| 536 | 42 | −81.46112 | −2.615852 | 1.48749 | 70.41 | Refraction | 4.100 |
| | 43 | 5.39319 | −0.100000 | | | Refraction | 4.100 |
| 535 | 44 | 14.24143 | −1.168071 | 1.49857 | 69.21 | Refraction | 4.100 |
| 534 | 45 | 5.30020 | −3.140374 | 1.74710 | 31.24 | Refraction | 4.100 |
| | 46 | −21.84805 | −0.692031 | | | Refraction | 4.300 |
| 533 | 47 | 84.87787 | −1.484554 | 1.58424 | 62.35 | Refraction | 4.300 |
| | 48 | 10.41633 | −3.695230 | | | Refraction | 4.300 |
| 532 | 49 | −82.65950 | −4.007568 | 1.49213 | 69.89 | Refraction | 5.200 |
| | 50 | 11.50134 | −0.100000 | | | Refraction | 5.200 |
| 531 | 51 | −15.67125 | −2.080417 | 1.74397 | 44.85 | Refraction | 5.500 |
| | 52 | −60.14683 | −1.530644 | | | Refraction | 5.500 |
| 50 | 53 | 0.00000 | −11.000000 | 1.51680 | 64.17 | Refraction | 6.000 |
| | 54 | 0.00000 | −6.876275 | | | Refraction | 6.000 |
| 3 | 55 | 0.00000 | 0.000000 | | | Refraction | 2.975 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3.314652E−08 | −5.17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | −4.717475E−17 | −3.480507E−15 | 1.826607E−14 |
| 14th-order coefficient | 1.074993E−20 | −2.316431E−20 | −8.166188E−17 | −1.164168E−16 |

| Surface number | 30 | 31 |
|---|---|---|
| Conic constant | 0 | 0 |
| 4th-order coefficient | −2.396093E−04 | −1.137865E−04 |
| 6th-order coefficient | 5.517708E−07 | −1.535466E−06 |
| 8th-order coefficient | 4.313834E−08 | 5.839183E−08 |
| 10th-order coefficient | −2.3134E−10 | −2.758925E−10 |

Data on the lenses of the second projection optical system 42 shown in FIG. 32 are shown below. Surface numbers are sequentially assigned from the enlargement side toward the reduction side. Reference characters are those of the screen, the lenses, the light combiner, and the imaging device. A surface having a surface number labeled with*is an aspherical surface. R represents the radius of curvature. D represents the axial inter-surface distance. Nd represents the refractive index at the d line. νd represents the Abbe number at the d line. Y represents the effective radius. R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.000 |
| | *2 | −35.90900 | 0.400000 | | | Refraction | 19.556 |
| L2 | 3 | 81.70000 | 2.000000 | 1.49700 | 81.54 | Refraction | 17.735 |
| | 4 | 22.98300 | 12.400000 | | | Refraction | 15.392 |
| L3 | 5 | −31.21800 | 1.200000 | 1.49700 | 81.54 | Refraction | 14.911 |
| | 6 | 118.38200 | 13.384000 | | | Refraction | 15.325 |
| L4 | 7 | 176.01300 | 10.150000 | 1.83400 | 37.16 | Refraction | 17.641 |
| L5 | 8 | −29.89400 | 1.300000 | 1.84666 | 23.78 | Refraction | 17.802 |
| | 9 | −103.47100 | 0.200000 | | | Refraction | 18.099 |
| L6 | 10 | 83.27600 | 4.320000 | 1.84666 | 23.78 | Refraction | 18.000 |
| | 11 | −298.53100 | 33.534000 | | | Refraction | 17.796 |
| L7 | 12 | 63.55500 | 5.580000 | 1.77250 | 49.60 | Refraction | 11.502 |
| L8 | 13 | −43.02500 | 1.100000 | 1.72825 | 28.46 | Refraction | 10.945 |
| | 14 | 1804.82100 | 2.873000 | | | Refraction | 10.461 |
| L9, 75 | 15 | −38.34400 | 1.000000 | 1.76182 | 26.52 | Refraction | 10.000 |
| | 16 | 75.19100 | 5.832000 | | | Refraction | 9.776 |
| L10 | *17 | −217.03500 | 4.360000 | 1.74320 | 49.29 | Refraction | 9.777 |
| | *18 | −29.41800 | 1.830000 | | | Refraction | 10.000 |
| L11 | 19 | −32.01900 | 1.200000 | 1.69895 | 30.13 | Refraction | 10.108 |
| L12 | 20 | 34.78000 | 7.550000 | 1.49700 | 81.54 | Refraction | 11.067 |
| | 21 | −41.76900 | 0.200000 | | | Refraction | 12.227 |
| L13 | 22 | 87.93800 | 4.850000 | 1.80809 | 22.76 | Refraction | 13.114 |
| | 23 | −86.87400 | 0.500000 | | | Refraction | 13.356 |
| L14 | 24 | 170.53700 | 5.170000 | 1.59522 | 67.74 | Refraction | 13.417 |
| | 25 | −55.33000 | 5.119637 | | | Refraction | 13.385 |
| 9 | 26 | 0.00000 | 16.000000 | 1.51680 | 64.17 | Refraction | 10.417 |
| 91 | 27 | 0.00000 | 16.000000 | 1.51680 | 64.17 | Refraction | 10.417 |
| | 28 | 0.00000 | 4.200000 | | | Refraction | 5.495 |
| 81 | 29 | 0.00000 | 0.000000 | | | Refraction | 4.503 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3.314652E−08 | −5.17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | −4.717475E−17 | −3.480507E−15 | 1.826607E−14 |
| 14th-order coefficient | 1.074993E−20 | −2.316431E−20 | −8.166188E−17 | −1.164168E−16 |

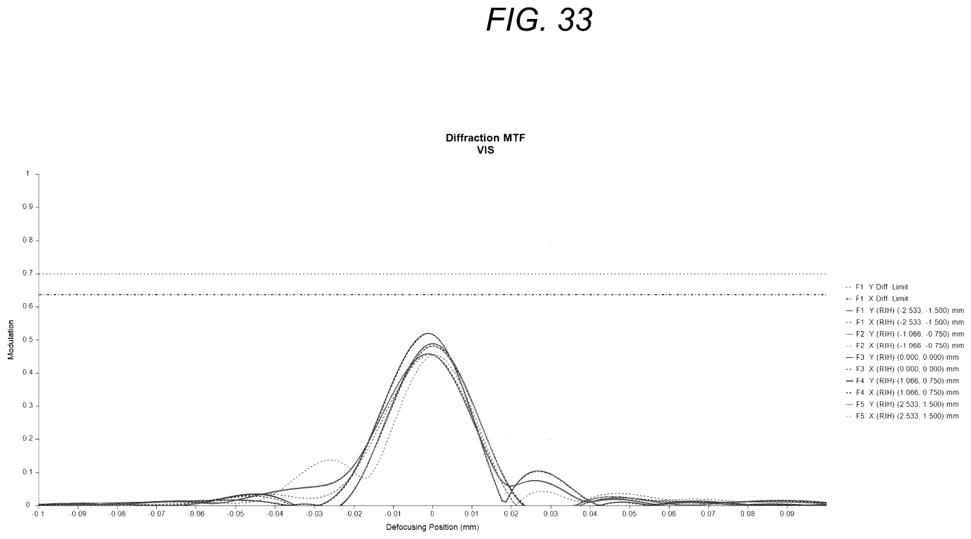

FIG. 33 shows the reduction-side MTF of the first projection optical system 41. FIG. 34 shows the reduction-side MTF of the second projection optical system 42. The first projection optical system 41 provides high resolution, as shown in FIG. 33. The second projection optical system 42 provides high resolution, as shown in FIG. 34.

### Effects and Advantages

The first relay optical system 5D forms the intermediate image 15, which differs in magnification from the projection images 18 formed at the light modulators 3, at the first position S1. The projection images 18 formed at the light modulators 3 are smaller than the intermediate image 15 formed at the first position S1. The size of the light modulators 3 can thus be reduced, so that the size of the projector 1D is reduced.

The projector system PS5 according to the fifth embodiment has the same configuration as the projector system PS1 according to the first embodiment. The projector system PS5 according to the fifth embodiment therefore provides the same effects and advantages as the projector system PS1 according to the first embodiment.

### Sixth Embodiment

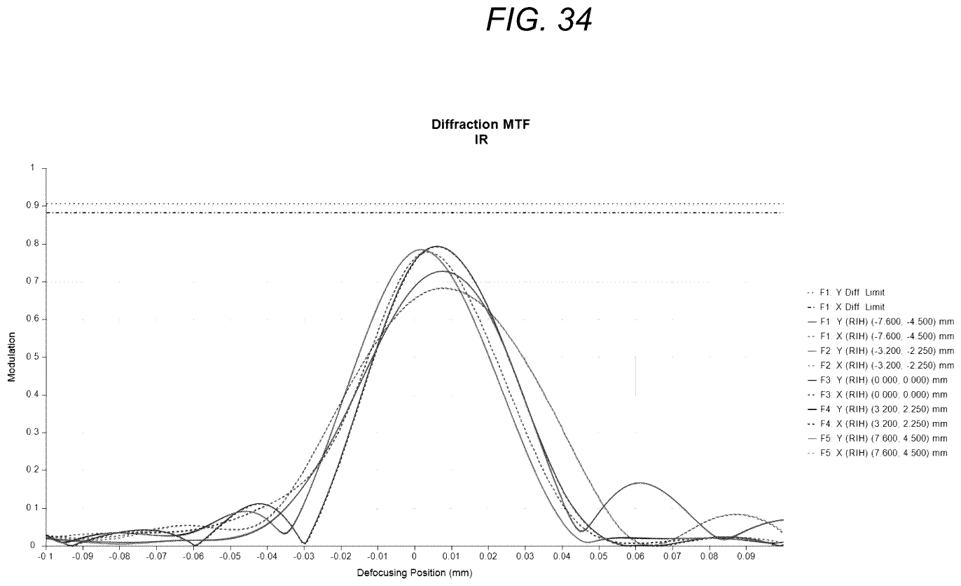

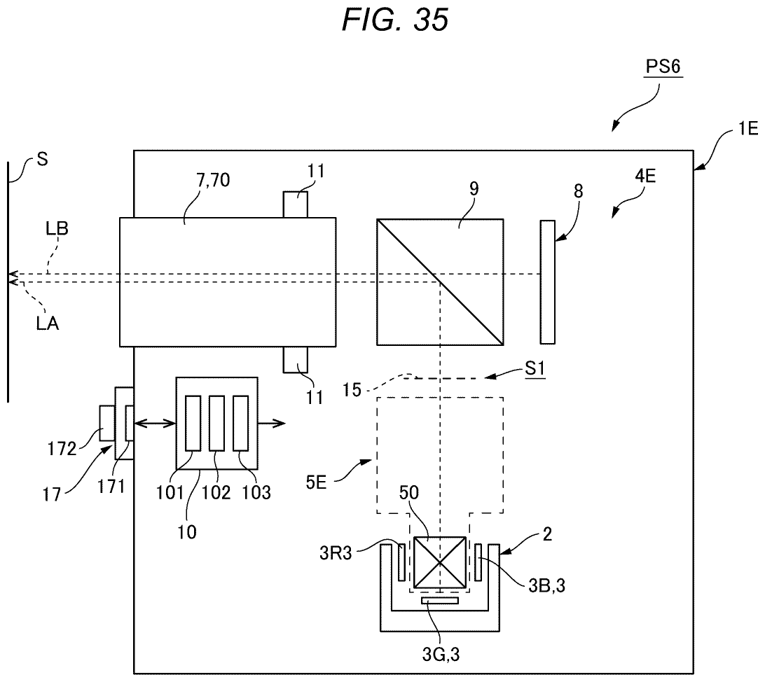

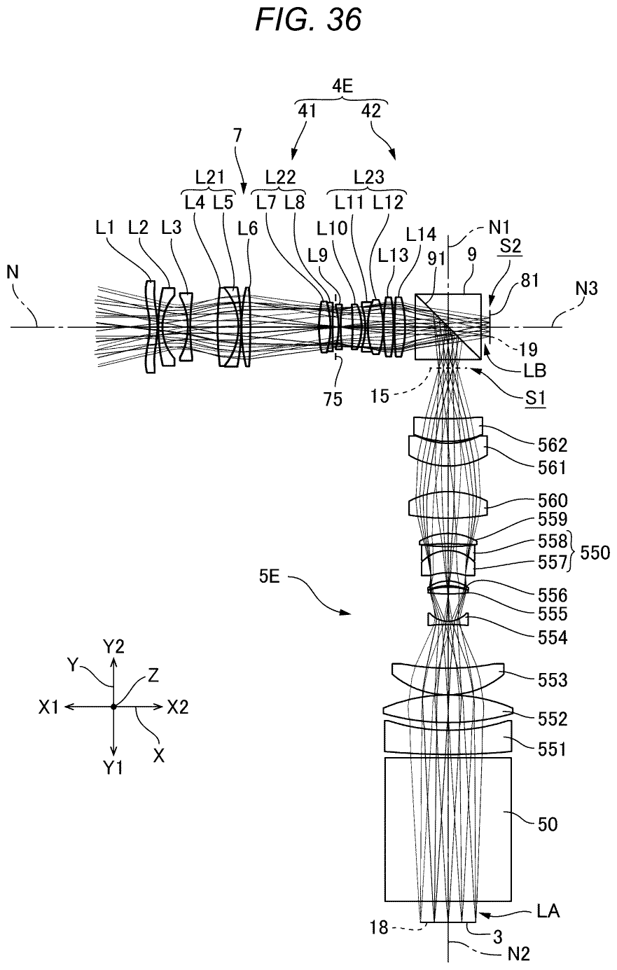

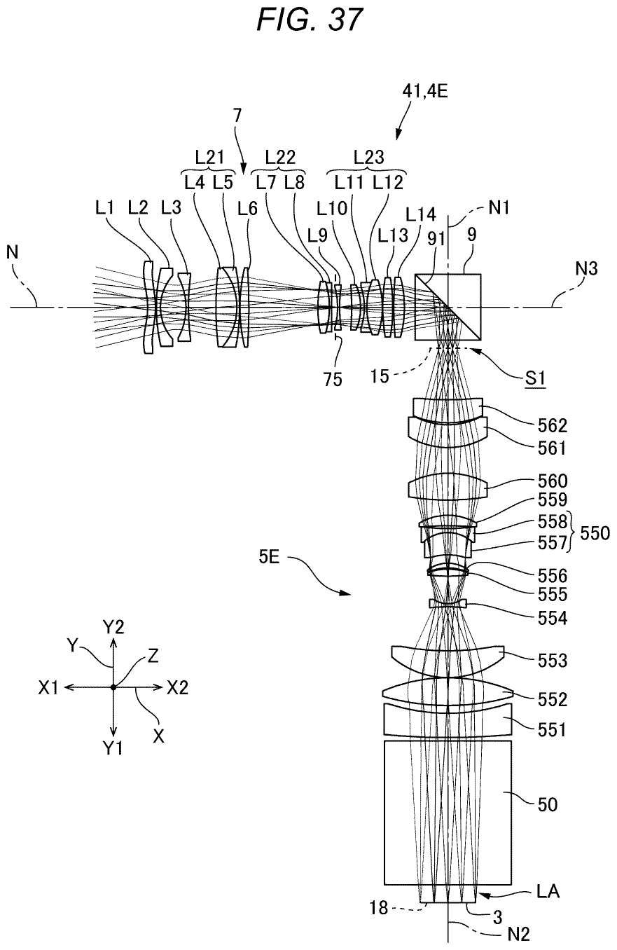

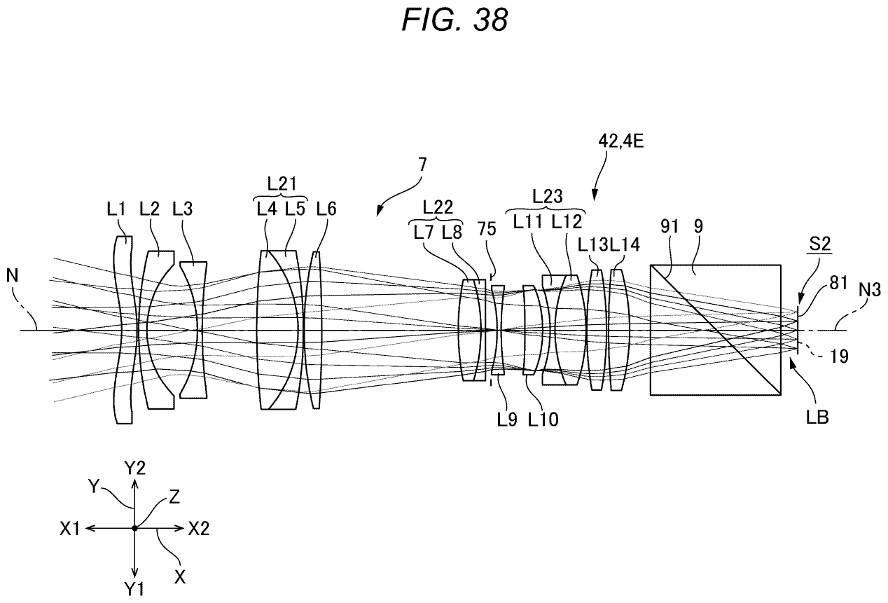

FIG. 35 is a schematic view of key parts of a projector system PS6 according a sixth embodiment. FIG. 36 shows a schematic configuration of an optical system 4E in the sixth embodiment. FIG. 37 is a schematic configuration diagram of the first projection optical system 41, which projects visible light, out of the optical system 4E in the sixth embodiment. FIG. 38 is a schematic configuration diagram of the second projection optical system 42, which projects invisible light, out of the optical system 4E in the sixth embodiment. In the sixth embodiment, a first relay optical system 5E of the projector system PS6 according to the sixth embodiment shown in FIG. 35 differs from the first relay optical system 5D of the projector system PS5 according to the fifth embodiment. Therefore, in the sixth embodiment, the same configurations as those in the fifth embodiment have the same reference characters, and will not be described in some cases.

The optical system 4E includes the first relay optical system 5E, the enlarging optical system 7, and the light combiner 9, as shown in FIG. 35. The first relay optical system 5E includes the dichroic prism 50.

The optical system 4E includes the first projection optical system 41 shown in FIG. 37, which projects the visible light LA, and the second projection optical system 42 shown in FIG. 38, which projects the invisible light LB, as shown in FIG. 36.

The enlarging optical system 7 includes 14 lenses L1 to L14, as shown in FIG. 36 to 38. The lenses L1 to L14 are arranged in this order from the enlargement side toward the reduction side. The diaphragm 75 is disposed between the lens L8 and the lens L9. The lenses L4 and L5 are cemented to each other into the cemented lens L21. The lenses L7 and L8 are cemented to each other into the cemented lens L22. The lenses L11 and L12 are cemented to each other into the cemented lens L23. The lens L1 has aspherical surfaces on opposite sides. The lens L10 has aspherical surfaces on opposite sides.

The first relay optical system 5E forms the projection images 18 at the first position S1, as shown in FIGS. 36 and 37. In the present embodiment, the first relay optical system 5E forms the intermediate image 15, which differs in magnification from the projection images 18 formed at the light modulators 3, at the first position S1. The projection images 18 formed at the light modulators 3 are larger than the intermediate image 15 formed at the first position S1. The first position S1 is located between the light combiner 9 and the first relay optical system 5E. Furthermore, in the present embodiment, the invisible image 19 formed by the IR light modulator 81 is smaller than the projection images 18 formed by the light modulators 3.

The first relay optical system 5E includes the dichroic prism 50, a first lens 551, a second lens 552, a third lens 553, a fourth lens 554, a fifth lens 555, a sixth lens 556, a seventh lens 557, an eighth lens 558, a ninth lens 559, a tenth lens 560, an eleventh lens 561, and a twelfth lens 562 sequentially arranged in the direction in which the visible light travels from the light modulators 3 toward the first position S1. The first lens 551 to the twelfth lens 562 are arranged along the Y-axis. The seventh lens 557 and the eighth lens 558 are cemented to each other into a cemented lens 550.

The light combiner 9 combines the visible light LA and the invisible light LB with each other into the combined light, as shown in FIG. 36 to 38. The enlarging optical system 7 is disposed at a position shifted in the X1 direction from the light combiner 9, the IR light modulator 81 is disposed at a position shifted in the X2 direction from the light combiner 9, and the twelfth lens 562 of the first relay optical system 5E is disposed at a position shifted in the Y1 direction from the light combiner 9. The light combiner 9 includes a wavelength separating film 91. The wavelength separating film 91 transmits one of infrared light and visible light and reflects the other. In the present embodiment, the wavelength separating film 91 transmits infrared light, which is the visible light LA, and reflects the invisible light LB. The visible light LA output from the first relay optical system 5E is therefore reflected off the wavelength separating film 91 and enters the enlarging optical system 7, as shown in FIG. 37. The intermediate image 15 is displayed as the combined projection image on the screen S by the enlarging optical system 7. The invisible light LB output from the second relay optical system 6C passes through the wavelength separating film 91 and enters the enlarging optical system 7, as shown in FIG. 38. The invisible image 19 is displayed on the screen S by the enlarging optical system 7. The invisible image 19 is formed at the second position S2 conjugate with the positions where the projection images 18 are formed.

The opposite sides of the first relay optical system 5E are telecentric systems, as shown in FIG. 37. The principal ray of each beam passing through the image formation plane at the first position S1 is therefore parallel or substantially parallel to the optical axis N1 of the image formation plane at the first position S1. The principal ray of each beam passing through the image formation surfaces of the light modulators 3 is parallel or substantially parallel to the optical axis N2 of the image formation surfaces of the light modulators 3.

### Lens Data

Data on the lenses of the first projection optical system 41 shown in FIG. 37 are shown below. Surface numbers are sequentially assigned from the enlargement side toward the reduction side. Reference characters are those of the screen, the lenses, the light combiner, the lenses, the polarization combining/separating prism, the dichroic prism, and the light modulators. A surface having a surface number labeled with*is an aspherical surface. R represents the radius of curvature. D represents the axial inter-surface distance. Nd represents the refractive index at the d line. νd represents the Abbe number at the d line. Y represents the effective radius. R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.000 |
| | *2 | −35.90900 | 0.400000 | | | Refraction | 19.556 |
| L2 | 3 | 81.70000 | 2.000000 | 1.49700 | 81.54 | Refraction | 17.735 |
| | 4 | 22.98300 | 12.400000 | | | Refraction | 15.392 |
| L3 | 5 | −31.21800 | 1.200000 | 1.49700 | 81.54 | Refraction | 14.911 |
| | 6 | 118.38200 | 13.384000 | | | Refraction | 15.325 |
| L4 | 7 | 176.01300 | 10.150000 | 1.83400 | 37.16 | Refraction | 17.641 |
| L5 | 8 | −29.89400 | 1.300000 | 1.84666 | 23.78 | Refraction | 17.802 |
| | 9 | −103.47100 | 0.200000 | | | Refraction | 18.099 |
| L6 | 10 | 83.27600 | 4.320000 | 1.84666 | 23.78 | Refraction | 18.000 |
| | 11 | −298.53100 | 33.534000 | | | Refraction | 17.796 |
| L7 | 12 | 63.55500 | 5.580000 | 1.77250 | 49.60 | Refraction | 11.502 |
| L8 | 13 | −43.02500 | 1.100000 | 1.72825 | 28.46 | Refraction | 10.945 |
| | 14 | 1804.82100 | 2.873000 | | | Refraction | 10.461 |
| L9, 75 | 15 | −38.34400 | 1.000000 | 1.76182 | 26.52 | Refraction | 10.000 |
| | 16 | 75.19100 | 5.832000 | | | Refraction | 9.776 |
| L10 | *17 | −217.03500 | 4.360000 | 1.74320 | 49.29 | Refraction | 9.777 |
| | *18 | −29.41800 | 1.830000 | | | Refraction | 10.000 |
| L11 | 19 | −32.01900 | 1.200000 | 1.69895 | 30.13 | Refraction | 10.108 |
| L12 | 20 | 34.78000 | 7.550000 | 1.49700 | 81.54 | Refraction | 11.067 |
| | 21 | −41.76900 | 0.200000 | | | Refraction | 12.227 |
| L13 | 22 | 87.93800 | 4.850000 | 1.80809 | 22.76 | Refraction | 13.114 |
| | 23 | −86.87400 | 0.500000 | | | Refraction | 13.356 |
| L14 | 24 | 170.53700 | 5.170000 | 1.59522 | 67.74 | Refraction | 13.417 |
| | 25 | −55.33000 | 5.119637 | | | Refraction | 13.385 |
| 9 | 26 | 0.00000 | 16.000000 | 1.51680 | 64.17 | Refraction | 12.000 |
| 91 | 27 | 0.00000 | −16.000000 | 1.51680 | 64.17 | Reflection | 12.000 |
| | 28 | 0.00000 | −4.200000 | | | Refraction | 9.307 |
| S1 | 29 | 0.00000 | −24.728531 | | | Refraction | 8.847 |
| 562 | *30 | 140.05274 | −11.072216 | 1.75520 | 27.58 | Refraction | 13.963 |
| | *31 | 42.86245 | −0.953138 | | | Refraction | 15.539 |
| 561 | 32 | 34.58088 | −11.102785 | 1.74397 | 44.85 | Refraction | 15.544 |
| | 33 | 36.67072 | −12.516702 | | | Refraction | 17.829 |
| 560 | 34 | −41.13171 | −13.000000 | 1.49239 | 69.86 | Refraction | 17.763 |
| | 35 | 114.23053 | −7.413559 | | | Refraction | 16.580 |
| 559 | 36 | −27.51957 | −5.090750 | 1.61846 | 60.42 | Refraction | 12.901 |
| | 37 | −160.21300 | −1.323666 | | | Refraction | 12.000 |
| 558 | 38 | 95.17663 | −1.964400 | 1.70142 | 31.59 | Refraction | 11.921 |
| 557 | 39 | −17.56238 | −10.812017 | 1.56285 | 63.75 | Refraction | 10.350 |
| | 40 | −26.82393 | −4.084324 | | | Refraction | 8.500 |
| 556 | 41 | −16.42195 | −2.295541 | 1.48749 | 70.41 | Refraction | 9.027 |
| | 42 | −23.50016 | −0.600243 | | | Refraction | 8.835 |
| 555 | 43 | −30.24579 | −3.376526 | 1.54973 | 64.69 | Refraction | 8.830 |
| | 44 | 93.48541 | −13.448703 | | | Refraction | 8.629 |
| 554 | 45 | 11.93052 | −1.500000 | 1.71067 | 29.64 | Refraction | 6.793 |
| | 46 | −88.88065 | −21.384116 | | | Refraction | 8.059 |
| 553 | 47 | 119.92079 | −13.000000 | 1.75520 | 27.58 | Refraction | 22.613 |
| | 48 | 41.95182 | −0.100000 | | | Refraction | 25.689 |
| 552 | 49 | −80.88435 | −13.455660 | 1.74397 | 44.85 | Refraction | 29.985 |
| | 50 | 114.78774 | −3.768754 | | | Refraction | 29.915 |
| 551 | 51 | 93.18261 | −11.797513 | 1.75520 | 27.58 | Refraction | 29.150 |
| | 52 | 331.98331 | −1.617087 | | | Refraction | 29.308 |
| 50 | 53 | 0.00000 | −70.000000 | 1.51680 | 64.17 | Refraction | 29.165 |
| | 54 | 0.00000 | 10.296700 | | | Refraction | 26.976 |
| 3 | 55 | 0.00000 | 0.000000 | | | Refraction | 26.505 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3.314652E−08 | −5.17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | −4.717475E−17 | −3.480507E−15 | 1.826607E−14 |
| 14th-order coefficient | 1.074993E−20 | −2.316431E−20 | −8.166188E−17 | −1.164168E−16 |

Data on the lenses of the second projection optical system 42 shown in FIG. 38 are shown below. Surface numbers are sequentially assigned from the enlargement side toward the reduction side. Reference characters are those of the screen, the lenses, the light combiner, and the imaging device. A surface having a surface number labeled with*is an aspherical surface. R represents the radius of curvature. D represents the axial inter-surface distance. Nd represents the refractive index at the d line. νd represents the Abbe number at the d line. Y represents the effective radius. R, D, and Y are expressed in millimeters.

| Reference | Surface | | | | | | |
|---|---|---|---|---|---|---|---|
| character | number | R | D | nd | vd | Mode | Y |
| S | 0 | 0.00000 | 2360.000000 | | | Refraction | |
| L1 | *1 | −30.93600 | 3.800000 | 1.50942 | 55.88 | Refraction | 21.000 |
| | *2 | −35.90900 | 0.400000 | | | Refraction | 19.556 |
| L2 | 3 | 81.70000 | 2.000000 | 1.49700 | 81.54 | Refraction | 17.735 |
| | 4 | 22.98300 | 12.400000 | | | Refraction | 15.392 |
| L3 | 5 | −31.21800 | 1.200000 | 1.49700 | 81.54 | Refraction | 14.911 |
| | 6 | 118.38200 | 13.384000 | | | Refraction | 15.325 |
| L4 | 7 | 176.01300 | 10.150000 | 1.83400 | 37.16 | Refraction | 17.641 |
| L5 | 8 | −29.89400 | 1.300000 | 1.84666 | 23.78 | Refraction | 17.802 |
| | 9 | −103.47100 | 0.200000 | | | Refraction | 18.099 |
| L6 | 10 | 83.27600 | 4.320000 | 1.84666 | 23.78 | Refraction | 18.000 |
| | 11 | −298.53100 | 33.534000 | | | Refraction | 17.796 |
| L7 | 12 | 63.55500 | 5.580000 | 1.77250 | 49.60 | Refraction | 11.502 |
| L8 | 13 | −43.02500 | 1.100000 | 1.72825 | 28.46 | Refraction | 10.945 |
| | 14 | 1804.82100 | 2.873000 | | | Refraction | 10.461 |
| L9, 75 | 15 | −38.34400 | 1.000000 | 1.76182 | 26.52 | Refraction | 10.000 |
| | 16 | 75.19100 | 5.832000 | | | Refraction | 9.776 |
| L10 | *17 | −217.03500 | 4.360000 | 1.74320 | 49.29 | Refraction | 9.777 |
| | *18 | −29.41800 | 1.830000 | | | Refraction | 10.000 |
| L11 | 19 | −32.01900 | 1.200000 | 1.69895 | 30.13 | Refraction | 10.108 |
| L12 | 20 | 34.78000 | 7.550000 | 1.49700 | 81.54 | Refraction | 11.067 |
| | 21 | −41.76900 | 0.200000 | | | Refraction | 12.227 |
| L13 | 22 | 87.93800 | 4.850000 | 1.80809 | 22.76 | Refraction | 13.114 |
| | 23 | −86.87400 | 0.500000 | | | Refraction | 13.356 |
| L14 | 24 | 170.53700 | 5.170000 | 1.59522 | 67.74 | Refraction | 13.417 |
| | 25 | −55.33000 | 5.119637 | | | Refraction | 13.385 |
| 9 | 26 | 0.00000 | 16.000000 | 1.51680 | 64.17 | Refraction | 10.417 |
| 91 | 27 | 0.00000 | 16.000000 | 1.51680 | 64.17 | Refraction | 10.417 |
| | 28 | 0.00000 | 4.200000 | | | Refraction | 5.495 |
| 81 | 29 | 0.00000 | 0.000000 | | | Refraction | 4.503 |

Each aspherical coefficient is as follows.

| Surface number | 1 | 2 | 17 | 18 |
|---|---|---|---|---|
| Conic constant | −7.43E+00 | −8.549E+00 | −2.00E+00 | 5.52E−01 |
| 4th-order coefficient | 2.575429E−05 | 2.508628E−05 | −1.189732E−05 | −1.887723E−06 |
| 6th-order coefficient | −3.724959E−08 | −3. 314652E−08 | −5. 17632E−09 | −6.584551E−09 |
| 8th-order coefficient | 3.59918E−11 | 1.242655E−11 | −4.937693E−10 | −2.484272E−10 |
| 10th-order coefficient | 9.857151E−15 | 6.209172E−14 | 2.55588E−12 | −7.155889E−13 |
| 12th-order coefficient | −3.080937E−17 | −4.717475E−17 | −3.480507E−15 | 1.826607E−14 |
| 14th-order coefficient | 1.074993E−20 | −2.316431E−20 | −8.166188E−17 | −1.164168E−16 |

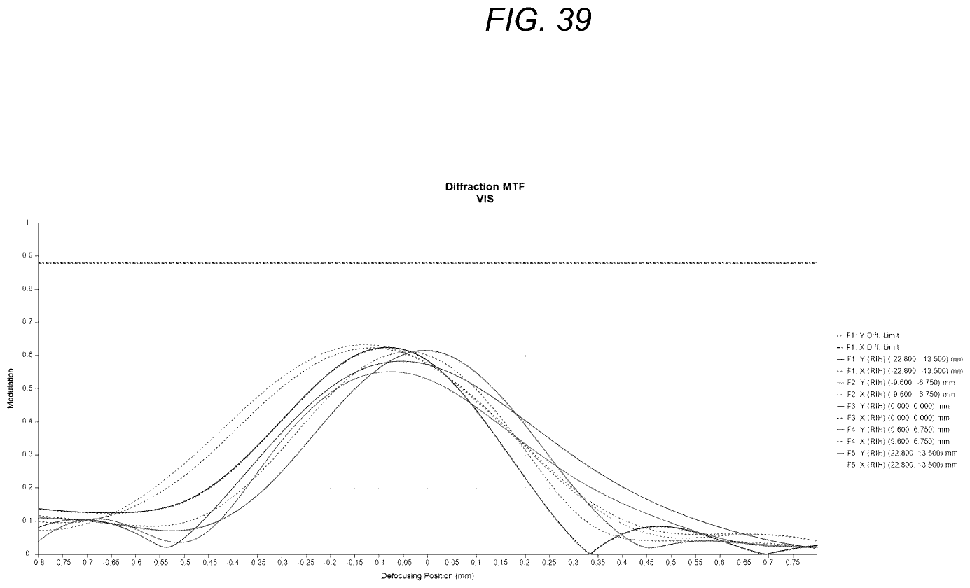

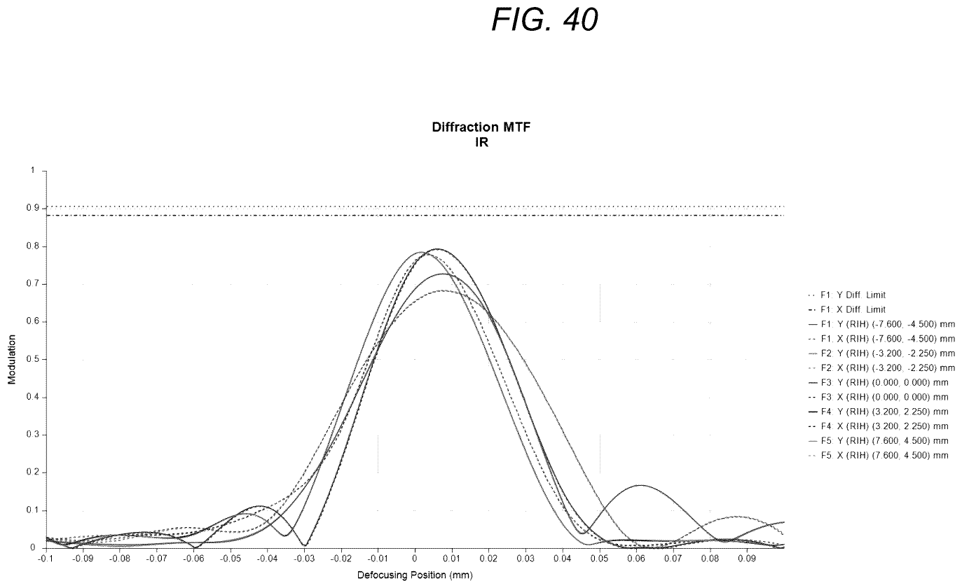

FIG. 39 shows the reduction-side MTF of the first projection optical system 41. FIG. 40 shows the reduction-side MTF of the second projection optical system 42. The first projection optical system 41 provides high resolution, as shown in FIG. 39. The second projection optical system 42 provides high resolution, as shown in FIG. 40.

### Effects and Advantages

The first relay optical system 5E forms the intermediate image 15, which differs in magnification from the projection images 18 formed at the light modulators 3, at the first position S1. The projection images 18 formed at the light modulators 3 are larger than the intermediate image 15 formed at the first position S1. The size of the light modulators 3 can thus be increased, so that the brightness of the combined projection image displayed on the screen S increases.

The projector system PS6 according to the sixth embodiment has the same configuration as the projector system PS5 according to the fifth embodiment. The projector system PS6 according to the sixth embodiment therefore provides the same effects and advantages as the projector system PS5 according to the fifth embodiment.

### Variation of Fourth Embodiment

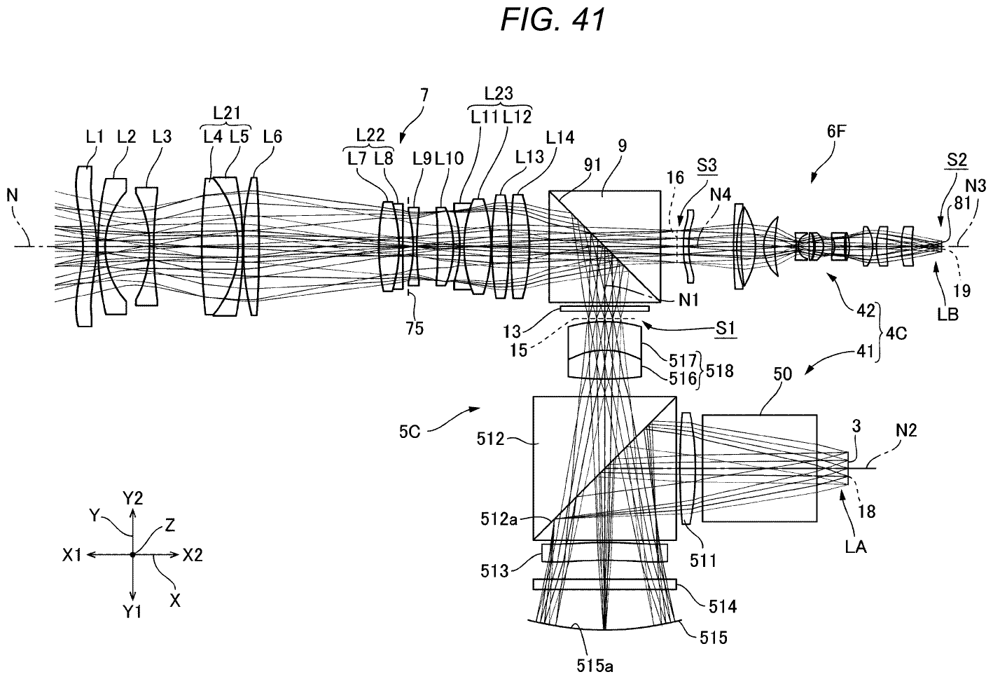

FIG. 41 shows a schematic configuration of an optical system of a projector system according to a variation of the fourth embodiment. In the variation of the fourth embodiment, a second relay optical system 6F forms the intermediate image 16, which differs in magnification from the invisible image 19 formed at the IR light modulator 81, at the third position S3. In this case, in the variation of the fourth embodiment, the invisible image 19 formed at the IR light modulator 81 is smaller than the intermediate image 16 formed at the third position S3.

### Variation of Invisible Image Generator

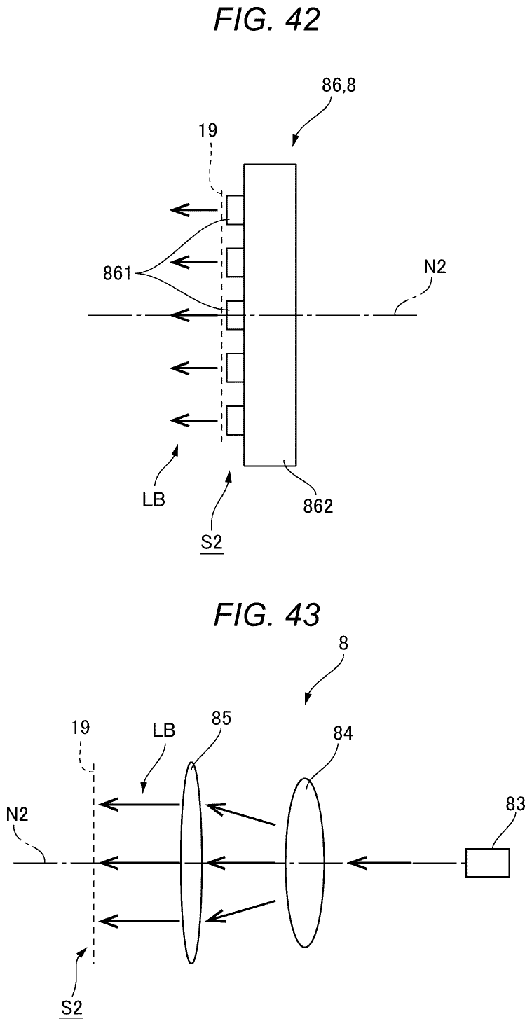

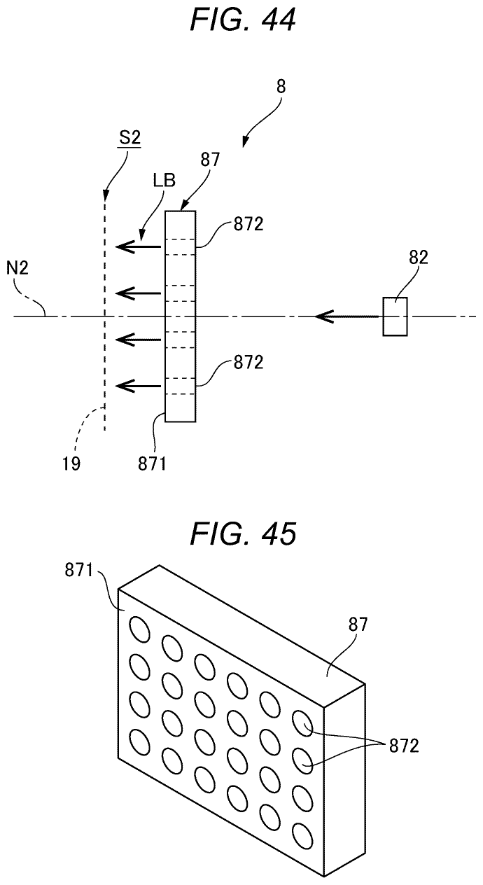

FIG. 42 is a schematic view of the invisible image generator 8 according to a first variation. FIG. 43 is a schematic view of the invisible image generator 8 according to a second variation. FIG. 44 is a schematic view of the invisible image generator 8 according to a third variation. FIG. 45 is a perspective view of an example of an optical member of the invisible image generator according to the third variation.

The invisible image generator 8 according to the first variation includes an IR light modulator 86, which forms the invisible image, as shown in FIG. 42. The IR light modulator 86 is controlled by the second display driver 102. The IR light modulator 86 includes self-luminous devices 861, which output the invisible light LB to form the invisible image 19, and a substrate 862, at which the self-luminous devices 861 are provided. The self-luminous devices 861 are each an LED element that emits infrared light as the invisible light. The light emitting surfaces of the self-luminous devices 861 are located at the second position S2. The self-luminous devices 861 therefore form the invisible image 19 at the second position S2. In the present embodiment, the invisible image 19 displayed at the screen S is the image shown in FIG. 4. The first variation according to the invisible image generator 8 reduces the size of the invisible image generator 8 as compared with a case where the invisible image generator 8 includes a light source that outputs invisible light and an IR light modulator that forms an invisible image from the output invisible light.

The invisible image generator 8 according to the second variation includes a semiconductor laser device 83, which outputs the invisible light LB, a diffractive optical element 84, which diffracts and spatially spreads the invisible light LB, and a light focusing lens 85, which brings the invisible light LB spread by the diffractive optical element 84 into focus as the invisible image 19 at the second position S2, as shown in FIG. 43. In the present embodiment, the diffractive optical element 84 spatially spreads the invisible light LB output from the semiconductor laser device 83 in such a way that the intensity distribution of the spread invisible light LB is the Gaussian distribution. The invisible image 19 displayed on the screen S is therefore the image shown in FIG. 4. The second variation according to the invisible image generator 8, in which the semiconductor laser device 83 is used, increases the brightness of the invisible image displayed on the screen S, and improves the contrast thereof. As a result, the imager 17 can accurately capture an image of the invisible image displayed on the screen S. Furthermore, the efficiency at which the energy is used to output the invisible light LB is improved, so that the amount of electric power consumed by the invisible image generator 8 can be reduced.

The invisible image generator 8 according to the third variation includes the second light source 82, which outputs the invisible light LB, and an optical member 87 having a formation surface 871, through which the invisible light LB passes to form pattern light, as shown in FIG. 44. The second light source 82 is an LED device that outputs infrared light, which is the invisible light. The optical member 87 is a plate-shaped member that does not transmit light, as shown in FIGS. 44 and 45. The optical member 87 has multiple holes 872 passing through the optical member 87. The optical member 87 is, for example, a glass plate, and an optical film that absorbs or reflects infrared light is provided at a surface of the optical member 87. In the present embodiment, the surface of the optical member 87 that is opposite the second light source 82 is the formation surface 871. When the invisible light LB output from the second light source 82 passes through the holes 872 in the optical member 87, the pattern light is formed at the formation surface 871. The formation surface 871 is located at a position shifted from the second position S2 toward the second light source 82 in the frontward-rearward direction in which light travels, as shown in FIG. 44. Therefore, since the position of the formation surface 871 is shifted from the second position S2, which is the image formation surface, the invisible image 19 formed by the pattern light at the second position S2 is an unclear image having an intensity distribution close to the Gaussian distribution. The third variation according to the invisible image generator 8, in which the invisible image 19 is formed by the optical member 87, which forms the pattern light, makes the configuration of the invisible image generator 8 simple. Furthermore, the cost of the invisible image generator 8 is reduced as compared with the case where the invisible image generator 8 includes the IR light modulator 81.

In the invisible image generator 8 according to the third variation, the formation surface 871 is located at a position shifted from the second position S2 toward the second light source 82 in the frontward-rearward direction in which light travels, and the formation surface 871 may instead be located at the second position S2. In this case, the invisible image 19 displayed on the screen S is not an image having the Gaussian intensity distribution shown in FIG. 4, but even in this case, the imager 17 can capture an image of the invisible image displayed on the screen S.

In the invisible image generator 8 according to the third variation, the optical member 87 includes the optical film that is provided at a surface thereof and absorbs or reflects infrared light, and has the multiple holes 872 passing the optical member 87, but not necessarily. For example, the optical member 87 may be a quartz substrate, and may include an AR film formed by vapor deposition and a circular optical film that is provided on the vapor-deposited film and absorbs or reflects infrared light. In this case, the optical film may be formed at the vapor-deposited AR film via a metal mask having a hole formed therein.

### Summary of Present Disclosure

The present disclosure will be summarized below as additional remarks.

### Additional Remark 1

A projector including:
a first light source;
a light modulator configured to modulate visible light output from the first light source to form a projection image;
a first relay optical system configured to relay the projection image to a first position;
an enlarging optical system;
an invisible image generator configured to form an invisible image made of invisible light; and
a light combiner disposed in an optical path between the enlarging optical system and the light modulator and configured to combine the visible light and the invisible light with each other into combined light,
wherein the invisible image is formed at a second position conjugate with a position where the projection image is formed, and
the enlarging optical system is configured to form an image at the first position and project the combined light to display the projection image and the invisible image at a single projection surface.

Since the enlarging optical system forms an image at the first position, the back focal length of the enlarging optical system is shortened as compared with a case where the enlarging optical system forms an image at the position of the light modulator. The contrast of the projection image displayed on the projection surface is thus improved. Furthermore, since the invisible image is formed at the second position conjugate with the position where the projection image is formed, the contrast of the invisible image displayed at the projection surface is also improved. Moreover, since the back focal length of the enlarging optical system is shortened, the size of the enlarging optical system can be reduced.

### Additional Remark 2

The projector according to Additional Remark 1, wherein the enlarging optical system forms an image at the second position.

Therefore, since the invisible light from the invisible image generator reaches the enlarging optical system only after passing through the light combiner, the invisible image displayed at the projection surface has high image quality. Furthermore, the amount of the invisible light reaching the enlarging optical system can be secured.

### Additional Remark 3

The projector according to Additional Remark 1, wherein the first relay optical system relays the invisible image to the first position.

An intermediate image of the invisible image and an intermediate image of the projection image can thus be formed by the single first relay optical system, so that the entire optical system can be made compact.

### Additional Remark 4

The projector according to Additional Remark 3, wherein an optical distance between the second position and the light combiner is equal to an optical distance between the position where the projection image is formed and the light combiner.

The light modulator and the invisible image generator are thus disposed at the same distance from the light combiner, so that the optical characteristics relating to the light modulator and the invisible image generator are unlikely to change even when the shape of the light combiner changes due to a change in the temperature.

### Additional Remark 5

The projector according to any one of Additional Remarks 1 to 4, wherein the first relay optical system has a first reflective surface having a concave shape.

The thus configured first relay optical system has a folded optical path, so that the entire first relay optical system can be made compact. Furthermore, the first reflective surface, which allows the optical path of the first relay optical system to be folded, can reduce chromatic aberrations produced by the folded optical path.

### Additional Remark 6

The projector according to any one of Additional Remarks 1 to 5, wherein the invisible image generator includes an IR light modulator configured to form the invisible image.

The invisible image can thus be formed in any manner.

### Additional Remark 7

The projector according to Additional Remark 6, wherein
the invisible image generator includes a second light source configured to output the invisible light, and a transmissive liquid crystal panel as the IR light modulator, and
the liquid crystal panel is configured to modulate the invisible light output from the second light source to form the invisible image.

The size of the IR light modulator is therefore reduced as compared with a case where the IR light modulator is a reflective liquid crystal panel.

### Additional Remark 8

The projector according to Additional Remark 6, wherein the IR light modulator includes a self-luminous device configured to output the invisible light to form the invisible image.

The size of the invisible image generator is thus reduced.

### Additional Remark 9

The projector according to any one of Additional Remarks 1 to 5, wherein the invisible image generator includes a semiconductor laser device configured to output the invisible light, a diffractive optical element configured to diffract and spatially spread the invisible light, and a light focusing lens configured to bring the invisible light spread by the diffractive optical element into focus to form the invisible image at the second position.

Additional Remark 9, in which the semiconductor laser device is used, increases the brightness of the invisible image displayed at the projection surface, and improves the contrast thereof. Furthermore, the efficiency at which the energy is used to output the invisible light is improved, so that the amount of electric power consumed by the invisible image generator can be reduced.

### Additional Remark 10

The projector according to any one of Additional Remarks 1 to 5, wherein
the invisible image generator includes a second light source configured to output the invisible light, and an optical member having a formation surface through which the invisible light passes to form pattern light,
the formation surface is located at the second position, and
the invisible image is formed at the second position by the pattern light.

Additional Remark 10, in which the invisible image is formed by the optical member, which forms the pattern light, makes the configuration of the invisible image generator simple. Furthermore, the cost of the invisible image generator is reduced as compared with the case where the invisible image generator includes the IR light modulator.

### Additional Remark 11

The projector according to any one of Additional Remarks 1 to 5, wherein
the invisible image generator includes a second light source configured to output the invisible light, and an optical member having a formation surface through which the invisible light passes to form pattern light,
the formation surface is located at a position shifted from the second position in a frontward-rearward direction in which light travels, and
the invisible image is formed at the second position by the pattern light.

Additional Remark 11, in which the invisible image is formed by the optical member, which forms the pattern light, makes the configuration of the invisible image generator simple. Furthermore, the cost of the invisible image generator is reduced as compared with the case where the invisible image generator includes the IR light modulator. Furthermore, since the position of the formation surface is shifted from the second position, which is the image formation surface, the invisible image formed by the pattern light at the second position is an image having an intensity distribution close to the Gaussian distribution.

### Additional Remark 12

The projector according to any one of Additional Remarks 1 to 12, wherein the invisible light is infrared light having a peak wavelength longer than or equal to 930 nm but shorter than or equal to 950 nm.

Therefore, when an image of the invisible image is captured with an imaging device, the imaging device can favorably capture an image of the invisible image.

### Additional Remark 13

The projector according to any one of Additional Remarks 1 to 12, wherein the invisible light is infrared light having a peak wavelength longer than or equal to 840 nm but shorter than or equal to 860 nm.

The invisible light is therefore unlikely to be affected by external light, so that the invisible image displayed at the projection surface becomes clear.

### Additional Remark 14

The projector according to any one of Additional Remarks 1 to 13, further including an attachment/detachment mechanism configured to allow the enlarging optical system to be attached to and detached from the first relay optical system.

The enlarging optical system of the projector can thus be replaced with another in accordance with the projection specifications.

### Additional Remark 15

A projector system including:
the projector according to any one of Additional Remarks 1 to 14;
an imager configured to capture an image of the invisible image displayed at the projection surface;
a recognizer configured to recognize a positional deviation of the invisible image from a reference position at the projection surface based on the image of the invisible image captured by the imager, and
a display corrector configured to correct a position of the projection image displayed at the projection surface based on the positional deviation recognized by the recognizer.

The projector system thus corrects the position of the projection image displayed at the projection surface based on the positional deviation of the invisible image recognized by the recognizer, so that the position of the projection image displayed at the projection surface is always kept constant.

What is claimed is:

1. A projector comprising:
a first light source;
a light modulator configured to modulate visible light output from the first light source to form a projection image;
a first relay optical system configured to relay the projection image to a first position;
an enlarging optical system;
an invisible image generator configured to form an invisible image made of invisible light; and
a light combiner disposed in an optical path between the enlarging optical system and the light modulator and configured to combine the visible light and the invisible light with each other into combined light,
wherein the invisible image is formed at a second position conjugate with a position where the projection image is formed, and
the enlarging optical system is configured to form an image at the first position and project the combined light to display the projection image and the invisible image at a single projection surface.

2. The projector according to claim 1, wherein the enlarging optical system forms an image at the second position.

3. The projector according to claim 1, wherein the first relay optical system relays the invisible image to the first position.

4. The projector according to claim 3, wherein an optical distance between the second position and the light combiner is equal to an optical distance between the position where the projection image is formed and the light combiner.

5. The projector according to claim 1, wherein the first relay optical system has a first reflective surface having a concave shape.

6. The projector according to claim 1, wherein the invisible image generator includes an IR light modulator configured to form the invisible image.

7. The projector according to claim 6, wherein
the invisible image generator includes a second light source configured to output the invisible light, and a transmissive liquid crystal panel as the IR light modulator, and
the liquid crystal panel is configured to modulate the invisible light output from the second light source to form the invisible image.

8. The projector according to claim 6, wherein the IR light modulator includes a self-luminous device configured to output the invisible light to form the invisible image.

9. The projector according to claim 1, wherein the invisible image generator includes a semiconductor laser device configured to output the invisible light, a diffractive optical element configured to diffract and spatially spread the invisible light, and a light focusing lens configured to bring the invisible light spread by the diffractive optical element into focus to form the invisible image at the second position.

10. The projector according to claim 1, wherein
the invisible image generator includes a second light source configured to output the invisible light, and an optical member having a formation surface through which the invisible light passes to form pattern light,
the formation surface is located at the second position, and
the invisible image is formed at the second position by the pattern light.

11. The projector according to claim 1, wherein
the invisible image generator includes a second light source configured to output the invisible light, and an optical member having a formation surface through which the invisible light passes to form pattern light,
the formation surface is located at a position shifted from the second position in a frontward-rearward direction in which light travels, and
the invisible image is formed at the second position by the pattern light.

12. The projector according to claim 1, wherein the invisible light is infrared light having a peak wavelength longer than or equal to 930 nm but shorter than or equal to 950 nm.

13. The projector according to claim 1, wherein the invisible light is infrared light having a peak wavelength longer than or equal to 840 nm but shorter than or equal to 860 nm.

14. The projector according to claim 1, further including an attachment/detachment mechanism configured to allow the enlarging optical system to be attached to and detached from the first relay optical system.

15. A projector system comprising:
the projector according to claim 1;
an imager configured to capture an image of the invisible image displayed at the projection surface;
a recognizer configured to recognize a positional deviation of the invisible image from a reference position at the projection surface based on the image of the invisible image captured by the imager, and
a display corrector configured to correct a position of the projection image displayed at the projection surface based on the positional deviation recognized by the recognizer.
